(19) United States
(12) Patent Application Publication
(10) Pub. No.: US 2026/0194629 A1
(43) Pub. Date: Jul. 9, 2026

(54) RECONFIGURABLE INTELLIGENT SURFACE-BASED TARGET OBJECT VELOCITY MEASUREMENTS

(71) Applicant: QUALCOMM Incorporated, San Diego, CA (US)

(72) Inventors: Min HUANG, Beijing (CN); Mingxi YIN, Beijing (CN); Hao XU, Beijing (CN)

(21) Appl. No.: 19/132,756

(22) PCT Filed: Feb. 1, 2023
(86) PCT No.: PCT/CN2023/074067

§ 371 Date: May 23, 2025

(51) Int. Cl. G01S 7/41; G01S 13/58; H04B 7/04

(52) U.S. Cl. CPC G01S 7/41; G01S 13/58; H04B 7/04013

(57) ABSTRACT

A wireless device obtains a configuration of a first set of sensing signals associated with a first reflection path including a first RIS and of a second set of sensing signals associated with a second reflection path including the first RIS or a second RIS. The first set of sensing signals are associated with a first RIS reflection coefficient and the second set of sensing signals are associated with a second RIS reflection coefficient. The wireless device receives the first set of sensing signals via the first reflection path and the second set of sensing signals via the second reflection path. The wireless device calculates a first Doppler frequency of a target object based on the first set of sensing signals and the first configuration and calculate a second Doppler frequency of the same target object based on the second set of sensing signals and the second configuration.

### TECHNICAL FIELD

The present disclosure relates generally to communication systems, and more particularly, to a wireless sensing system using one or more reconfigurable intelligent surfaces (RISs).

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may include a sensing receiver. The apparatus may obtain a first configuration of a first set of sensing signals associated with a first reflection path including a first reconfigurable intelligent surface (RIS). Each of the first set of sensing signals may be associated with a first RIS reflection coefficient. The apparatus may obtain a second configuration of a second set of sensing signals associated with a second reflection path including at least one of the first RIS or a second RIS. Each of the second set of sensing signals may be associated with a second RIS reflection coefficient. The apparatus may receive the first set of sensing signals via the first reflection path. The apparatus may receive the second set of sensing signals via the second reflection path. The apparatus may calculate a first Doppler frequency of a target object based on the first set of sensing signals and the first configuration. The apparatus may calculate a second Doppler frequency of the target object based on the second set of sensing signals and the second configuration.

In an aspect of the disclosure, a method, a computer-readable medium, and an apparatus are provided. The apparatus may include a sensing transmitter. The apparatus may transmit, to a first reconfigurable intelligent surface (RIS), a first configuration of a first set of sensing signals. Each of the first set of sensing signals may be associated with a first RIS reflection coefficient. The apparatus may transmit, to at least one of the first RIS or a second RIS, a second configuration of a second set of sensing signals. Each of the second set of sensing signals may be associated with a second RIS reflection coefficient. The apparatus may transmit the first set of sensing signals along a first reflection path including the first RIS and a target object. The apparatus may transmit the second set of sensing signals along a second reflection path including at least one of the first RIS or the second RIS and the target object.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5 is a diagram illustrating an example of sensing based on measurements of sensing signals reflected off of a target object, in accordance with various aspects of the present disclosure.

FIG. 6 is a diagram illustrating an example of a reflective wireless device configured to reflect one or more signals from a first wireless device to a second wireless device, in accordance with various aspects of the present disclosure.

FIG. 7A is a diagram illustrating an example of a reflective wireless device configured to assist a wireless device in performing monostatic sensing of a target object, in accordance with various aspects of the present disclosure.

FIG. 7B is a diagram illustrating an example of a reflective wireless device configured to assist a wireless device in performing monostatic sensing of a target object, in accordance with various aspects of the present disclosure.

FIG. 7C is a diagram illustrating an example of a reflective wireless device configured to assist a wireless device in performing monostatic sensing of a target object, in accordance with various aspects of the present disclosure.

FIG. 8A is a diagram illustrating an example of a first reflective wireless device and a second reflective device configured to assist a wireless device in performing monostatic sensing of a target object, in accordance with various aspects of the present disclosure.

FIG. 8B is a diagram illustrating an example of a reflective wireless device configured to assist a first wireless device and a second wireless device in performing bistatic sensing of a target object, in accordance with various aspects of the present disclosure.

FIG. 9 is a connection flow diagram illustrating an example of communications between wireless devices and a reflective wireless device configured to perform bistatic sensing on a target object, in accordance with various aspects of the present disclosure.

FIG. 10 is a connection flow diagram illustrating an example of communications between a wireless device and a reflective wireless device configured to perform monostatic sensing on a target object, in accordance with various aspects of the present disclosure.

FIG. 11 is a connection flow diagram illustrating an example of communications between a wireless device and a plurality of reflective wireless devices configured to perform monostatic sensing on a target object, in accordance with various aspects of the present disclosure.

FIG. 12 is a connection flow diagram illustrating an example of communications between a plurality of wireless devices and a plurality of reflective wireless devices configured to perform bistatic sensing on a target object, in accordance with various aspects of the present disclosure.

FIG. 13 is a flowchart of a method of wireless communication.

FIG. 14 is another flowchart of a method of wireless communication.

FIG. 15 is a flowchart of a method of wireless communication.

FIG. 16 is another flowchart of a method of wireless communication.

FIG. 17 is a flowchart of a method of wireless communication.

FIG. 18 is a diagram illustrating an example of a hardware implementation for an example apparatus and/or network entity.

FIG. 19 is a diagram illustrating an example of a hardware implementation for an example network entity.

FIG. 20 is a diagram illustrating an example of a hardware implementation for an example network entity.

### DETAILED DESCRIPTION

When sensing a target object, a wireless device may transmit a sensing signal to a target object and receive the sensing signal from the target object to measure a Doppler frequency of the target object in one direction. While the wireless device may calculate a velocity of the target object in the incident direction of the target object using the measurement of the Doppler frequency, the wireless device may not be able to calculate the velocity of the target object in a direction perpendicular to the incident direction without performing an additional sensing measurement at an angle to the incident direction of the target object. However, there may not be another wireless device within range of the target object to perform sensing on the target object at another angle.

The wireless device may utilize a reflective wireless device, such as a reconfigurable intelligent surface (RIS) to reflect a sensing signal off of a target object at a plurality of reflection paths to allow a wireless device to calculate a Doppler frequency of the target object at a variety of angles relative to one another. A configuration device, such as a sensing processing entity or a sensing transmitter, may configure a discrete RIS reflection coefficient for each reflection path, enabling received sensing signals for each reflection path to be contextualized and calculated separately from one another.

A first wireless device, such as a sensing transmitter, may be configured to transmit, to a first reconfigurable intelligent surface (RIS), a first configuration of a first set of sensing signals. Each of the first set of sensing signals may be associated with a first RIS reflection coefficient. The first wireless device may transmit the first set of sensing signals along a first reflection path including the first RIS and a target object. The first wireless device may transmit, to at least one of the first RIS or a second RIS, a second configuration of a second set of sensing signals. Each of the second set of sensing signals may be associated with a second RIS reflection coefficient. The first wireless device may transmit the second set of sensing signals along a second reflection path including at least one of the first RIS or the second RIS and the target object. The RIS may reflect the first set of sensing signals based on the first RIS reflection coefficient and may reflect the second set of sensing signals based on the second RIS reflection coefficient.

A second wireless device, such as a sensing receiver, may obtain a first configuration of a first set of sensing signals associated with a first reflection path including a first RIS. Each of the first set of sensing signals may be associated with a first RIS reflection coefficient. The second wireless device may receive the first set of sensing signals via the first reflection path. The second wireless device may calculate a first Doppler frequency of a target object based on the first set of sensing signals and the first configuration. The second wireless device may obtain a second configuration of a second set of sensing signals associated with a second reflection path including at least one of the first RIS or a second RIS. Each of the second set of sensing signals may be associated with a second RIS reflection coefficient. The second wireless device may receive the second set of sensing signals via the second reflection path. The second wireless device may calculate a second Doppler frequency of the target object based on the second set of sensing signals and the second configuration. A velocity of the target object may be calculated based on the first Doppler frequency and the second Doppler frequency.

Particular aspects of the subject matter described in this disclosure can be implemented to realize one or more of the following potential advantages. In some examples, the described techniques can be used to measure a velocity of a target object using a RIS instead of needing to add another wireless device to a sensing system to sense a target object, reducing resources needed to perform enough sensing on a target object to calculate its velocity.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer. While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

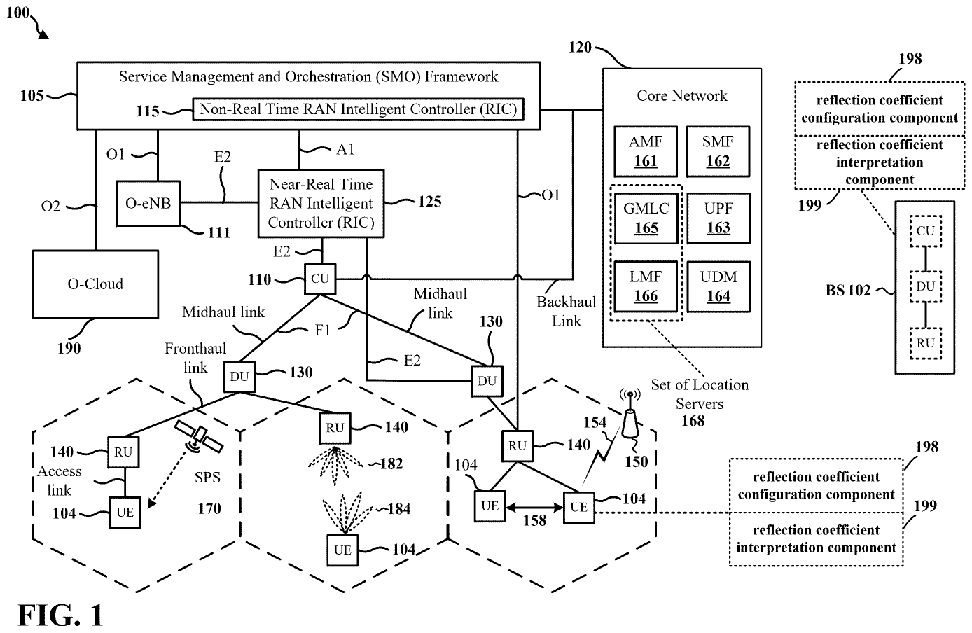

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140. Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 or the base station 102 may have a reflection coefficient configuration component 198 that may be configured to transmit, to a first reconfigurable intelligent surface (RIS), a first configuration of a first set of sensing signals. Each of the first set of sensing signals may be associated with a first RIS reflection coefficient. The reflection coefficient configuration component 198 may transmit the first set of sensing signals along a first reflection path including the first RIS and a target object. The reflection coefficient configuration component 198 may transmit, to at least one of the first RIS or a second RIS, a second configuration of a second set of sensing signals. Each of the second set of sensing signals may be associated with a second RIS reflection coefficient. The reflection coefficient configuration component 198 may transmit the second set of sensing signals along a second reflection path including at least one of the first RIS or the second RIS and the target object. The RIS may reflect the first set of sensing signals based on the first RIS reflection coefficient and may reflect the second set of sensing signals based on the second RIS reflection coefficient. In certain aspects, the UE 104 or the base station 102 may have a reflection coefficient interpretation component 199 that may be configured to obtain a first configuration of a first set of sensing signals associated with a first reflection path including a first RIS. Each of the first set of sensing signals may be associated with a first RIS reflection coefficient. The reflection coefficient interpretation component 199 may receive the first set of sensing signals via the first reflection path. The reflection coefficient interpretation component 199 may calculate a first Doppler frequency of a target object based on the first set of sensing signals and the first configuration. The reflection coefficient interpretation component 199 may obtain a second configuration of a second set of sensing signals associated with a second reflection path including at least one of the first RIS or a second RIS. Each of the second set of sensing signals may be associated with a second RIS reflection coefficient. The reflection coefficient interpretation component 199 may receive the second set of sensing signals via the second reflection path. The reflection coefficient interpretation component 199 may calculate a second Doppler frequency of the target object based on the second set of sensing signals and the second configuration. A velocity of the target object may be calculated based on the first Doppler frequency and the second Doppler frequency.

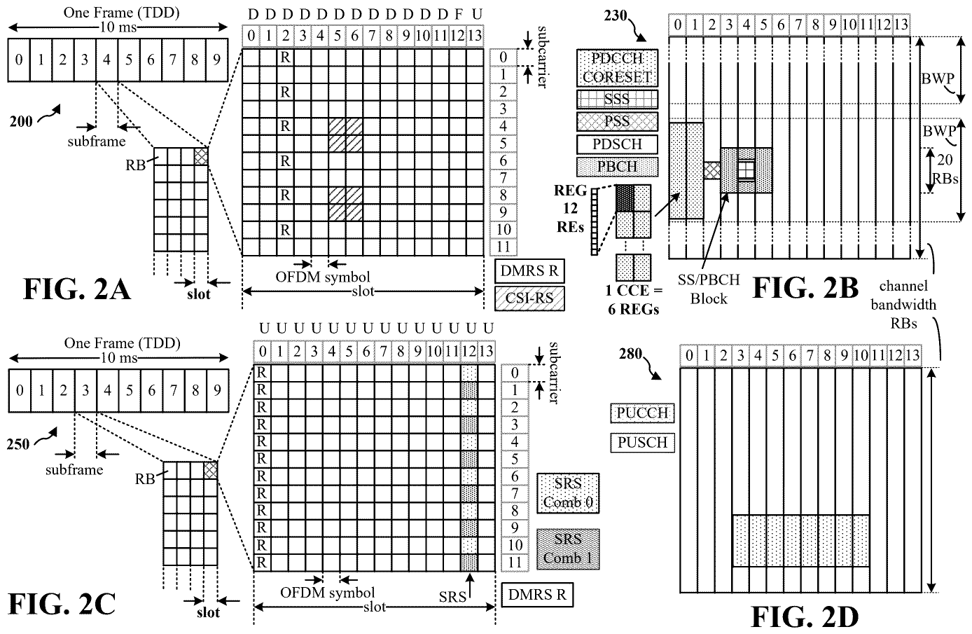

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 24 slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

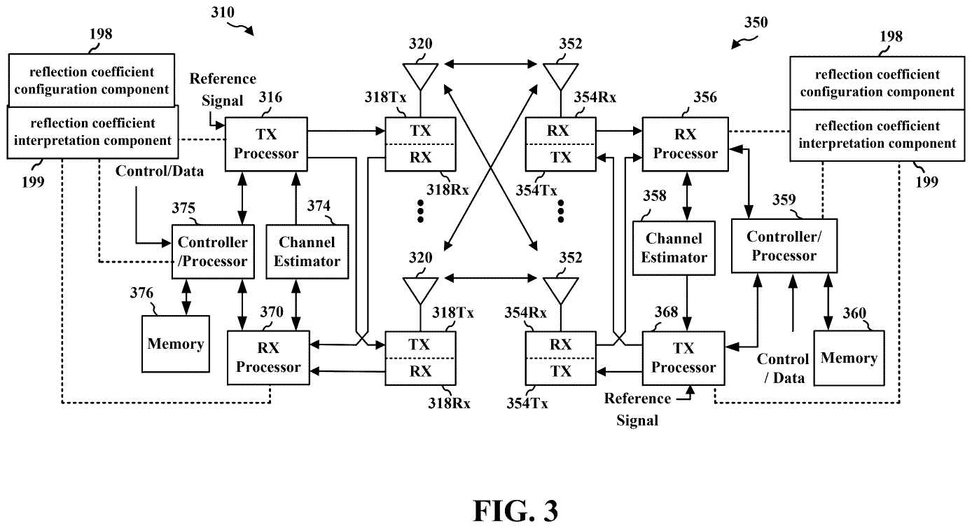

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the reflection coefficient configuration component 198 of FIG. 1.

At least one of the TX processor 368, the RX processor 356, and the controller/processor 359 may be configured to perform aspects in connection with the reflection coefficient interpretation component 199 of FIG. 1.

At least one of the TX processor 316, the RX processor 370, and the controller/processor 375 may be configured to perform aspects in connection with the reflection coefficient configuration component 198 of FIG. 1.

At least one of the TX processor 316, the RX processor 370, and the controller/processor 375 may be configured to perform aspects in connection with the reflection coefficient interpretation component 199 of FIG. 1.

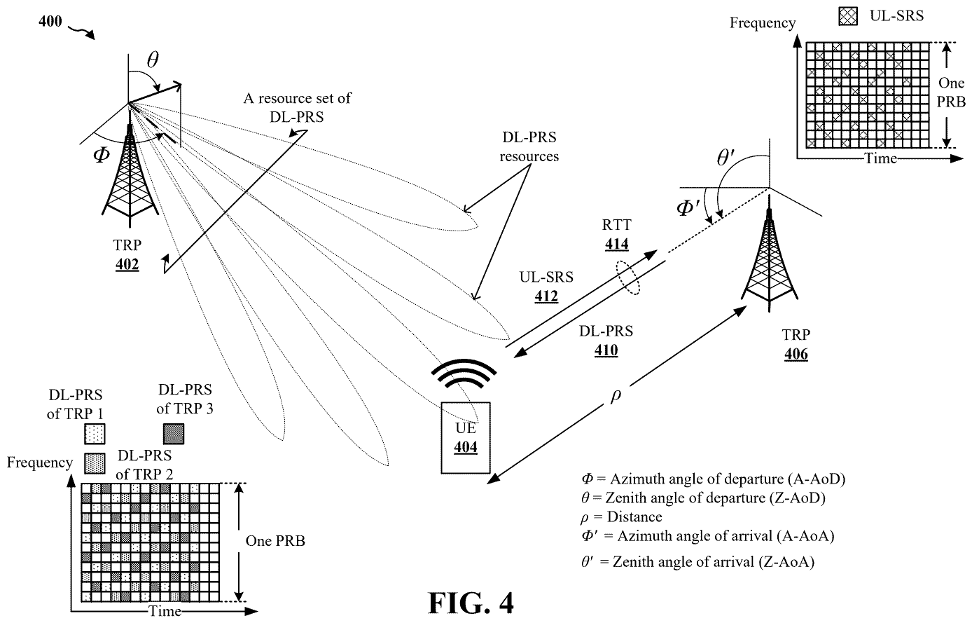

FIG. 4 is a diagram 400 illustrating an example of a UE positioning based on reference signal measurements. The UE 404 may transmit UL-SRS 412 at time TsRS_TX and receive DL positioning reference signals (PRS) (DL-PRS) 410 at time T_{PRS_RX}. The TRP 406 may receive the UL-SRS 412 at time T_{SRS_RX} and transmit the DL-PRS 410 at time T_{PRS_TX}. The UE 404 may receive the DL-PRS 410 before transmitting the UL-SRS 412, or may transmit the UL-SRS 412 before receiving the DL-PRS 410. In both cases, a positioning server (e.g., location server(s) 168) or the UE 404 may determine the RTT 414 based on |T_{SRS_RX}−T_{PRS_TX}|−|T_{SRS_TX}−T_{PRS_RX}∥. Accordingly, multi-RTT positioning may make use of the UE Rx-Tx time difference measurements (i.e., |T_{SRS_TX}−T_{PRS_RX}|) and DL-PRS reference signal received power (RSRP) (DL-PRS-RSRP) of downlink signals received from multiple TRPs 402, 406 and measured by the UE 404, and the measured TRP Rx-Tx time difference measurements (i.e., |T_{SRS_RX}−T_{PRS_TX}|) and UL-SRS-RSRP at multiple TRPs 402, 406 of uplink signals transmitted from UE 404. The UE 404 measures the UE Rx-Tx time difference measurements (and optionally DL-PRS-RSRP of the received signals) using assistance data received from the positioning server, and the TRPs 402, 406 measure the gNB Rx-Tx time difference measurements (and optionally UL-SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

DL-AoD positioning may make use of the measured DL-PRS-RSRP of downlink signals received from multiple TRPs 402, 406 at the UE 404. The UE 404 measures the DL-PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and optionally DL-PRS-RSRP) of downlink signals received from multiple TRPs 402, 406 at the UE 404. The UE 404 measures the DL RSTD (and optionally DL-PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and optionally UL-SRS-RSRP) at multiple TRPs 402, 406 of uplink signals transmitted from UE 404. The TRPs 402, 406 measure the UL-RTOA (and optionally UL-SRS-RSRP) of the received signals using assistance data received from the positioning server, and the resulting measurements are used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404.

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

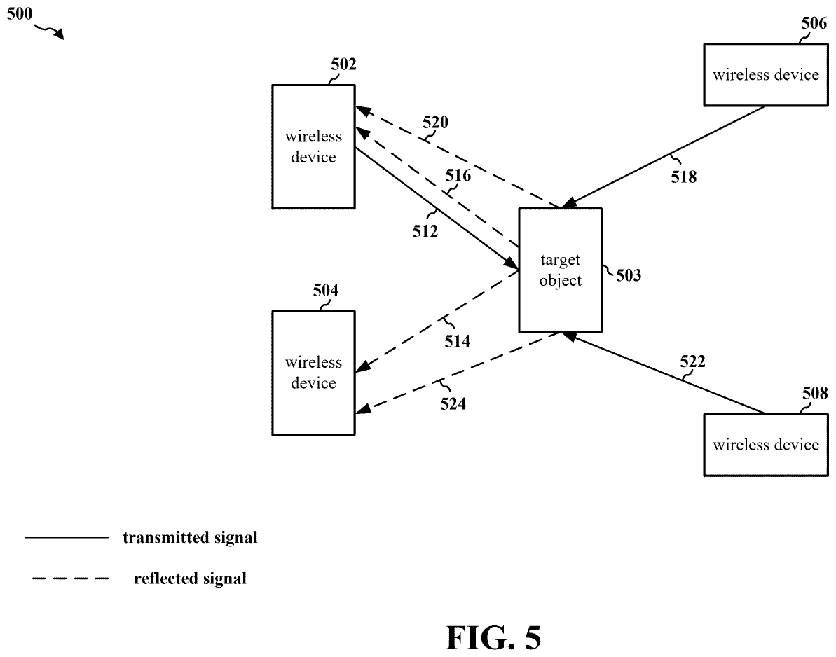

FIG. 5 is a diagram 500 illustrating an example of sensing based on sensing signal measurements. A sensing signal may be any signal transmitted by a wireless device, such as the wireless device 502, the wireless device 506, or the wireless device 508, which may reflect off of the target object 503. The sensing signal may be an RF signal, such as an RS transmitted by a wireless device. In one aspect, the wireless device 502 may perform monostatic sensing, where the wireless device 502 may transmit a set of sensing signals 512 at the target object 503, the target object 503 may reflect the set of sensing signals 512 as the reflected set of sensing signals 516 at the wireless device 502, and the wireless device 502 may measure the reflected set of sensing signals 516 from the target object 503. In another aspect, the wireless device 502 and the wireless device 504 may perform bistatic sensing, where the wireless device 502 may transmit a set of sensing signals 512 at the target object 503, the target object 503 may reflect the set of sensing signals 512 as the reflected set of sensing signals 514 at the wireless device 504, and the wireless device 504 may measure the reflected set of sensing signals 514 from the target object 503. In another aspect the wireless device 502 and the wireless device 506 may perform multi-static sensing, where in addition to the wireless device 502 measuring the reflected set of sensing signals 516 from the target object 503 using monostatic sensing, the wireless device 506 may transmit a set of sensing signals 518 at the target object 503, the target object 503 may reflect the set of sensing signals 518 as the reflected set of sensing signals 520 at the wireless device 502, and the wireless device 502 may measure the reflected set of sensing signals 520 from the target object 503. In another aspect the wireless device 502, the wireless device 504, and the wireless device 508 may perform multi-static sensing, where in addition to the wireless device 504 measuring the reflected set of sensing signals 514 from the target object 503 using bistatic sensing, the wireless device 508 may transmit a set of sensing signals 522 at the target object 503, the target object 503 may reflect the set of sensing signals 522 as the reflected set of sensing signals 524 at the wireless device 504, and the wireless device 504 may measure the reflected set of sensing signals 524 from the target object 503. Each wireless node may be any wireless device configured to transmit or receive wireless signals, such as UEs, network nodes, TRPs, or base stations. For example, the wireless device 502 may be a network node configured to transmit the set of sensing signals 512 at the target object 503 and measure the reflected set of sensing signals 516 from the target object 503. In another example, the wireless device 502 may be a network node configured to transmit the set of sensing signals 512 at the target object 503, and the wireless device 504 may be a UE configured to measure the reflected set of sensing signals 514 from the target object 503.

The wireless device 502 may conduct one or more sensing measurements on the reflected set of sensing signals 516 and/or the reflected set of sensing signals 520. In one aspect, the wireless device 502 may calculate a distance or a range between the wireless device 502 and the target object 503 based on a round trip time (RTT) between when the wireless device 502 transmits the set of sensing signals 512 and when the wireless device 502 receives the reflected set of sensing signals 516. In one aspect, the wireless device 502 may calculate a distance or a range that the set of sensing signals 518 and the reflected set of sensing signals 520 travels based on a time between when the wireless device 506 transmits the set of sensing signals 518 and when the wireless device 502 receives the reflected set of sensing signals 520. In one aspect, the wireless device 502 may calculate a location of the target object 503 based on a plurality or range or distance measurements, for example via triangulation using known positions of the wireless devices 502 and 506 and the calculated range or distance measurements. In one aspect, the wireless device 502 may calculate a velocity of the target object 503 based on a first calculated location of the target object 503 based on the reflected set of sensing signals 516 and/or the reflected set of sensing signals 520 measured at a first time, and a second calculated location of the target object 503 based on the reflected set of sensing signals 516 and/or the reflected set of sensing signals 520 measured at a second time. In one aspect, the wireless device 502 may calculate an AoA of the reflected set of sensing signals 516 and/or an AoD of the set of sensing signals 512 based on a plurality of ports that transmitted the set of sensing signals 512 and a plurality of ports that received the reflected set of sensing signals 516. In one aspect, the wireless device 502 may calculate an AoA of the reflected set of sensing signals 520 and/or an AoD of the set of sensing signals 518 based on a plurality of ports that transmitted the set of sensing signals 518 and a plurality of ports that received the reflected set of sensing signals 520.

Similarly, the wireless device 504 may conduct one or more sensing measurements on the reflected set of sensing signals 514 and/or the reflected set of sensing signals 524. In one aspect, the wireless device 504 may calculate a distance or a range that the set of sensing signals 512 and the reflected set of sensing signals 514 travels based on a on a time between when the wireless device 502 transmits the set of sensing signals 512 and when the wireless device 504 receives the reflected set of sensing signals 514. In one aspect, the wireless device 504 may calculate a distance or a range that the set of sensing signals 522 and the reflected set of sensing signals 524 travels based on a time between when the wireless device 508 transmits the set of sensing signals 522 and when the wireless device 504 receives the reflected set of sensing signals 524. In one aspect, the wireless device 504 may calculate a location of the target object 503 based on a plurality or range or distance measurements, for example via triangulation using the known positions of wireless devices 502, 504, and 508, and the calculated range or distance measurements. In one aspect, the wireless device 504 may calculate a velocity of the target object 503 based on a first calculated location of the target object 503 based on the reflected set of sensing signals 514 and/or the reflected set of sensing signals 524 measured at a first time, and a second calculated location of the target object 503 based on the reflected set of sensing signals 514 and/or the reflected set of sensing signals 524 measured at a second time. In one aspect, the wireless device 504 may calculate an AoA of the reflected set of sensing signals 514 and/or an AoD of the set of sensing signals 512 based on a plurality of ports that transmitted the set of sensing signals 512 and a plurality of ports that received the reflected set of sensing signals 514. In one aspect, the wireless device 504 may calculate an AoA of the reflected set of sensing signals 524 and/or an AoD of the set of sensing signals 522 based on a plurality of ports that transmitted the set of sensing signals 522 and a plurality of ports that received the reflected set of sensing signals 524.

A network node or a UE configured to perform measurements on a set of reflected sensing signals may be configured to transmit a sensing signal report to a sensing server (e.g., an LMF) that coordinates a plurality of wireless nodes to perform sensing on a target object. In order to perform Doppler estimates or velocity estimates of a target object, such as the target object 503 in FIG. 5, or of a UE, such as the UE 104 in FIG. 1, the receiver wireless node may be configured to measure a reflected set of sensing signals at multiple points of time.

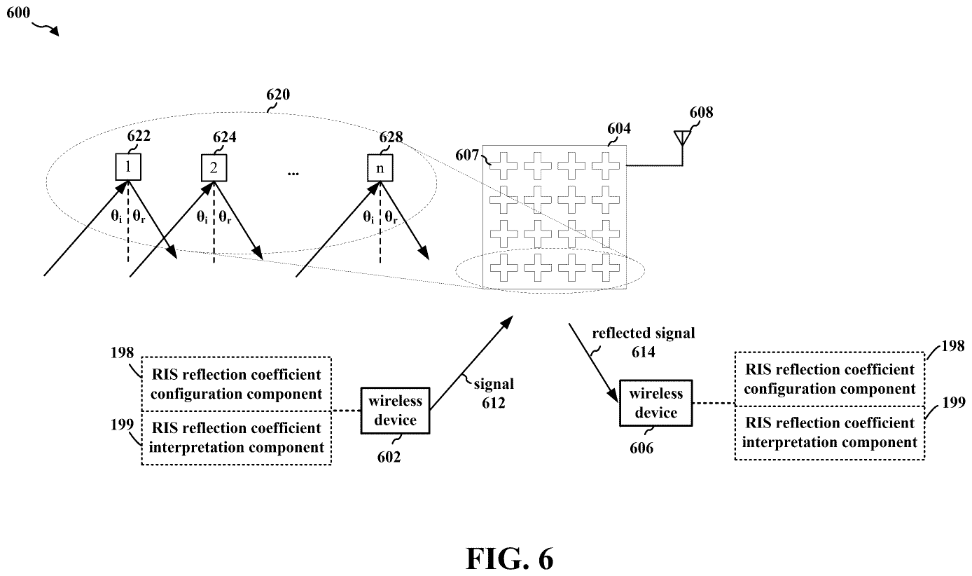

FIG. 6 is a diagram 600 illustrating an example of a RIS 604 configured to receive a signal 612 from a wireless device 602, and forward (e.g., reflect) a signal 614 towards a wireless device 606. The wireless device 602 may be a wireless device configured to transmit the signal 612, such as the UE 104 or the base station 102 in FIG. 1. The wireless device 606 may be a wireless device configured to receive the signal 614, such as the UE 104 or the base station 102 in FIG. 1. The RIS 604 may have an antenna 608 that may be used to transmit data, such as a capability to redirect wireless signals or an indication of a frequency-domain compensation factor, to the wireless device 602 or to the wireless device 606. One or more of the meta-elements 607 of a meta-surface of the RIS 604 may be configured to reflect the signal 612 as the signal 614. One or more of the meta-elements 607 of the RIS 604 may be configured to sense one or more attributes of the signal 612, such as an AoA or a signal strength.

The RIS 604 may have an ultrathin surface inlaid with a plurality of meta-elements 607, which may also be referred to as sub-wavelength scatters or RIS elements. The electromagnetic response, such as phase shifts, of each of the meta-elements 607 may be controlled by programmable PIN diodes or varactor diodes. Each of the meta-elements 607 may be configured to reflect the signal 612 to a desired direction. The configuration of one or more reflective elements may be used to aim a signal 612 in a desired direction. For example, one or more reflection coefficients of one of the meta-elements 607 may be changed to alter a direction that the signal 614 is centered upon. For example, a first coefficient may be altered to change an amplitude of the signal 614 and a second coefficient may be altered to shift a phase of the signal 614. The configuration of the meta-elements 607 of the RIS 604 may depend on the knowledge of the direction of the incident wave of the signal 612. In other words, the accuracy of where a meta-element of the meta-elements 607 centers or aims the signal 614 may be increased using information about the direction that the signal 612 approaches the meta-elements 607 from, or an AoA of the signal 612 relative to the meta-elements 607.

The RIS 604 may allow the wireless device 602 and the wireless device 606 to communicate with one another using wireless signals even if there may not be a line of sight (LOS) path between the transceivers of the wireless device 602 and the wireless device 606. Without the RIS 604, the wireless device 602 may have limited covering distance due to in-return transmission. Without the RIS 604, the wireless device 602 may have a coverage hole in transmitting to wireless devices, such as wireless device 606, if there is no LOS link between the wireless device 602 and a transmission target. Without the RIS 604, the wireless device 602 may not have sufficient positioning reference points, as one network node may provide one reference point. With the RIS 604, the RIS 604 may extend the covering distance via RIS beamforming. With the RIS 604, the RIS 604 may eliminate a coverage hole by using the RIS 604 as a relay point. The RIS 604 may have flexible deployment to have a LOS link to the coverage hole of the wireless device 602. With the RIS 604, an extra reference point with the position of the RIS 604 may be added as a positioning reference points for positioning measurements.

The signal 612 may be transmitted towards the RIS 604 from the wireless device 602 at an incident angle θᵢ, and the signal 614 may be reflected or forwarded towards the wireless device 606 from the RIS 604 at a reflection angle θᵣ. The incident angle θᵢ and the reflection angle θᵣ may be estimated by the wireless device 602 in any suitable manner, for example based on a location indication of the wireless device 602, a location indication of the RIS 604, and a location indication of the wireless device 606. The wireless device 602 may transmit a query to a LMF, such as the LMF 166 in FIG. 1, to retrieve location information associated with the wireless device 602, the RIS 604, and/or the wireless device 606, respectively. In some aspects, at least one of the wireless device 602, the RIS 604, and/or the wireless device 606 may perform positioning using one or more positioning reference signals in order to retrieve location information associated with the wireless device 602, the RIS 604, and/or the wireless device 606, respectively. In some aspects, at least one of the wireless device 602, the RIS 604, and/or the wireless device 606 may perform sensing using one or more sensing reference signals in order to retrieve location information associated with the wireless device 602, the RIS 604, and/or the wireless device 606, respectively. In some aspects, the location/position of the wireless device 602, the RIS 604, and/or the wireless device 606 may be fixed.

A section 620 of the RIS 604 may have an element 622, an element 624, and an element 628. The elements may be identified as elements 1 to n. The signal 612 may approach each of the elements 622, 624, and 628 at an incident angle θᵢ and may be reflected by each of the elements 622, 624, and 628, respectively, at a reflection angle θᵣ. The equivalent channel response value of the nth element, such as the element 628, of the RIS 604 at a reflection angle θᵣₙ may be estimated as

$${h}_{n} = {e}^{j \frac{2 π {d}_{n}}{λ} ( sin {θ}_{i} + sin {θ}_{r} )} \times {α}_{n} {e}^{j {φ}_{n}} .$$

αₙe^{jφ}^{ₙ} may be the reflection coefficient of the element n, such as the element 628.

dₙ may be the distance between the nth element to the first element, such as the distance between the element 628 and the element 622.

j may be a complex value symbol.

λ may be the wavelength of the signal reflected off of the element n, such as the element 628.

αₙ may be an amplitude of a reflection coefficient at the nth element

The overall equivalent channel response value of all of the elements of the RIS 604 at the reflection angle θᵣ may be estimated as

$$h = {\sum }_{n = 1}^{N} {h}_{n} = {\sum }_{n = 1}^{N} {e}^{j \frac{2 π {d}_{n}}{λ} ( sin {θ}_{i} + sin {θ}_{r} )} \times {α}_{n} {e}^{j {φ}_{n}}$$

If the reflection coefficient satisfies αₙ≡α, then the value of φₙ may be estimated as

$${φ}_{n} = - \frac{2 π {d}_{n}}{λ} ( sin {θ}_{i} + sin {θ}_{r} )$$

The reflected beam may point to the direction Or.

The coefficient amplitude and phase values of each of the meta-elements 607 of the RIS 604 may be obtained from a limited candidate reflection coefficient set {(a₁, φ₁), (a₂, φ₂), . . . , (a_{M}, φ_{M})} by different configurations, where aₘ may be the amplitude of the mth candidate reflection coefficient and φₘ may be the phase of the mth candidate reflection coefficient. In other words, the actual beam shape may deviate from the ideal estimated beam direction θᵣ. The larger the number of meta-elements 607 of RIS 604, the closer the actual beam shape may be to the ideal beam, which may increase the accuracy of the estimated beam direction θᵣ.

For the RIS 604, the amplitude and the phase of reflection coefficient at each of the meta-elements 607 may vary with frequency. The amplitude and/or the phase relationship with frequency characteristics may depend on the hardware structure of the RIS 604. In some aspects, the coefficient phase of each meta-element may change substantially linearly with the frequency. In other aspects, the coefficient phase of each meta-element may change non-linearly with the frequency. In some aspects, the coefficient amplitude may have a slight variance with frequency. For each meta-element configuration, the reflection coefficient amplitude and phase may be frequency-dependent, and may be expressed by

$$ψ ( f ) = \{ ( {a}_{1} ( f ) , {ϕ}_{1} ( f ) ) , ( {a}_{2} ( f ) , {ϕ}_{2} ( f ) ) , … , ( {a}_{M} ( f ) , {ϕ}_{M} ( f ) ) \}$$

While a network having a plurality of wireless devices, such as the wireless devices 502, 504, 506, and 508 in FIG. 5, may be used to perform sensing on a target object, deploying multiple wireless devices in an area to sense the target object may be costly, particularly if the deployed wireless device is a network node, such as a TRP. One wireless device may be used to sense the presence of a target object, but one wireless device with one set of sensing signals may not provide high-resolution of a target object. For example, one wireless device with one set of sensing signals may sense the presence of a human in a direction, but may not recognize the shape of the human or recognize hand/body gestures of the human. Moreover, one wireless device with one set of sensing signals may sense a Doppler frequency of the target object in one direction, but may not be able to measure a Doppler frequency of the target object in another direction that is non-parallel to the first direction. For example, a wireless device may estimate the Doppler frequency fa of a target object in one direction based on phase variation of the received signals over time. The wireless device may calculate f_{d} as

$${f}_{d} = \frac{Δφ}{2 π T} ,$$

and may calculate velocity of the wireless device as

$$v = \frac{{f}_{d}}{{f}_{c}} c .$$

While the wireless device may calculate a velocity of the target object in the incident direction of the target object using the measurement of the Doppler frequency, the wireless device may not be able to calculate the velocity of the target object in a direction perpendicular to the incident direction without performing an additional sensing measurement at an angle to the incident direction of the target object. To obtain an accurate velocity of a target object, the wireless device may calculate sensing signals reflected off of the target object in multiple directions.

Adding reflective devices to an area about a target object, such as the RIS 604 in FIG. 6, may enable a wireless device to transmit a plurality of sets of sensing signals to a target object via a plurality of paths, such as the target object 503 in FIG. 5. For example, a wireless device may transmit a set of sensing signals directly at the target object, and may transmit a set of sensing signals indirectly at the target object by reflecting the sensing signals off of the reflective device. Deploying reflective devices to an environment about a target object may be cheaper in deployment, hardware, radio resources, and network consumption than deploying additional wireless devices about the target object. Moreover, a RIS may use elements to reshape a reflective beam. For example, a RIS may reshape a wide beam received by its surface to a narrow beam aimed at a target object, improving the spatial resolution of the reflected beam off of the target object. In some aspects, a RIS may be controlled by a network. For example, the RIS 604 may be controlled by a wired connection to a network node, such as the base station 102 in FIG. 1. In another example, the RIS 604 may be controlled by a wireless connection to a network node, such as a network node that transmits commands to the RIS via an SSB, PDCCH, or PDSCH transmission. The RIS 604 may respond to the network node via a PRACH, PUCCH, or PUSCH transmission. In other embodiments, the RIS 604 may respond to a command by reflecting the command using a modulated reflective transmission, which may contain a response via the reflection pattern selection.

The wireless device 602 or the wireless device 606 may have a component 198 configured to transmit, to a first RIS, a first configuration of a first set of sensing signals. Each of the first set of sensing signals may be associated with a first RIS reflection coefficient. The component 198 may transmit the first set of sensing signals along a first reflection path including the first RIS and a target object. The component 198 may transmit, to at least one of the first RIS or a second RIS, a second configuration of a second set of sensing signals. Each of the second set of sensing signals is associated with a second RIS reflection coefficient. The component 198 may transmit the second set of sensing signals along a second reflection path including at least one of the first RIS or the second RIS and the target object. The RIS may reflect the first set of sensing signals based on the first RIS reflection coefficient and may reflect the second set of sensing signals based on the second RIS reflection coefficient.

The wireless device 602 or the wireless device 606 may have a component 199 configured to obtain a first configuration of a first set of sensing signals associated with a first reflection path including a first RIS. Each of the first set of sensing signals may be associated with a first RIS reflection coefficient. The component 199 may receive the first set of sensing signals via the first reflection path. The component 199 may calculate a first Doppler frequency of a target object based on the first set of sensing signals and the first configuration. The component 199 may obtain a second configuration of a second set of sensing signals associated with a second reflection path including at least one of the first RIS or a second RIS. Each of the second set of sensing signals may be associated with a second RIS reflection coefficient. The component 199 may receive the second set of sensing signals via the second reflection path. The component 199 may calculate a second Doppler frequency of the target object based on the second set of sensing signals and the second configuration. A velocity of the target object may be calculated based on the first Doppler frequency and the second Doppler frequency.

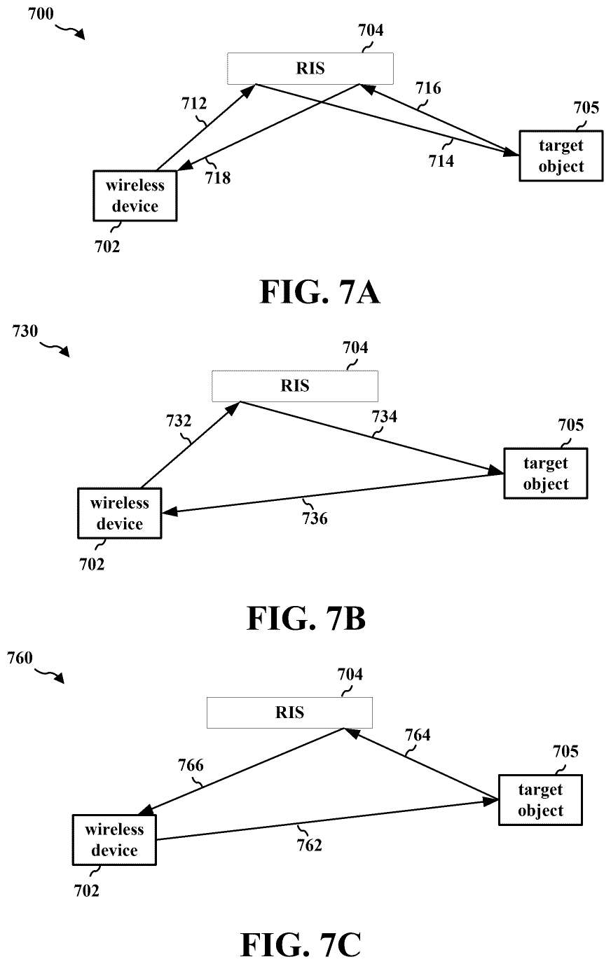

FIG. 7A is a diagram 700 illustrating an example of a RIS 704 configured to assist a wireless device 702 in performing monostatic sensing of a target object 705 via a first reflective path. The wireless device 702 may transmit a first reflection coefficient to the RIS 704. The wireless device 702 may transmit a set of sensing signals 712 to the RIS 704. The RIS 704 may reflect the set of sensing signals 712 based on the first reflection coefficient for the set of sensing signals 712 as the set of sensing signals 714. The set of sensing signals 714 may reflect off of the target object 705 as the set of sensing signals 716. In some aspects the RIS 704 may reflect the set of sensing signals 716 based on the first reflection coefficient as the set of sensing signals 718. In other aspects, the wireless device 702 may transmit a second reflection coefficient to the RIS 704, and the RIS 704 may reflect the set of sensing signals 716 based on the second reflection coefficient as the set of sensing signals 718. The wireless device 702 may calculate a Doppler frequency of the target object 705 based on the received set of sensing signals. This allows the wireless device 702 to calculate a Doppler frequency of the target object 705 at an angle incident with the set of sensing signals 714 or the set of sensing signals 716.

FIG. 7B is a diagram 730 illustrating an example of a RIS 704 configured to assist a wireless device 702 in performing monostatic sensing of a target object 705 via a second reflective path. The wireless device 702 may transmit a reflection coefficient to the RIS 704. This reflection coefficient may be different than the first and/or second reflection coefficient for the set of sensing signals 712 and/or the set of sensing signals 716 in FIG. 7A. The wireless device 702 may transmit a set of sensing signals 732 to the RIS 704. The RIS 704 may reflect the set of sensing signals 732 based on the reflection coefficient for the set of sensing signals 732 as the set of sensing signals 734. The set of sensing signals 714 may reflect off of the target object 705 as the set of sensing signals 736 towards the wireless device 702. The wireless device 702 may calculate a Doppler frequency of the target object 705 based on the received set of sensing signals. This allows the wireless device 702 to calculate a Doppler frequency of the target object 705 at an angle incident with the set of sensing signals 734 or the set of sensing signals 736.

FIG. 7C is a diagram 760 illustrating an example of a RIS 704 configured to assist a wireless device 702 in performing monostatic sensing of a target object 705 via a third reflective path. The wireless device 702 may transmit a reflection coefficient to the RIS 704. This reflection coefficient may be different than the reflection coefficient for the set of sensing signals 712 in FIG. 7A and for the set of sensing signals 732 in FIG. 7B. The wireless device 702 may transmit a set of sensing signals 762 to the target object 705. The set of sensing signals 762 may reflect off of the target object 705 as the set of sensing signals 764 to the RIS 704. RIS 704 may reflect the set of sensing signals 764 based on the reflection coefficient for the set of sensing signals 762 as the set of sensing signals 766 to the wireless device 702. The wireless device 702 may calculate a Doppler frequency of the target object 705 based on the received set of sensing signals. This allows the wireless device 702 to calculate a Doppler frequency of the target object 705 at an angle incident with the set of sensing signals 762 or the set of sensing signals 764. While the angle incident with the set of sensing signals 764 may be the same as the angle incident with the set of sensing signals 716 in FIG. 7A, the third reflective path may be shorter than the first reflective path, decreasing the required time period between transmissions of the wireless device 702 in FIG. 7C as compared to the transmissions of the wireless device 702 in FIG. 7A.

Thus, the RIS 704 may be used to reflect a set of sensing signals along first path in FIG. 7A (where the RIS may work in monostatic mode with two bidirectional reflections), may be used to reflect a set of sensing signals along a second path in FIG. 7B (where the RIS may work in bistatic mode with one reflection), and/or may be used to reflect a set of sensing signals along a third path in FIG. 7C (where the RIS may work in bistatic mode with one reflection). In addition, the wireless device 702 may reflect a set of sensing signals directly off of the target object 705 and back to itself along a fourth path, similar to how the wireless device 502 may reflect the set of sensing signals 512 off of the target object 503 as the reflected set of sensing signals 516. The wireless device 702 may measure Doppler frequencies of at least two of these four paths to calculate the velocity of the target object 705. For example, the velocity vector [symbol] =[vₓ, v_{y}, v_{z}], where vₓ may be the velocity of the target object 705 in an x direction, v_{y} may be the velocity of the target object 705 in a y direction perpendicular to the x direction, and v_{z} may be the velocity of the target object 705 in a z direction perpendicular to both the x direction and the y direction. While FIGS. 7A, 7B, and 7C illustrate examples of a single RIS assisting a single wireless device in performing monostatic sensing using a plurality of paths, a plurality of RISs may be used to assist one or more wireless devices in performing monostatic sensing, or bistatic sensing.

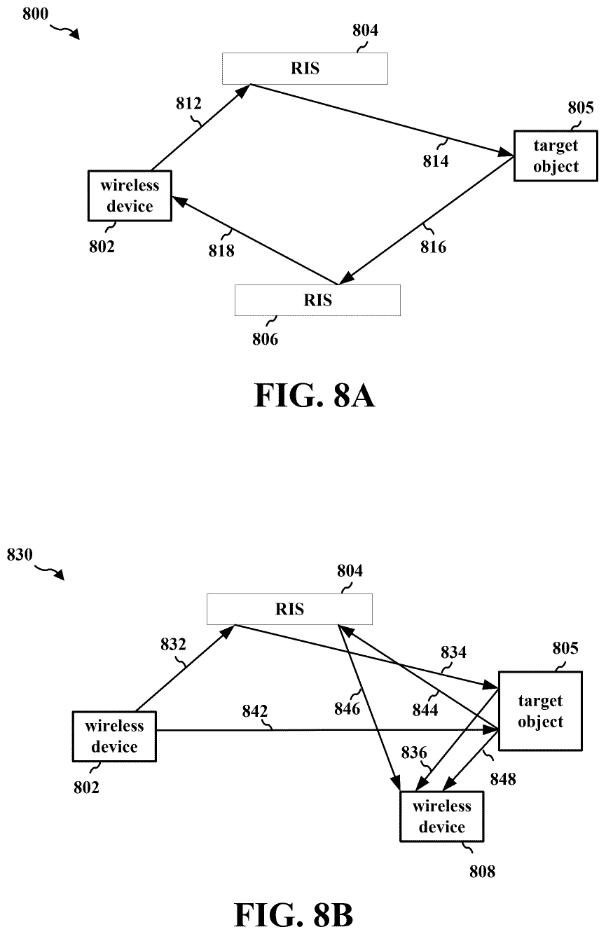

FIG. 8A is a diagram 800 illustrating an example of a RIS 804 and a RIS 806 configured to assist a wireless device 802 in performing monostatic sensing of a target object 805 via a plurality of reflective paths. The wireless device 802 may transmit a first reflection coefficient to the RIS 804 and a second reflection coefficient to the RIS 806. The wireless device 802 may transmit a set of sensing signals 812 to the RIS 804. The RIS 804 may reflect the set of sensing signals 812 based on the first reflection coefficient for the set of sensing signals 812 as the set of sensing signals 814. The set of sensing signals 814 may reflect off of the target object 805 as the set of sensing signals 816. The RIS 804 may reflect the set of sensing signals 816 based on the second reflection coefficient as the set of sensing signals 818. The wireless device 802 may calculate a Doppler frequency of the target object 805 based on the received set of sensing signals based on the reflection coefficient. This allows the wireless device 802 to calculate a Doppler frequency of the target object 805 at an angle incident with the set of sensing signals 814 or an angle incident with the set of sensing signals 816. An additional path may be formed by reversing the path of the set of sensing signals to reflect off of the RIS 806, then the target object 805, then the RIS 804, and back to the wireless device 802. An additional four paths may be formed by reflecting a set of sensing signals to reflect off of one RIS, such as in FIGS. 7B and 7C, and one more path may be formed by reflecting a set of sensing signals directly off of the target object 805 and back to the wireless device 802. Thus, the wireless device 802 may reflect a set of sensing signals off of the target object 805 via seven different paths, enabling the wireless device 802 to dynamically perform monostatic sensing using multiple paths to increase accuracy of the measurements, or to provide multiple options in case one or more of the paths are blocked by an obstacle or an interfering signal. The wireless device 802 may measure Doppler frequencies of at least two of these seven paths to calculate the velocity of the target object 705.

While FIGS. 7A, 7B, 7C, and 8A illustrate examples of a single wireless device performing monostatic sensing with one or more reflective devices using a plurality of paths, a plurality of wireless devices may be used to perform bistatic sensing using a plurality of paths.

FIG. 8B is a diagram 830 illustrating an example of a RIS 804 configured to assist a wireless device 802 and a wireless device 808 in performing bistatic sensing of a target object 805 via a plurality of reflective paths. The wireless device 802 may transmit a first reflection coefficient to the RIS 804. The wireless device 802 may transmit a set of sensing signals 832 to the RIS 804. The RIS 804 may reflect the set of sensing signals 832 based on the first reflection coefficient for the set of sensing signals 832 as the set of sensing signals 834. The set of sensing signals 834 may reflect off of the target object 805 as the set of sensing signals 836. The wireless device 808 may receive the set of sensing signals 834. The wireless device 802 may calculate a first Doppler frequency of the target object 805 based on the received set of sensing signals and based on the first reflection coefficient. This allows the wireless device 808 to calculate a Doppler frequency of the target object 805 at an angle incident with the set of sensing signals 834 or an angle incident with the set of sensing signals 836. The wireless device 802 may transmit a set of sensing signals 842 to the target object 805. The set of sensing signals 842 may reflect off of the target object 805 as the set of sensing signals 844. In one aspect, the RIS 804 may reflect the set of sensing signals 844 based on the first reflection coefficient as the set of sensing signals 846. In another aspect, the wireless device 802 may transmit a second reflection coefficient to the RIS 804, and the RIS 804 may reflect the set of sensing signals 844 based on the second reflection coefficient as the set of sensing signals 846. The wireless device 808 may receive the set of sensing signals 846. The wireless device 802 may calculate a second Doppler frequency of the target object 805 based on the received set of sensing signals and based on the first reflection coefficient or the second reflection coefficient. This allows the wireless device 808 to calculate a Doppler frequency of the target object 805 at an angle incident with the set of sensing signals 842 or an angle incident with the set of sensing signals 844.

The wireless device 802 may transmit a set of sensing signals 842 to the target object 805. The set of sensing signals 842 may reflect off of the target object 805 as the set of sensing signals 848. The wireless device 808 may receive the set of sensing signals 848. The wireless device 802 may calculate a third Doppler frequency of the target object 805 based on the received set of sensing signals. This allows the wireless device 808 to calculate a Doppler frequency of the target object 805 at an angle incident with the set of sensing signals 842 or an angle incident with the set of sensing signals 848. The wireless device 808 may measure Doppler frequencies of at least two of these three paths to calculate the velocity of the target object 705. Such bistatic configurations may be extended to the aspects shown in FIGS. 7A, 7B, 7C, and 8A.

For each sensing signal radio resource corresponding to a reflection path, the receiver wireless device may receive the sensing signals at multiple periodical time occasions, which may be denoted as y₁, y₂, . . . , y_{N}. The interval between two adjacent time occasions may be referred to as T. The receiver wireless device may estimate the Doppler frequency of the target object by calculating the phase shift of the two adjacent time occasions as

$${φ}_{n} = phase ( \frac{{y}_{n + 1}}{{y}_{n}} ) ,$$

n=1, 2, . . . , N−1. The receiver wireless device may then estimate/calculate the average phase shift as

$$\overline{φ} = \frac{1}{N - 1} {\sum }_{n = 1}^{N - 1} {φ}_{n} ,$$

and the Doppler frequency as

$${\hat{f}}_{d} = \frac{\overline{φ}}{2 π T} .$$

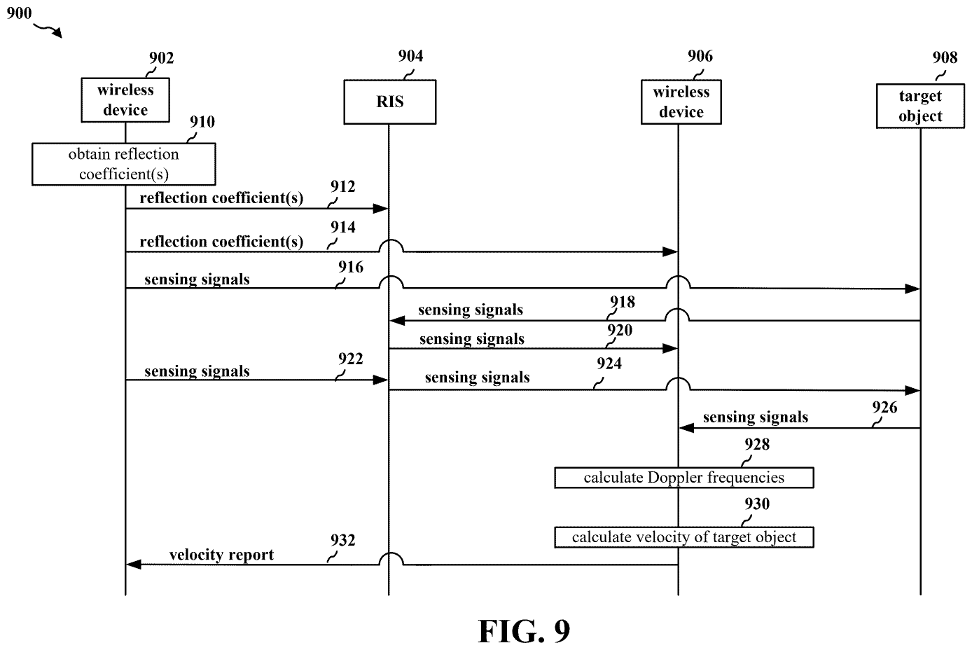

FIG. 9 is a connection flow diagram 900 illustrating an example of communications between a wireless device 902, a RIS 904, and a wireless device 906 to assist in performing bistatic sensing on a target object 908. The wireless device 902 may be a sensing transmitter. The wireless device 906 may be a sensing receiver. The wireless device 902 may be a network node or a UE. The wireless device 906 may be a network node or a UE. The position of the RIS 904 may be known to the wireless device 902. In some aspects, the RIS 904 may be configured to indicate its position to the wireless device 902, or the wireless device 902 may be configured to perform positioning on the RIS 904 to calculate its position.

At 910, the wireless device 902 may obtain a plurality of reflection coefficients for a plurality of reflection paths, such as the first reflection path including the set of sensing signals 916 from the wireless device 902 to the target object 908, the set of sensing signals 918 from the target object 908 to the RIS 904, and the set of sensing signals 920 from the RIS 904 to the wireless device 906, and the second reflection path including the set of sensing signals 922 from the wireless device 902 to the RIS 904, the set of sensing signals 924 from the RIS 904 to the target object 908, and the set of sensing signals 926 from the target object 908 to the wireless device 906. In some aspects, the wireless device 902 may receive the plurality of reflection coefficients from another wireless entity, such as an LMF or a sensing entity configuring the sensing occasion. In other aspects, the wireless device 902 may configure a first reflection coefficient for the first reflection path and a second reflection coefficient for the second reflection path. In some aspects, the wireless device 902 may configure a plurality of periodical sensing signal radio resources for velocity measurement purposes to the RIS 904. The inter-occasion interval length between two occasions for each radio resource may be configured to ensure that the occasions do not interfere with one another. The RIS 904 may be configured to keep the reflection coefficient of each meta element identical in each of the periodical time occurrences for each radio resource. For example, for a first time occasion, the RIS 904 may use the first reflection coefficient for the first path while the wireless device 902 transmits the set of sensing signals 916. For a second time occasion after the first time occasion, the RIS 904 may use the second reflection coefficient for the second path while the wireless device 902 transmits the set of sensing signals 922. For a third time occasion after the second time occasion, the RIS 904 may use the first reflection coefficient for the first path while the wireless device 902 transmits the set of sensing signals 916. For a fourth time occasion after the third time occasion, the RIS 904 may use the second reflection coefficient for the second path while the wireless device 902 transmits the set of sensing signals 922. The wireless device 902 may configure one reflection coefficient for each path. While two paths are shown in FIG. 9, the wireless device 902 may configure additional paths, for example a path from the wireless device 902 to the RIS 904 to the target object 908 back to the RIS 904 and to the wireless device 906. The RIS 904 may be configured to keep the reflection coefficient of each meta element identical in each of the periodical time occurrences for each corresponding reflection beam, radio resource, and/or path.

The wireless device 902 may transmit the set of reflection coefficients 912 to the RIS 904. The RIS 904 may receive the set of reflection coefficients 912. The set of reflection coefficients 912 may include the first reflection coefficient and/or the second reflection coefficient. The wireless device 902 may transmit the set of reflection coefficients 914 to the wireless device 906. The wireless device 906 may receive the set of reflection coefficients 914. The set of reflection coefficients 914 may include the first reflection coefficient and/or the second reflection coefficient. The wireless device 902 may transmit the set of reflection coefficients 912 and/or the set of reflection coefficients 914 in an RRC configuration, DCI, or a MAC-CE. In some aspects, the wireless device 902 may transmit the position of the wireless device 902 and/or the position of the RIS 904 to the wireless device 906.

The wireless device 902 may transmit the set of sensing signals 916 to the target object 908 for a first reflection path. The target object may reflect the set of sensing signals 916 as the set of sensing signals 918 to the RIS 904 for the first reflection path. The RIS 904 may reflect the set of sensing signals 918 as the set of sensing signals 920 based on the first reflection coefficient for the first reflection path. The wireless device 906 may receive the set of sensing signals 920 from the RIS 904 via the first reflection path.

The wireless device 902 may transmit the set of sensing signals 922 to the RIS 904. The RIS 904 may reflect set of sensing signals 922 as the set of sensing signals 924 based on the second reflection coefficient for the second reflection path. The target object may reflect the set of sensing signals 924 as the set of sensing signals 926 to the wireless device 906 for the second reflection path. The wireless device 906 may receive the set of sensing signals 926 from the target object 908.

At 928, the wireless device 906 may calculate the Doppler frequencies of each of the set of sensing signals 920 and the set of sensing signals 926 based on the respective reflection coefficients. At 930, the wireless device 906 may calculate the velocity of the target object 908 based on the calculated Doppler frequencies. For each sensing signal resource, the wireless device 906 may receive the set of sensing signals at multiple periodical time occasions. Each time occasion may be denoted as y₁, y₂, . . . , y_{N}, where the interval between two adjacent time occasions may be denoted as T. The wireless device 906 may calculate the phase shift of two adjacent time occasions as

$${φ}_{n} = phase ( \frac{{y}_{n + 1}}{{y}_{n}} ) ,$$

where n=0, 1, 2, . . . , N−1 the periodical time occasion. The wireless device 906 may calculate the average phase shift to be

$$\overline{φ} = \frac{1}{N - 1} {\sum }_{n = 1}^{N - 1} {φ}_{n} .$$

The wireless device 906 may calculate the doppler frequency of the target object 908 to be

$${\hat{f}}_{d} = \frac{\overline{φ}}{2 π T} .$$

The wireless device 906 may calculate one or more Doppler frequencies as \hat{f}_{d,m}, where m=1~M may be the index of the sensing signal resource.

In some aspects, the wireless device 906 may be configured to transmit a velocity report 932 to the wireless device 902 or to another wireless device, such as a sensing entity. The wireless device 906 may transmit the velocity report 932 via a level 1 (L1) measurement report, such as a channel state information (CSI) report or a level 3 (L3) measurement report. The measurement report may include a position of the wireless device 906. The wireless device 906 may calculate its position via positioning or via a sensor, such as a GNSS device.

The velocity report may include a Doppler frequency value for each sensing signal resource (e.g., each distinct path). The calculated velocity report may include a quantization value of

$${\{ {\hat{f}}_{d , m} \}}_{m = 1}^{M} .$$

The calculated velocity report may include an absolute value for each \hat{f}_{d,m}. The calculated velocity report may include a relative (i.e., differential) value for each fam as compared to \hat{f}_{d,m-1}, and may include an absolute value for \hat{f}_{d,0}. The calculated velocity report may include a certain number K of maximum Doppler frequency values for the target object 908. The wireless device 906 may sort all calculated Doppler frequencies by size, and may select the K largest calculated Doppler frequencies. The wireless device 906 may report the quantitation results of the selected Doppler frequencies with absolute or relative values in the calculated velocity report. The calculated velocity report may include the indexes of sensing signal resources (e.g., RIS beams or coefficients) corresponding to each of the selected Doppler frequencies.

The velocity report may include a velocity component corresponding with a transmission path. A velocity component may be calculated in the direction of the line connecting a device transmitting or reflecting a set of sensing signals to the target object 908 as [symbol] . A velocity component may be calculated in the direction of the line connecting the target object 908 and the device receiving the reflected set of sensing signals from the target object 908 as [symbol] ₂. The wireless device 906 may calculate the value | [symbol] ₁| based on \hat{f}_{d,1} and may calculate the value | [symbol] ₂| based on \hat{f}_{d,2}. For example, for the first path including the set of sensing signals 916, the set of sensing signals 918, and the set of sensing signals 920, the distance between the wireless device 902 may be equal to the distance between the target object 908 and the RIS 904 added to the distance between the RIS 904 and the wireless device 906. The velocity component value [symbol] ₁ may be estimated as

$$\vert {\vec{v}}_{1} \vert = \frac{1}{2} \cdot \frac{{\hat{f}}_{d , 1}}{{f}_{c}} \cdot c .$$

For the second path including the set of sensing signals 922, the set of sensing signals 924, and the set of sensing signals 926, the velocity component value of [symbol] ₂ may be calculated based on

$$\vert {\vec{v}}_{1} \vert - \vert {\vec{v}}_{2} \vert = \frac{{\hat{f}}_{d , 2}}{{f}_{c}} \cdot c .$$

In summary, based on the velocity values and directions (based on the pre-known/pre-measured positions of the RIS 904, the target object 908, the wireless device 906, and the wireless device 902), the value and direction of the velocity of the target object 908 may be calculated.

In some aspects, the wireless device 906 may transmit measurements of the set of sensing signals 920 and the set of sensing signals 926 to the wireless device 902. The wireless device 906 may transmit its position to the wireless device 902. The RIS 904 may transmit its position to the wireless device 902. The wireless device 902 may calculate the velocity of the target object 908 based on the received measurements and the relative positions of the wireless device 902, the RIS 904, and the wireless device 906.

In some aspects, a sensing processing entity may configure the wireless device 902 and the wireless device 906 to coordinate sensing of the target object 908 via the RIS 904. The sensing processing entity may configure the reflection coefficients. The wireless device 906 may transmit the calculated velocity report to the sensing processing entity. In some aspects, the wireless device 906 may transmit measurements of the set of sensing signals 920 and the set of sensing signals 926 to the sensing processing entity. The wireless device 906 may transmit its position to the sensing processing entity. The wireless device 902 may transmit its position to the sensing processing entity. The RIS 904 may transmit its position to the sensing processing entity. The sensing processing entity may calculate the velocity of the target object 908 based on the relative positions of the wireless device 902, the RIS 904, and the wireless device 906. In some aspects, the sensing processing entity may aggregate measurements from a plurality of receiver sensing nodes to calculate the velocity of the target object 908.

While FIG. 9 shows an example of bistatic sensing between the wireless device 902 and the wireless device 906, the RIS 904 may be configured to assist in a wireless device to perform monostatic sensing for example with the set of sensing signals 918 reflecting off of the RIS 904 to the wireless device 902, and the set of sensing signals 924 reflecting off of the target object 1108 to the wireless device 902. The wireless device 902 may measure the sets of sensing signals and calculate the velocity of the target object 908, or may transmit the measurements to a sensing processing entity for calculation of the velocity of the target object 908.

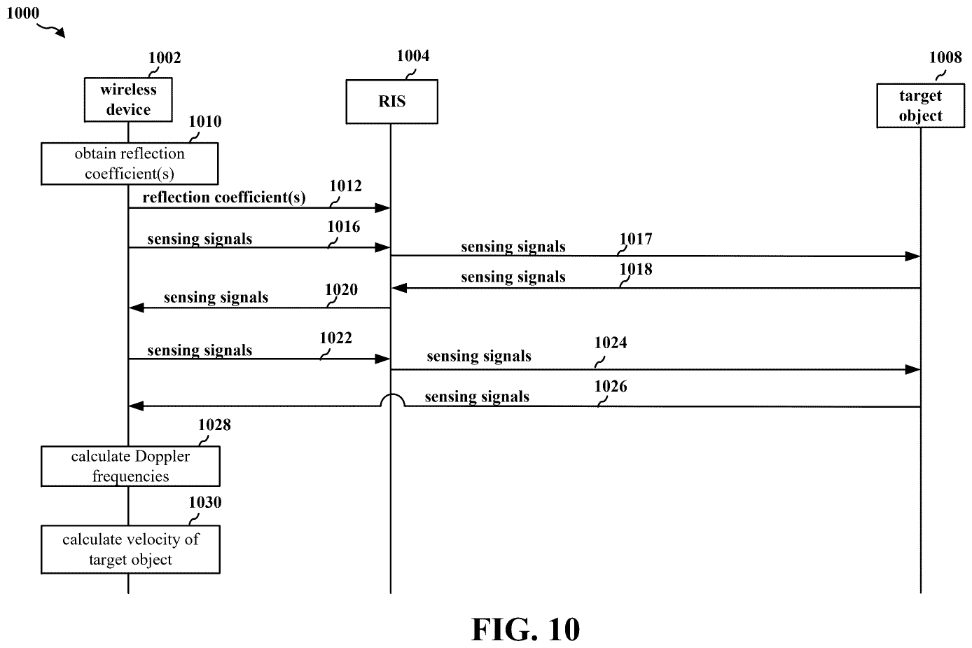

FIG. 10 is a connection flow diagram 1000 illustrating an example of communications between a wireless device 1002 and a RIS 1004 to assist in performing monostatic sensing on a target object 1008. The wireless device 1002 may be a sensing transmitter and a sensing receiver. The wireless device 1002 may be a network node or a UE. The position of the RIS 1004 may be known to the wireless device 1002. In some aspects, the RIS 1004 may be configured to indicate its position to the wireless device 1002, or the wireless device 1002 may be configured to perform positioning on the RIS 1004 to calculate its position.

At 1010, the wireless device 1002 may obtain a plurality of reflection coefficients for a plurality of reflection paths, such as the first reflection path including the set of sensing signals 1016 from the wireless device 1002 to the RIS 1004, the set of sensing signals 1017 from the RIS 1004 to the target object 1008, the set of sensing signals 1018 from the target object 1008 to the RIS 1004, and the set of sensing signals 1020 from the RIS 1004 to the wireless device 1002, and the second reflection path including the set of sensing signals 1022 from the wireless device 1002 to the RIS 1004, the set of sensing signals 1024 from the RIS 1004 to the target object 1008, and the set of sensing signals 1026 from the target object 1008 to the wireless device 1002.

In some aspects, the wireless device 1002 may receive the plurality of reflection coefficients from another wireless entity, such as an LMF or a sensing entity configuring the sensing occasion. In other aspects, the wireless device 1002 may configure a first reflection coefficient for the first reflection path and a second reflection coefficient for the second reflection path. In some aspects, the wireless device 1002 may configure a plurality of periodical sensing signal radio resources for velocity measurement purposes to the RIS 1004. The inter-occasion interval length between two occasions for each radio resource may be configured to ensure that the occasions do not interfere with one another. The RIS 1004 may be configured to keep the reflection coefficient of each meta element identical in each of the periodical time occurrences for each radio resource. The wireless device 1002 may configure one reflection coefficient for each path. While two paths are shown in FIG. 10, the wireless device 1002 may configure additional paths, for example a path from the wireless device 1002 to the target object 1008 to the RIS 1004 back to the wireless device 1002. The RIS 1004 may be configured to keep the reflection coefficient of each meta element identical in each of the periodical time occurrences for each corresponding reflection beam, radio resource, and/or path.

The wireless device 1002 may transmit the set of reflection coefficients 1012 to the RIS 1004. The RIS 1004 may receive the set of reflection coefficients 1012. The set of reflection coefficients 1012 may include the first reflection coefficient and the second reflection coefficient. The wireless device 1002 may transmit the set of reflection coefficients 1012 in an RRC configuration, DCI, or a MAC-CE.

The wireless device 1002 may transmit the set of sensing signals 1016 to the RIS 1004 for a first reflection path. The RIS 1004 may reflect the set of sensing signals 1016 as the set of sensing signals 1017 based on the first reflection coefficient for the first reflection path. The target object may reflect the set of sensing signals 1017 as the set of sensing signals 1018 to the RIS 1004 for the first reflection path. The RIS 1004 may reflect the set of sensing signals 1018 as the set of sensing signals 1020 based on the first reflection coefficient for the first reflection path. The wireless device 1002 may receive the set of sensing signals 1020 from the RIS 1004 via the first reflection path.

The wireless device 1002 may transmit the set of sensing signals 1022 to the RIS 1004. The RIS 1004 may reflect set of sensing signals 1022 as the set of sensing signals 1024 based on the second reflection coefficient for the second reflection path. The target object may reflect the set of sensing signals 1024 as the set of sensing signals 1026 to the wireless device 1002 for the second reflection path. The wireless device 1002 may receive the set of sensing signals 1026 from the target object 1008.

At 1028, the wireless device 1002 may calculate the Doppler frequencies of each of the set of sensing signals 1020 and the set of sensing signals 1026 based on the respective reflection coefficients. At 1030, the wireless device 1002 may calculate the velocity of the target object 1008 based on the calculated Doppler frequencies.

The wireless device 1002 may calculate the velocity of the target object 1008 based on one or more velocity components of the target object 1008. Each velocity component may correspond with a transmission path. A velocity component may be calculated in the direction of the line connecting a device transmitting or reflecting a set of sensing signals to the target object 1008 as [symbol] ₁. A velocity component may be calculated in the direction of the line connecting the target object 1008 and the device receiving the reflected set of sensing signals from the target object 1008 as [symbol] ₂. The wireless device 1002 may calculate the value | [symbol] ₁| based on a calculated quantization value of a Doppler frequency \hat{f}_{d,1} and may calculate the value | [symbol] ₂| based on a calculated quantization value of a Doppler frequency \hat{f}_{d,2}. For example, for the first path including the set of sensing signals 1016, the set of sensing signals 1017, the set of sensing signals 1018, and the set of sensing signals 1020, the reflection at the target object 1008 may return along the same path, such that the incident direction may be equal to the reflection direction. The calculated Doppler frequency value may be related to the velocity component value between the RIS 1004 and the target object 1008, such that the velocity component value [symbol] ₁ may be estimated as

$$\vert {\vec{v}}_{1} \vert = \frac{1}{2} \cdot \frac{{\hat{f}}_{d , 1}}{{f}_{c}} .$$

c. For the second path including the set of sensing signals 1022, the set of sensing signals 1024, and the set of sensing signals 1026, the incident direction may not be equal to the reflection direction. The calculated Doppler frequency value may be related to the difference between the velocity component value between the RIS 1004 and the target object 1008, and the velocity component value between the wireless device 1002 and the target object 1008, such that [symbol] ₂ may be calculated based on

$$\vert {\vec{v}}_{1} \vert - \vert {\vec{v}}_{2} \vert = \frac{{\hat{f}}_{d , 2}}{{f}_{c}} \cdot c .$$

In summary, based on the velocity values and directions (based on the pre-known/pre-measured positions of the RIS 1004, the target object 1008, and the wireless device 1002), the value and direction of the velocity of the target object 1008 may be calculated.

In some aspects, a sensing processing entity may configure the wireless device 1002 to coordinate sensing of the target object 1008 via the RIS 1004. The sensing processing entity may configure the reflection coefficients. The wireless device 1002 may transmit a calculated velocity report to the sensing processing entity. In some aspects, the wireless device 1002 may transmit measurements of the set of sensing signals 1020 and the set of sensing signals 1026 to the sensing processing entity. The wireless device 1002 may transmit its position to the sensing processing entity. The RIS 1004 may transmit its position to the sensing processing entity. The sensing processing entity may calculate the velocity of the target object 1008 based on the relative positions of the RIS 1004 and the wireless device 1002. In some aspects, the sensing processing entity may aggregate measurements from a plurality of receiver sensing nodes to calculate the velocity of the target object 1008.

While FIG. 10 shows an example of monostatic sensing with the wireless device 1002, the RIS 1004 may be configured to assist in a wireless device to perform bistatic sensing, for example with the set of sensing signals 1017 reflecting off of the target object 1008 to a wireless device different from the wireless device 1002, and the set of sensing signals 1024 reflecting off of the target object 1108 to the same, or a different, wireless device. The receiving wireless device(s) may measure the sets of sensing signals and calculate the velocity of the target object 1008, or may transmit the measurements to a sensing processing entity for calculation of the velocity of the target object 1008.

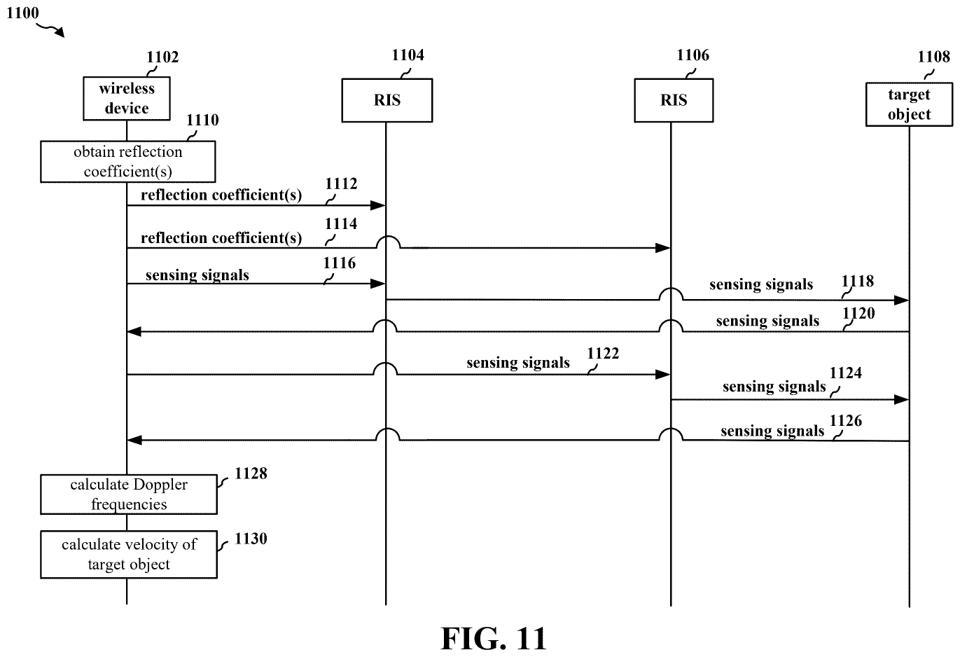

FIG. 11 is a connection flow diagram 1100 illustrating an example of communications between a wireless device 1102, a RIS 1104, and a RIS 1106 to assist in performing monostatic sensing on a target object 1108. The wireless device 1102 may be a sensing transmitter and a sensing receiver. The wireless device 1102 may be a network node or a UE. The position of the RIS 1104 may be known to the wireless device 1102. In some aspects, the RIS 1104 may be configured to indicate its position to the wireless device 1102, or the wireless device 1102 may be configured to perform positioning on the RIS 1104 to calculate its position. The position of the RIS 1106 may be known to the wireless device 1102. In some aspects, the RIS 1106 may be configured to indicate its position to the wireless device 1102, or the wireless device 1102 may be configured to perform positioning on the RIS 1106 to calculate its position.

At 1110, the wireless device 1102 may obtain a plurality of reflection coefficients for a plurality of reflection paths, such as the first reflection path including the set of sensing signals 1116 from the wireless device 1102 to the RIS 1104, the set of sensing signals 1118 from the RIS 1104 to the target object 1108, and the set of sensing signals 1120 from the target object 1108 to the wireless device 1102, and the second reflection path including the set of sensing signals 1122 from the wireless device 1102 to the RIS 1106, the set of sensing signals 1124 from the RIS 1106 to the target object 1108, and the set of sensing signals 1126 from the target object 1108 to the wireless device 1102. In some aspects, the wireless device 1102 may receive the plurality of reflection coefficients from another wireless entity, such as an LMF or a sensing entity configuring the sensing occasion. In other aspects, the wireless device 1102 may configure a first reflection coefficient for the first reflection path and a second reflection coefficient for the second reflection path. In some aspects, the wireless device 1102 may configure a plurality of periodical sensing signal radio resources for velocity measurement purposes to the RIS 1104. The inter-occasion interval length between two occasions for each radio resource may be configured to ensure that the occasions do not interfere with one another. The RIS 1104 may be configured to keep the reflection coefficient of each meta element identical in each of the periodical time occurrences for each radio resource. The wireless device 1102 may configure one reflection coefficient for each path. While two paths are shown in FIG. 11, the wireless device 1102 may configure additional paths, for example a path from the wireless device 1102 to the target object 1108 to the RIS 1104 back to the wireless device 1102, a path from the wireless device 1102 to the target object 1108 back to the wireless device 1102, or a path from the wireless device 1102 to the RIS 1104 to the target object 1108 to the RIS 1106 back to the wireless device 1102. The RIS 1104 and the RIS 1106 may be configured to keep the reflection coefficient of each meta element identical in each of the periodical time occurrences for each corresponding reflection beam, radio resource, and/or path.

The wireless device 1102 may transmit the set of reflection coefficients 1112 to the RIS 1104. The RIS 1104 may receive the set of reflection coefficients 1112. The set of reflection coefficients 1112 may include the first reflection coefficient. The wireless device 1102 may transmit the set of reflection coefficients 1114 to the RIS 1106. The RIS 1106 may receive the set of reflection coefficients 1114. The set of reflection coefficients 1114 may include the second reflection coefficient. The wireless device 1102 may transmit the set of reflection coefficients 1112 and/or the set of reflection coefficients 1114 in an RRC configuration, DCI, or a MAC-CE.

The wireless device 1102 may transmit the set of sensing signals 1116 to the RIS 1104 for a first reflection path. The RIS 1104 may reflect the set of sensing signals 1116 as the set of sensing signals 1118 based on the first reflection coefficient for the first reflection path. The target object may reflect the set of sensing signals 1118 as the set of sensing signals 1120 to the wireless device 1102 for the first reflection path. The wireless device 1102 may receive the set of sensing signals 1120 from the target object 1108 via the first reflection path.

The wireless device 1102 may transmit the set of sensing signals 1122 to the RIS 1106. The RIS 1106 may reflect set of sensing signals 1122 as the set of sensing signals 1124 based on the second reflection coefficient for the second reflection path. The target object may reflect the set of sensing signals 1124 as the set of sensing signals 1126 to the wireless device 1102 for the second reflection path. The wireless device 1102 may receive the set of sensing signals 1126 from the target object 1108.

At 1128, the wireless device 1102 may calculate the Doppler frequencies of each of the set of sensing signals 1120 and the set of sensing signals 1126 based on the respective reflection coefficients. At 1130, the wireless device 1102 may calculate the velocity of the target object 1108 based on the calculated Doppler frequencies.

The wireless device 1102 may propagate sets of sensing signals via the target object 1108 back to the wireless device 1102 via a first reflective path using the RIS 1104 and via a second reflective path using the RIS 1106. The wireless device 1102 may calculate the Doppler frequencies of the two paths at different radio resources. The wireless device 1102 may calculate the Doppler frequency of the first reflective path as \hat{f}_{d,1} at a first radio resource and may calculate the Doppler frequency of the second reflective path as \hat{f}_{d,2} at a second radio resource. The wireless device 1102 may know the position of the RIS 1104, the position of the RIS 1106, and a previously measured or calculated position of the target object 1108.

The wireless device 1102 may calculate the velocity of the target object 1108 based on one or more velocity components of the target object 1108. The wireless device 1102 may first construct equations of velocity component values and velocity component directions, and then may calculate the value and direction of the target object velocity. Each velocity component may correspond with a transmission path. A velocity component may be calculated in the direction of the line connecting the RIS 1104 and the target object 1108 as [symbol] ₁. A velocity component may be calculated in the direction of the line connecting the RIS 1106 and the target object 1108 as [symbol] ₂. A velocity component may be calculated in the direction of the line connecting the target object 1108 and the wireless device 1102 receiving the reflected set of sensing signals from the target object 1108 as [symbol] ₃. The wireless device 1102 may calculate the value | [symbol] ₁| based on a calculated quantization value of a Doppler frequency \hat{f}_{d,1} and may calculate the value | [symbol] ₂| based on a calculated quantization value of a Doppler frequency \hat{f}_{d,2}. For example, for the first reflective path including the set of sensing signals 1116, the set of sensing signals 1118, and the set of sensing signals 1120, the wireless device 1102 may calculate the velocity component | [symbol] ₁| as it relates to | [symbol] ₃| as

$$\vert {\vec{v}}_{1} \vert - \vert {\vec{v}}_{3} \vert = \frac{{\hat{f}}_{d , 1}}{{f}_{c}} \cdot c .$$

For the second reflective path including the set of sensing signals 1122, the set of sensing signals 1124, and the set of sensing signals 1126, the wireless device 1102 may calculate the velocity component | [symbol] ₂| as it relates to | [symbol] ₃| as

$$\vert {\vec{v}}_{2} \vert - \vert {\vec{v}}_{3} \vert = \frac{{\hat{f}}_{d , 2}}{{f}_{c}} \cdot c .$$

Based on the indicated positions of the RIS 1104 and the RIS 1106 and the wireless device 1102, the wireless device 1102 may calculate the velocity component directions θ₁, θ₂, and θ₃, where θ₁ may be an angle between a reference line passing through a point representing the target object 1108 and the line connecting a point representing a reflection point of the RIS 1104 and the point representing the target object 1108, θ₂ May be an angle between the reference line and the line connecting a point representing a reflection point of the RIS 1106 and the point representing the target object 1108, and θ₃ may be an angle between the reference line and the line connecting the point representing the target object 1108 and a point representing a reception point of the wireless device 1102. The velocity of the target object 1108 may be denoted as [symbol] , and the wireless device 1102 may calculate the velocity component values and directions to satisfy | [symbol] ₁|=| [symbol] |cos(θ+θ₁), | [symbol] ₂|=| [symbol] |cos(θ+θ₂), | [symbol] ₃|=| [symbol] |cos(θ+θ₃) to calculate the velocity of the target object 1108 as | [symbol] | and the direction of the target object 1108 as θ, where θ may represent a directional angle of the velocity of the target object 1108 relative to the reference line.

In some aspects, a sensing processing entity may configure the wireless device 1102 to coordinate sensing of the target object 1108 via the RIS 1104. The sensing processing entity may configure the reflection coefficients. The wireless device 1102 may transmit a calculated velocity report to the sensing processing entity. In some aspects, the wireless device 1102 may transmit measurements of the set of sensing signals 1120 and the set of sensing signals 1126 to the sensing processing entity. The wireless device 1102 may transmit its position to the sensing processing entity. The RIS 1104 may transmit its position to the sensing processing entity. The sensing processing entity may calculate the velocity of the target object 1108 based on the relative positions of the RIS 1104 and the wireless device 1102. In some aspects, the sensing processing entity may aggregate measurements from a plurality of receiver sensing nodes to calculate the velocity of the target object 1108.

While FIG. 11 shows an example of monostatic sensing with the wireless device 1102, the RIS 1104 and the RIS 1106 may be configured to assist in a plurality of wireless devices to perform bistatic sensing, for example with the set of sensing signals 1118 reflecting off of the target object 1108 to a wireless device different from the wireless device 1102, and the set of sensing signals 1124 reflecting off of the target object 1108 to the same, or a different, wireless device. The receiving wireless device(s) may measure the sets of sensing signals and calculate the velocity of the target object 1108, or may transmit the measurements to a sensing processing entity for calculation of the velocity of the target object 1108.

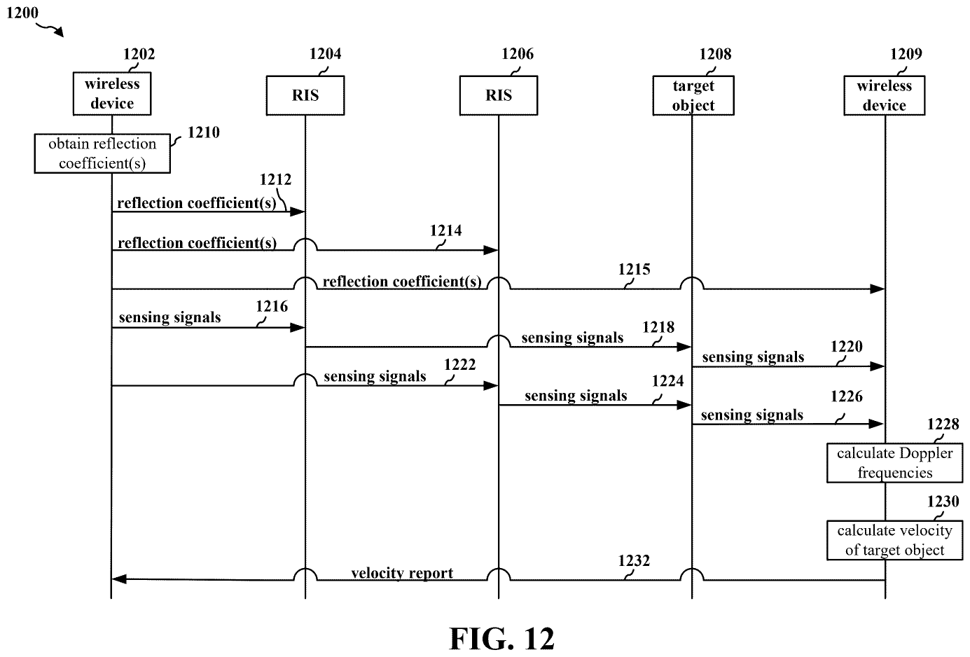

FIG. 12 is a connection flow diagram 1200 illustrating an example of communications between a wireless device 1202, a RIS 1204, a RIS 1206, and a wireless device 1209 to assist in performing bistatic sensing on a target object 1208. The wireless device 1202 may be a sensing transmitter. The wireless device 1202 may be a network node or a UE. The wireless device 1209 may be a sensing receiver. The wireless device 1209 may be a network node or a UE. The position of the RIS 1204 may be known to the wireless device 1202 and/or to the wireless device 1209. In some aspects, the RIS 1204 may be configured to indicate its position to the wireless device 1202 and/or to the wireless device 1209. In some aspects, the wireless device 1202 and/or to the wireless device 1209 may be configured to perform positioning on the RIS 1204 to calculate its position. The position of the RIS 1206 may be known to the wireless device 1202 and/or to the wireless device 1209. In some aspects, the RIS 1206 may be configured to indicate its position to the wireless device 1202 and/or to the wireless device 1209. In some aspects, the wireless device 1202 and/or to the wireless device 1209 may be configured to perform positioning on the RIS 1206 to calculate its position.

At 1210, the wireless device 1202 may obtain a plurality of reflection coefficients for a plurality of reflection paths, such as the first reflection path including the set of sensing signals 1216 from the wireless device 1202 to the RIS 1204, the set of sensing signals 1218 from the RIS 1204 to the target object 1208, and the set of sensing signals 1220 from the target object 1208 to the wireless device 1209, and the second reflection path including the set of sensing signals 1222 from the wireless device 1202 to the RIS 1206, the set of sensing signals 1224 from the RIS 1206 to the target object 1208, and the set of sensing signals 1226 from the target object 1208 to the wireless device 1209. In some aspects, the wireless device 1202 may receive the plurality of reflection coefficients from another wireless entity, such as an LMF or a sensing entity configuring the sensing occasion. In other aspects, the wireless device 1202 may configure a first reflection coefficient for the first reflection path and a second reflection coefficient for the second reflection path. In some aspects, the wireless device 1202 may configure a plurality of periodical sensing signal radio resources for velocity measurement purposes to the RIS 1204. The inter-occasion interval length between two occasions for each radio resource may be configured to ensure that the occasions do not interfere with one another. The RIS 1204 may be configured to keep the reflection coefficient of each meta element identical in each of the periodical time occurrences for each radio resource. The wireless device 1202 may configure one reflection coefficient for each path. While two paths are shown in FIG. 12, the wireless device 1202 may configure additional paths, for example a path from the wireless device 1202 to the target object 1208 to the RIS 1204, and to the wireless device 1209, a path from the wireless device 1202 to the target object 1208, and to the wireless device 1209, or a path from the wireless device 1202 to the RIS 1204 to the target object 1208 to the RIS 1206, and to the wireless device 1209. The RIS 1204 and the RIS 1206 may be configured to keep the reflection coefficient of each meta element identical in each of the periodical time occurrences for each corresponding reflection beam, radio resource, and/or path.

The wireless device 1202 may transmit the set of reflection coefficients 1212 to the RIS 1204. The RIS 1204 may receive the set of reflection coefficients 1212. The set of reflection coefficients 1212 may include the first reflection coefficient. The wireless device 1202 may transmit the set of reflection coefficients 1214 to the RIS 1206. The RIS 1206 may receive the set of reflection coefficients 1214. The set of reflection coefficients 1214 may include the second reflection coefficient. The wireless device 1202 may transmit the set of reflection coefficients 1215 to the wireless device 1209. The wireless device 1209 may receive the set of reflection coefficients 1215. The set of reflection coefficients 1215 may include the first reflection coefficient and the second reflection coefficient. The wireless device 1202 may transmit the set of reflection coefficients 1212, the set of reflection coefficients 1214 and/or the set of reflection coefficients 1215 in an RRC configuration, DCI, or a MAC-CE.

The wireless device 1202 may transmit the set of sensing signals 1216 to the RIS 1204 for a first reflection path. The RIS 1204 may reflect the set of sensing signals 1216 as the set of sensing signals 1218 based on the first reflection coefficient for the first reflection path. The target object may reflect the set of sensing signals 1218 as the set of sensing signals 1220 to the wireless device 1209 for the first reflection path. The wireless device 1209 may receive the set of sensing signals 1220 from the target object 1208 via the first reflection path.

The wireless device 1202 may transmit the set of sensing signals 1222 to the RIS 1206. The RIS 1206 may reflect set of sensing signals 1222 as the set of sensing signals 1224 based on the second reflection coefficient for the second reflection path. The target object may reflect the set of sensing signals 1224 as the set of sensing signals 1226 to the wireless device 1209 for the second reflection path. The wireless device 1209 may receive the set of sensing signals 1226 from the target object 1208.

At 1228, the wireless device 1209 may calculate the Doppler frequencies of each of the set of sensing signals 1220 and the set of sensing signals 1226 based on the respective reflection coefficients. At 1230, the wireless device 1209 may calculate the velocity of the target object 1208 based on the calculated Doppler frequencies.

The wireless device 1202 may propagate sets of sensing signals via the target object 1208 to the wireless device 1209 via a first reflective path using the RIS 1204 and via a second reflective path using the RIS 1206. The wireless device 1209 may calculate the Doppler frequencies of the two paths at different radio resources. The wireless device 1209 may calculate the Doppler frequency of the first reflective path as f_{d,1} at a first radio resource and may calculate the Doppler frequency of the second reflective path as f_{d,2} at a second radio resource. The wireless device 1209 may know the position of the RIS 1204, the position of the RIS 1206, and a previously measured or calculated position of the target object 1208.

The wireless device 1209 may calculate the velocity of the target object 1208 based on one or more velocity components of the target object 1208. The wireless device 1209 may first construct equations of velocity component values and velocity component directions, and then may calculate the value and direction of the target object velocity. Each velocity component may correspond with a transmission path. A velocity component may be calculated in the direction of the line connecting the RIS 1204 and the target object 1208 as [symbol] ₁. A velocity component may be calculated in the direction of the line connecting the RIS 1206 and the target object 1208 as [symbol] ₂. A velocity component may be calculated in the direction of the line connecting the target object 1208 and the wireless device 1209 receiving the reflected set of sensing signals from the target object 1208 as 13. The wireless device 1209 may calculate the value | [symbol] ₁| based on a calculated quantization value of a Doppler frequency \hat{f}_{d,1} and may calculate the value | [symbol] ₂| based on a calculated quantization value of a Doppler frequency \hat{f}_{d,2}. For example, for the first reflective path including the set of sensing signals 1216, the set of sensing signals 1218, and the set of sensing signals 1220, the wireless device 1209 may calculate the velocity component | [symbol] ₁| as it relates to | [symbol] ₃| as

$$\vert {\vec{v}}_{1} \vert - \vert {\vec{v}}_{3} \vert = \frac{{\hat{f}}_{d , 1}}{{f}_{c}} \cdot c .$$

For the second reflective path including the set of sensing signals 1222, the set of sensing signals 1224, and the set of sensing signals 1226, the wireless device 1209 may calculate the velocity component | [symbol] ₂| as it relates to | [symbol] ₃| as

$$\vert {\vec{v}}_{2} \vert - \vert {\vec{v}}_{3} \vert = \frac{{\hat{f}}_{d , 2}}{{f}_{c}} \cdot c .$$

Based on the indicated positions of the RIS 1204, the RIS 1206, the wireless device 1202, and the wireless device 1209, the wireless device 1209 may calculate the velocity component directions θ₁, θ₂, and θ₃, where θ₁ may be an angle between a reference line passing through a point representing the target object 1208 and the line connecting a point representing a reflection point of the RIS 1204 and the point representing the target object 1208, θ₂ May be an angle between the reference line and the line connecting a point representing a reflection point of the RIS 1206 and the point representing the target object 1208, and θ₃ may be an angle between the reference line and the line connecting the point representing the target object 1208 and a point representing a reception point of the wireless device 1209.

The velocity of the target object 1208 may be denoted as [symbol] , and the wireless device 1209 may calculate the velocity component values and directions to satisfy | [symbol] ₁|=|v|cos(θ+θ₁), | [symbol] ₂|=| [symbol] |cos(θ+θ₂), | [symbol] ₃|=| [symbol] |cos(θ+θ₃) to calculate the velocity of the target object 1208 as | [symbol] | and the direction of the target object 1208 as θ, where θ may represent a directional angle of the velocity of the target object 1208 relative to the reference line. In some aspects, the wireless device 1209 may calculate the velocity component directions θ₁, θ₂, and θ₃, where θ₁ may be an angle between a first parallel reference line for the RIS 1204 and a point representing the target object 1208, θ₂ May be an angle between a second parallel reference line for the RIS 1206 and the point representing the target object 1208, and θ₃ may be an angle between a third parallel reference line for the point representing the target object 1208 and the wireless device 1209. A parallel reference line may be a line parallel to a reference line in a common base direction, such as the direction from a transmitting antenna of the wireless device 1202 and the point representing the target object 1208. The velocity of the target object 1208 may be denoted as v, and the wireless device 1209 may calculate the velocity component values and directions to satisfy | [symbol] ₁|=|v|cos(θ+θ₁), | [symbol] ₂|=|cos(θ+θ₂), | [symbol] ₃|=| [symbol] |cos(θ+θ₃) to calculate the velocity of the target object 1208 as | [symbol] | and the direction of the target object 1208 as θ, where θ may represent a directional angle of the velocity of the target object 1208 relative to a parallel reference line that is parallel to the same reference line as the parallel reference lines of θ₁, θ₂ and θ₃.

In some aspects, the wireless device 1209 may be configured to transmit a velocity report 1232 to the wireless device 1202 or to another wireless device, such as a sensing entity. The velocity report 1232 may be similar to the velocity report 932 in FIG. 9. The wireless device 1209 may transmit the velocity report 1232 via an L1 measurement report, such as a CSI report or an L3 measurement report. The measurement report may include a position of the wireless device 1209. The wireless device 1209 may calculate its position via positioning or via a sensor, such as a GNSS device. The velocity report may include the position of the wireless device 1202, the position of the RIS 1204, the position of the RIS 1206, and/or the position of the wireless device 1209, allowing the receiving entity (e.g., the wireless device 1202 or a sensing entity in a core network) to calculate the velocity of the target object 1208.

In some aspects, a sensing processing entity may configure the wireless device 1202 to coordinate sensing of the target object 1208 via the RIS 1204. The sensing processing entity may configure the reflection coefficients. The wireless device 1209 may transmit a calculated velocity report to the sensing processing entity. In some aspects, the wireless device 1209 may transmit measurements of the set of sensing signals 1220 and the set of sensing signals 1226 to the sensing processing entity. The wireless device 1202 and/or the wireless device 1209 may transmit its position to the sensing processing entity. The RIS 1204 may transmit its position to the sensing processing entity. The RIS 1206 may transmit its position to the sensing processing entity. The sensing processing entity may calculate the velocity of the target object 1208 based on the relative positions of the RIS 1204, the RIS 1206, the wireless device 1202, and the wireless device 1209. In some aspects, the sensing processing entity may aggregate measurements from a plurality of receiver sensing nodes to calculate the velocity of the target object 1208.

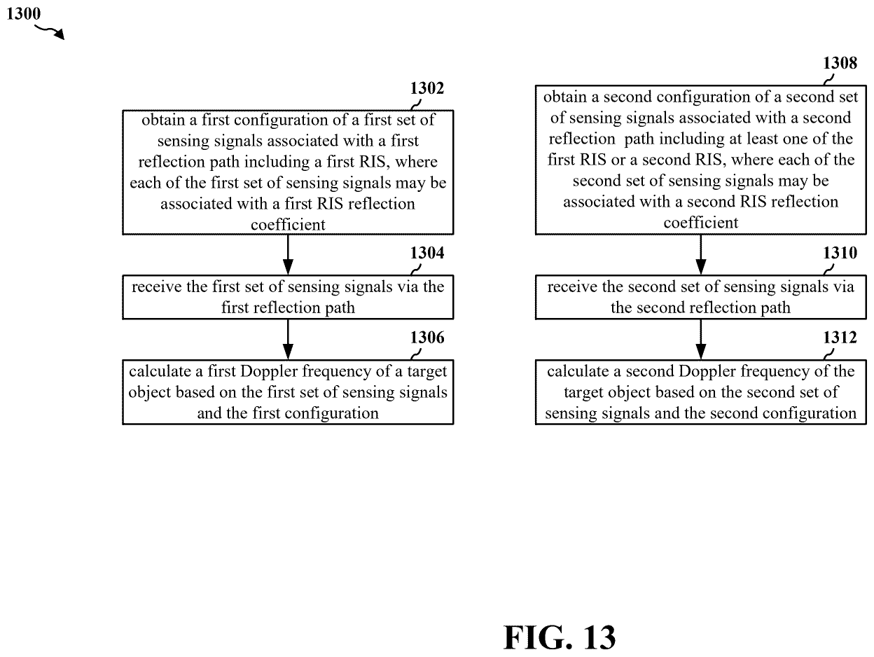

FIG. 13 is a flowchart 1300 of a method of wireless communication. The method may be performed by a wireless device (e.g., the UE 104, the UE 350, the UE 404; the base station 102, the base station 310; the wireless device 502, the wireless device 504, the wireless device 506, the wireless device 508, the wireless device 602, the wireless device 606, the wireless device 702, the wireless device 802, the wireless device 808, the wireless device 902, the wireless device 906, the wireless device 1002, the wireless device 1102, the wireless device 1202, the wireless device 1209; the apparatus 1804; the network entity 1802, the network entity 1902, the network entity 2060). At 1302, the wireless device may obtain a first configuration of a first set of sensing signals associated with a first reflection path including a first RIS. Each of the first set of sensing signals may be associated with a first RIS reflection coefficient. For example, 1302 may be performed by the wireless device 906 in FIG. 9, which may receive the set of reflection coefficients 914 from the wireless device 902, or may receive the reflection coefficients from a sensing processing entity. The set of reflection coefficients may be for a first configuration of the set of sensing signals 916 associated with a first reflection path including the set of sensing signals 916, the set of sensing signals 918, and the set of sensing signals 920, which includes reflecting off of the RIS 904. Each of the set of sensing signals may be associated with a first RIS reflection coefficient for the first reflection path. In another example, 1302 may be performed by the wireless device 1002 in FIG. 10, which may obtain a set of reflection coefficients from a module of the wireless device 1102 that calculates reflection coefficients, or may receive the reflection coefficients from a sensing processing entity. The set of reflection coefficients may be for a first configuration of the set of sensing signals 1016 associated with a first reflection path including the set of sensing signals 1016, the set of sensing signals 1017, the set of sensing signals 1018, and the set of sensing signals 1020, which includes reflecting off of the RIS 1004 and the target object 1008. Each of the set of sensing signals may be associated with a first RIS reflection coefficient for the first reflection path. In another example, 1302 may be performed by the wireless device 1102 in FIG. 11, which may obtain a set of reflection coefficients from a module of the wireless device 1102 that calculates reflection coefficients, or may receive the reflection coefficients from a sensing processing entity. The set of reflection coefficients may be for a first configuration of the set of sensing signals 1116 associated with a first reflection path including the set of sensing signals 1116, the set of sensing signals 1118, and the set of sensing signals 1120, which includes reflecting off of the RIS 1104. Each of the set of sensing signals may be associated with a first RIS reflection coefficient for the first reflection path. In another example, 1302 may be performed by the wireless device 1209 in FIG. 12, which may receive the set of reflection coefficients 1215 from the wireless device 1202 that calculates reflection coefficients at 1210. The set of reflection coefficients 1215 may be for a first configuration of the set of sensing signals 1216 associated with a first reflection path including the set of sensing signals 1216, the set of sensing signals 1218, and the set of sensing signals 1220, which includes reflecting off of the RIS 1204. Each of the set of sensing signals may be associated with a first RIS reflection coefficient for the first reflection path. Moreover, 1302 may be performed by the component 199 in FIG. 1, 3, 6, 18, 19, or 20.

At 1304, the wireless device may receive the first set of sensing signals via the first reflection path. For example, 1304 may be performed by the wireless device 906 in FIG. 9, which may receive the set of sensing signals 920, which originated with the set of sensing signals 916, via the first reflection path. In another example, 1304 may be performed by the wireless device 1002 in FIG. 10, which may receive the set of sensing signals 1020, which originated with the set of sensing signals 1016, via the first reflection path. In another example, 1304 may be performed by the wireless device 1102 in FIG. 11, which may receive the set of sensing signals 1120, which originated with the set of sensing signals 1116 via the first reflection path. In another example, 1304 may be performed by the wireless device 1209 in FIG. 12, which may receive the set of sensing signals 1220, which originated with the set of sensing signals 1216 via the first reflection path. Moreover, 1304 may be performed by the component 199 in FIG. 1, 3, 6, 18, 19, or 20.

At 1306, the wireless device may calculate a first Doppler frequency of a target object based on the first set of sensing signals and the first configuration. For example, 1306 may be performed by the wireless device 906 in FIG. 9, which may, at 928, calculate a first Doppler frequency of the target object 908 based on the set of sensing signals 920 and the first configuration. In another example, 1306 may be performed by the wireless device 1002 in FIG. 10, which may, at 1028, calculate a first Doppler frequency of the target object 1008 based on the set of sensing signals 1020 and the first configuration. In another example, 1306 may be performed by the wireless device 1102 in FIG. 11, which may, at 1128, calculate a first Doppler frequency of the target object 1108 based on the set of sensing signals 1120 and the first configuration. In another example, 1306 may be performed by the wireless device 1209 in FIG. 12, which may, at 1228, calculate a first Doppler frequency of the target object 1208 based on the set of sensing signals 1220 and the first configuration. Moreover, 1306 may be performed by the component 199 in FIG. 1, 3, 6, 18, 19, or 20.

At 1308, the wireless device may obtain a second configuration of a second set of sensing signals associated with a second reflection path including at least one of the first RIS or a second RIS. Each of the second set of sensing signals is associated with a second RIS reflection coefficient. For example, 1308 may be performed by the wireless device 906 in FIG. 9, which may receive the set of reflection coefficients 914 from the wireless device 902, or may receive the reflection coefficients from a sensing processing entity. The set of reflection coefficients may be for a second configuration of the set of sensing signals 922 associated with a second reflection path including the set of sensing signals 922, the set of sensing signals 924, and the set of sensing signals 926, which includes reflecting off of the RIS 904. Each of the set of sensing signals is associated with a second RIS reflection coefficient. In another example, 1308 may be performed by the wireless device 1002 in FIG. 10, which may obtain a set of reflection coefficients from a module of the wireless device 1102 that calculates reflection coefficients, or may receive the reflection coefficients from a sensing processing entity. The set of reflection coefficients may be for a second configuration of the set of sensing signals 1022 associated with a second reflection path including the set of sensing signals 1022, the set of sensing signals 1024, and the set of sensing signals 1026, which includes reflecting off of the RIS 1004. Each of the set of sensing signals is associated with a second RIS reflection coefficient. In another example, 1308 may be performed by the wireless device 1102 in FIG. 11, which may obtain a set of reflection coefficients from a module of the wireless device 1102 that calculates reflection coefficients, or may receive the reflection coefficients from a sensing processing entity. The set of reflection coefficients may be for a second configuration of the set of sensing signals 1122 associated with a second reflection path including the set of sensing signals 1122, the set of sensing signals 1124, and the set of sensing signals 1126, which includes reflecting off of the RIS 1106. Each of the set of sensing signals is associated with a second RIS reflection coefficient. In another example, 1308 may be performed by the wireless device 1209 in FIG. 12, which may obtain a set of reflection coefficients from a module of the wireless device 1202 that calculates reflection coefficients at 1210. The set of reflection coefficients may be for a second configuration of the set of sensing signals 1222 associated with a second reflection path including the set of sensing signals 1222, the set of sensing signals 1224, and the set of sensing signals 1226, which includes reflecting off of the RIS 1206. Each of the set of sensing signals is associated with a second RIS reflection coefficient. Moreover, 1308 may be performed by the component 199 in FIG. 1, 3, 6, 18, 19, or 20.

At 1310, the wireless device may receive the second set of sensing signals via the second reflection path. For example, 1310 may be performed by the wireless device 906 in FIG. 9, which may receive the set of sensing signals 926, which originate from the set of sensing signals 922, via the second reflection path. In another example, 1310 may be performed by the wireless device 1002 in FIG. 10, which may receive the set of sensing signals 1026, which originate from the set of sensing signals 1022, via the second reflection path. In another example, 1310 may be performed by the wireless device 1102 in FIG. 11, which may receive the set of sensing signals 1126, which originate from the set of sensing signals 1122, via the second reflection path. In another example, 1310 may be performed by the wireless device 1209 in FIG. 12, which may receive the set of sensing signals 1226, which originate from the set of sensing signals 1122, via the second reflection path. Moreover, 1310 may be performed by the component 199 in FIG. 1, 3, 6, 18, 19, or 20.

At 1312, the wireless device may calculate a second Doppler frequency of the target object based on the second set of sensing signals and the second configuration. For example, 1312 may be performed by the wireless device 906 in FIG. 9, which may, at 928, calculate a second Doppler frequency of the target object 908 based on the set of sensing signals 920 and the second configuration. In another example, 1312 may be performed by the wireless device 1002 in FIG. 10, which may, at 1028, calculate a second Doppler frequency of the target object 1008 based on the set of sensing signals 1020 and the second configuration. In another example, 1312 may be performed by the wireless device 1102 in FIG. 11, which may, at 1128, calculate a second Doppler frequency of the target object 1108 based on the set of sensing signals 1120 and the second configuration. In another example, 1312 may be performed by the wireless device 1209 in FIG. 12, which may, at 1228, calculate a second Doppler frequency of the target object 1208 based on the set of sensing signals 1126 and the second configuration. Moreover, 1312 may be performed by the component 199 in FIG. 1, 3, 6, 18, 19, or 20.

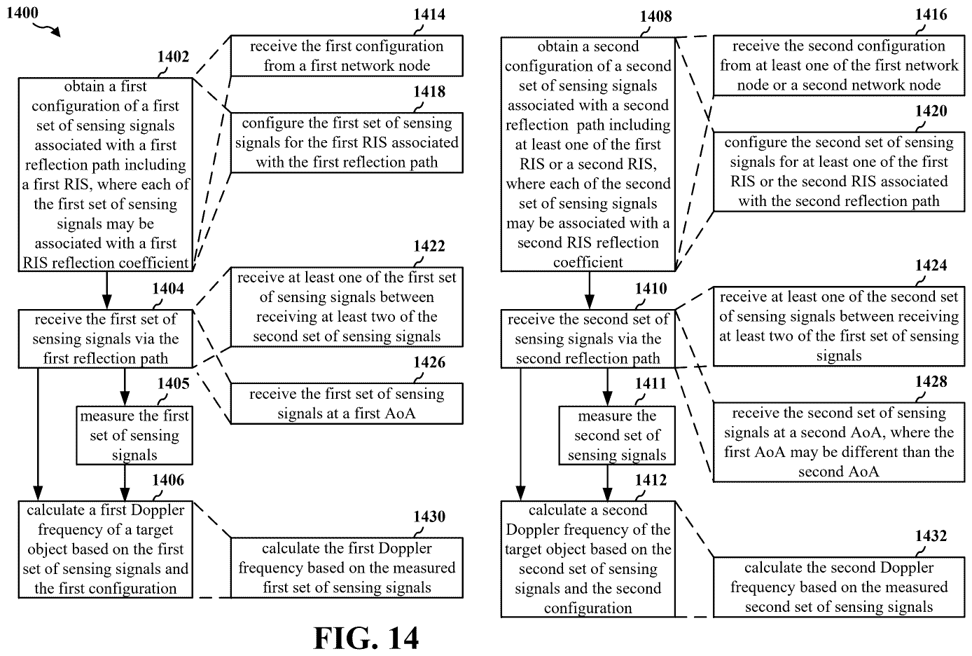

FIG. 14 is a flowchart 1400 of a method of wireless communication. The method may be performed by a wireless device (e.g., the UE 104, the UE 350, the UE 404; the base station 102, the base station 310; the wireless device 502, the wireless device 504, the wireless device 506, the wireless device 508, the wireless device 602, the wireless device 606, the wireless device 702, the wireless device 802, the wireless device 808, the wireless device 902, the wireless device 906, the wireless device 1002, the wireless device 1102, the wireless device 1202, the wireless device 1209; the apparatus 1804; the network entity 1802, the network entity 1902, the network entity 2060). At 1402, the wireless device may obtain a first configuration of a first set of sensing signals associated with a first reflection path including a first RIS. Each of the first set of sensing signals may be associated with a first RIS reflection coefficient. For example, 1402 may be performed by the wireless device 906 in FIG. 9, which may receive the set of reflection coefficients 914 from the wireless device 902, or may receive the reflection coefficients from a sensing processing entity. The set of reflection coefficients may be for a first configuration of the set of sensing signals 916 associated with a first reflection path including the set of sensing signals 916, the set of sensing signals 918, and the set of sensing signals 920, which includes reflecting off of the RIS 904. Each of the set of sensing signals may be associated with a first RIS reflection coefficient for the first reflection path. In another example, 1402 may be performed by the wireless device 1002 in FIG. 10, which may obtain a set of reflection coefficients from a module of the wireless device 1102 that calculates reflection coefficients, or may receive the reflection coefficients from a sensing processing entity. The set of reflection coefficients may be for a first configuration of the set of sensing signals 1016 associated with a first reflection path including the set of sensing signals 1016, the set of sensing signals 1017, the set of sensing signals 1018, and the set of sensing signals 1020, which includes reflecting off of the RIS 1004 and the target object 1008. Each of the set of sensing signals may be associated with a first RIS reflection coefficient for the first reflection path. In another example, 1402 may be performed by the wireless device 1102 in FIG. 11, which may obtain a set of reflection coefficients from a module of the wireless device 1102 that calculates reflection coefficients, or may receive the reflection coefficients from a sensing processing entity. The set of reflection coefficients may be for a first configuration of the set of sensing signals 1116 associated with a first reflection path including the set of sensing signals 1116, the set of sensing signals 1118, and the set of sensing signals 1120, which includes reflecting off of the RIS 1104. Each of the set of sensing signals may be associated with a first RIS reflection coefficient for the first reflection path. In another example, 1302 may be performed by the wireless device 1209 in FIG. 12, which may receive the set of reflection coefficients 1215 from the wireless device 1202 that calculates reflection coefficients at 1210. The set of reflection coefficients 1215 may be for a first configuration of the set of sensing signals 1216 associated with a first reflection path including the set of sensing signals 1216, the set of sensing signals 1218, and the set of sensing signals 1220, which includes reflecting off of the RIS 1204. Each of the set of sensing signals may be associated with a first RIS reflection coefficient for the first reflection path. Moreover, 1402 may be performed by the component 199 in FIG. 1, 3, 6, 18, 19, or 20.

At 1404, the wireless device may receive the first set of sensing signals via the first reflection path. For example, 1404 may be performed by the wireless device 906 in FIG. 9, which may receive the set of sensing signals 920, which originated with the set of sensing signals 916, via the first reflection path. In another example, 1404 may be performed by the wireless device 1002 in FIG. 10, which may receive the set of sensing signals 1020, which originated with the set of sensing signals 1016, via the first reflection path. In another example, 1404 may be performed by the wireless device 1102 in FIG. 11, which may receive the set of sensing signals 1120, which originated with the set of sensing signals 1116 via the first reflection path. In another example, 1304 may be performed by the wireless device 1209 in FIG. 12, which may receive the set of sensing signals 1220, which originated with the set of sensing signals 1216 via the first reflection path. Moreover, 1404 may be performed by the component 199 in FIG. 1, 3, 6, 18, 19, or 20.

At 1405, the wireless device may measure the first set of sensing signals. For example, 1405 may be performed by the wireless device 906 in FIG. 9, which may, at 928, measure the set of sensing signals 920, which originated with the set of sensing signals 916. In another example, 1405 may be performed by the wireless device 1002 in FIG. 10, which may, at 1028, measure the set of sensing signals 1020, which originated with the set of sensing signals 1016. In another example, 1405 may be performed by the wireless device 1102 in FIG. 11, which may, at 1128, measure the set of sensing signals 1120, which originated with the set of sensing signals 1116. In another example, 1405 may be performed by the wireless device 1209 in FIG. 12, which may, at 1228, measure the set of sensing signals 1220, which originated with the set of sensing signals 1216. Moreover, 1405 may be performed by the component 199 in FIG. 1, 3, 6, 18, 19, or 20.

At 1406, the wireless device may calculate a first Doppler frequency of a target object based on the first set of sensing signals and the first configuration. For example, 1406 may be performed by the wireless device 906 in FIG. 9, which may, at 928, calculate a first Doppler frequency of the target object 908 based on the set of sensing signals 920 and the first configuration. In another example, 1406 may be performed by the wireless device 1002 in FIG. 10, which may, at 1028, calculate a first Doppler frequency of the target object 1008 based on the set of sensing signals 1020 and the first configuration. In another example, 1306 may be performed by the wireless device 1102 in FIG. 11, which may, at 1128, calculate a first Doppler frequency of the target object 1108 based on the set of sensing signals 1120 and the first configuration. In another example, 1306 may be performed by the wireless device 1209 in FIG. 12, which may, at 1228, calculate a first Doppler frequency of the target object 1208 based on the set of sensing signals 1220 and the first configuration. Moreover, 1406 may be performed by the component 199 in FIG. 1, 3, 6, 18, 19, or 20.

At 1408, the wireless device may obtain a second configuration of a second set of sensing signals associated with a second reflection path including at least one of the first RIS or a second RIS. Each of the second set of sensing signals is associated with a second RIS reflection coefficient. For example, 1408 may be performed by the wireless device 906 in FIG. 9, which may receive the set of reflection coefficients 914 from the wireless device 902, or may receive the reflection coefficients from a sensing processing entity. The set of reflection coefficients may be for a second configuration of the set of sensing signals 922 associated with a second reflection path including the set of sensing signals 922, the set of sensing signals 924, and the set of sensing signals 926, which includes reflecting off of the RIS 904. Each of the set of sensing signals is associated with a second RIS reflection coefficient. In another example, 1408 may be performed by the wireless device 1002 in FIG. 10, which may obtain a set of reflection coefficients from a module of the wireless device 1102 that calculates reflection coefficients, or may receive the reflection coefficients from a sensing processing entity. The set of reflection coefficients may be for a second configuration of the set of sensing signals 1022 associated with a second reflection path including the set of sensing signals 1022, the set of sensing signals 1024, and the set of sensing signals 1026, which includes reflecting off of the RIS 1004. Each of the set of sensing signals is associated with a second RIS reflection coefficient. In another example, 1408 may be performed by the wireless device 1102 in FIG. 11, which may obtain a set of reflection coefficients from a module of the wireless device 1102 that calculates reflection coefficients, or may receive the reflection coefficients from a sensing processing entity. The set of reflection coefficients may be for a second configuration of the set of sensing signals 1122 associated with a second reflection path including the set of sensing signals 1122, the set of sensing signals 1124, and the set of sensing signals 1126, which includes reflecting off of the RIS 1106. Each of the set of sensing signals is associated with a second RIS reflection coefficient. In another example, 1308 may be performed by the wireless device 1209 in FIG. 12, which may obtain a set of reflection coefficients from a module of the wireless device 1202 that calculates reflection coefficients at 1210. The set of reflection coefficients may be for a second configuration of the set of sensing signals 1222 associated with a second reflection path including the set of sensing signals 1222, the set of sensing signals 1224, and the set of sensing signals 1226, which includes reflecting off of the RIS 1206. Each of the set of sensing signals is associated with a second RIS reflection coefficient. Moreover, 1408 may be performed by the component 199 in FIG. 1, 3, 6, 18, 19, or 20.

At 1410, the wireless device may receive the second set of sensing signals via the second reflection path. For example, 1410 may be performed by the wireless device 906 in FIG. 9, which may receive the set of sensing signals 926, which originate from the set of sensing signals 922, via the second reflection path. In another example, 1410 may be performed by the wireless device 1002 in FIG. 10, which may receive the set of sensing signals 1026, which originate from the set of sensing signals 1022, via the second reflection path. In another example, 1410 may be performed by the wireless device 1102 in FIG. 11, which may receive the set of sensing signals 1126, which originate from the set of sensing signals 1122, via the second reflection path. In another example, 1310 may be performed by the wireless device 1209 in FIG. 12, which may receive the set of sensing signals 1226, which originate from the set of sensing signals 1122, via the second reflection path. Moreover, 1410 may be performed by the component 199 in FIG. 1, 3, 6, 18, 19, or 20.

At 1411, the wireless device may measure the second set of sensing signals. For example, 1411 may be performed by the wireless device 906 in FIG. 9, which may, at 928, measure the set of sensing signals 926, which originated from the set of sensing signals 922. In another example, 1411 may be performed by the wireless device 1002 in FIG. 10, which may, at 1028, measure the set of sensing signals 1026, which originated with the set of sensing signals 1022. In another example, 1411 may be performed by the wireless device 1102 in FIG. 11, which may, at 1128, measure the set of sensing signals 1126, which originated with the set of sensing signals 1122. In another example, 1411 may be performed by the wireless device 1209 in FIG. 12, which may, at 1228, measure the set of sensing signals 1226, which originated with the set of sensing signals 1222. Moreover, 1411 may be performed by the component 199 in FIG. 1, 3, 6, 18, 19, or 20.

At 1412, the wireless device may calculate a second Doppler frequency of the target object based on the second set of sensing signals and the second configuration. For example, 1412 may be performed by the wireless device 906 in FIG. 9, which may, at 928, calculate a second Doppler frequency of the target object 908 based on the set of sensing signals 920 and the second configuration. In another example, 1412 may be performed by the wireless device 1002 in FIG. 10, which may, at 1028, calculate a second Doppler frequency of the target object 1008 based on the set of sensing signals 1020 and the second configuration. In another example, 1412 may be performed by the wireless device 1102 in FIG. 11, which may, at 1128, calculate a second Doppler frequency of the target object 1108 based on the set of sensing signals 1120 and the second configuration. In another example, 1312 may be performed by the wireless device 1209 in FIG. 12, which may, at 1228, calculate a second Doppler frequency of the target object 1208 based on the set of sensing signals 1126 and the second configuration. Moreover, 1412 may be performed by the component 199 in FIG. 1, 3, 6, 18, 19, or 20.

At 1414, the wireless device may receive the first configuration from a first network node. For example, 1414 may be performed by the wireless device 906 in FIG. 9, which may, at 910, receive the configuration, including the set of reflection coefficients 914 that contains the reflection coefficient for the first reflection path, from the wireless device 902 or a sensing entity. In another example, 1414 may be performed by the wireless device 1002 in FIG. 10, which may, at 1010, receive the configuration, including the set of reflection coefficients 1012 that contains the reflection coefficient for the first reflection path, from another wireless device, such as a sensing entity. In another example, 1414 may be performed by the wireless device 1102 in FIG. 11, which may, at 1110, receive the configuration, including the set of reflection coefficients 1112 that contains the reflection coefficient for the first reflection path, from another wireless device, such as a sensing entity. In another example, 1414 may be performed by the wireless device 1209 in FIG. 12, which may receive the configuration, including the set of reflection coefficients 1215 that contains the reflection coefficient for the first reflection path, from the wireless device 1202, or another wireless device, such as a sensing entity. Moreover, 1414 may be performed by the component 199 in FIG. 1, 3, 6, 18, 19, or 20.

At 1416, the wireless device may receive the second configuration from at least one of the first network node or a second network node. For example, 1416 may be performed by the wireless device 906 in FIG. 9, which may receive the configuration, including the set of reflection coefficients 914 that contains the reflection coefficient for the second reflection path, from the wireless device 902 or a sensing entity. In another example, 1416 may be performed by the wireless device 1002 in FIG. 10, which may, at 1010, receive the configuration, including the set of reflection coefficients 1012 that contains the reflection coefficient for the second reflection path, from another wireless device, such as a sensing entity. In another example, 1416 may be performed by the wireless device 1102 in FIG. 11, which may, at 1110, receive the configuration, including the set of reflection coefficients 1114 that contains the reflection coefficient for the second reflection path, from another wireless device, such as a sensing entity. In another example, 1416 may be performed by the wireless device 1209 in FIG. 12, which may receive the configuration, including the set of reflection coefficients 1215 that contains the reflection coefficient for the second reflection path, from the wireless device 1202, or another wireless device, such as a sensing entity. Moreover, 1416 may be performed by the component 199 in FIG. 1, 3, 6, 18, 19, or 20.

At 1418, the wireless device may configure the first set of sensing signals for the first RIS associated with the first reflection path. For example, 1418 may be performed by the wireless device 1002 in FIG. 10, which may, at 1010, configure the set of sensing signals 1016 for the RIS 1004 associated with the first reflection path including the set of sensing signals 1016, the set of sensing signals 1017, the set of sensing signals 1018, and the set of sensing signals 1020. In another example, 1418 may be performed by the wireless device 1102 in FIG. 11, which may, at 1110, configure the set of sensing signals 1116 for the RIS 1104 associated with the first reflection path including the set of sensing signals 1116, the set of sensing signals 1118, and the set of sensing signals 1120. Moreover, 1418 may be performed by the component 199 in FIG. 1, 3, 6, 18, 19, or 20.

At 1420, the wireless device may configure the second set of sensing signals for at least one of the first RIS or the second RIS associated with the second reflection path. For example, 1420 may be performed by the wireless device 1002 in FIG. 10, which may, at 1010, configure the set of sensing signals 1022 for the RIS 1004 associated with the second reflection path including the set of sensing signals 1022, the set of sensing signals 1024, and the set of sensing signals 1026. In another example, 1420 may be performed by the wireless device 1102 in FIG. 11, which may, at 1110, configure the set of sensing signals 1122 for the RIS 1006 associated with the second reflection path including the set of sensing signals 1122, the set of sensing signals 1124, and the set of sensing signals 1126. Moreover, 1420 may be performed by the component 199 in FIG. 1, 3, 6, 18, 19, or 20.

At 1422, the wireless device may receive at least one of the first set of sensing signals between receiving at least two of the second set of sensing signals. For example, 1422 may be performed by the wireless device 906 in FIG. 9, which may receive at least one of the set of sensing signals 920, which originated with the set of sensing signals 916, between at least two of the set of sensing signals 926, which originated with the set of sensing signals 922. In another example, 1422 may be performed by the wireless device 1002 in FIG. 10, which may receive at least one of the set of sensing signals 1020, which originated with the set of sensing signals 1016, between at least two of the set of sensing signals 1026, which originated with the set of sensing signals 1022. In another example, 1422 may be performed by the wireless device 1102 in FIG. 11, which may receive at least one of the set of sensing signals 1120, which originated with the set of sensing signals 1116, between at least two of the set of sensing signals 1126, which originated with the set of sensing signals 1122. In another example, 1422 may be performed by the wireless device 1209 in FIG. 12, which may receive at least one of the set of sensing signals 1220, which originated with the set of sensing signals 1216, between at least two of the set of sensing signals 1226, which originated with the set of sensing signals 1222. Moreover, 1422 may be performed by the component 199 in FIG. 1, 3, 6, 18, 19, or 20.

At 1424, the wireless device may receive at least one of the second set of sensing signals between receiving at least two of the first set of sensing signals. For example, 1424 may be performed by the wireless device 906 in FIG. 9, which may receive at least one of the set of sensing signals 926, which originated with the set of sensing signals 922, between receiving at least two of the set of sensing signals 920, which originated with the set of sensing signals 916. In other words, some of the set of sensing signals 920 and some of the set of sensing signals 926 may be received in an alternating fashion. In another example, 1424 may be performed by the wireless device 1002 in FIG. 10, which may receive at least one of the set of sensing signals 1026, which originated with the set of sensing signals 1022, between receiving at least two of the set of sensing signals 1020, which originated with the set of sensing signals 1016. In other words, some of the set of sensing signals 1020 and some of the set of sensing signals 1026 may be received in an alternating fashion. In another example, 1424 may be performed by the wireless device 1102 in FIG. 11, which may receive at least one of the set of sensing signals 1126, which originated with the set of sensing signals 1122, between receiving at least two of the set of sensing signals 1120, which originated with the set of sensing signals 1116. In other words, some of the set of sensing signals 1120 and some of the set of sensing signals 1126 may be received in an alternating fashion. In another example, 1424 may be performed by the wireless device 1209 in FIG. 12, which may receive at least one of the set of sensing signals 1226, which originated with the set of sensing signals 1222, between receiving at least two of the set of sensing signals 1220, which originated with the set of sensing signals 1216. In other words, some of the set of sensing signals 1220 and some of the set of sensing signals 1226 may be received in an alternating fashion. Moreover, 1424 may be performed by the component 199 in FIG. 1, 3, 6, 18, 19, or 20.

At 1426, the wireless device may receive the first set of sensing signals at a first AoA. For example, 1426 may be performed by the wireless device 906 in FIG. 9, which may receive the set of sensing signals 920 at a first AoA from the location of the RIS 904 to an antenna of the wireless device 906. In another example, 1426 may be performed by the wireless device 1002 in FIG. 10, which may receive the set of sensing signals 1020 at a first AoA from the location of the RIS 1004 to an antenna of the wireless device 1002. In another example, 1426 may be performed by the wireless device 1102 in FIG. 11, which may receive the set of sensing signals 1120 at a first AoA from the location of the target object 1108 to an antenna of the wireless device 1102. In another example, 1426 may be performed by the wireless device 1209 in FIG. 12, which may receive the set of sensing signals 1220 at a first AoA from the location of the target object 1208 to an antenna of the wireless device 1209. Moreover, 1426 may be performed by the component 199 in FIG. 1, 3, 6, 18, 19, or 20.

At 1428, the wireless device may receive the second set of sensing signals at a second AoA. The first AoA may be different than the second AoA. For example, 1428 may be performed by the wireless device 906 in FIG. 9, which may receive the set of sensing signals 926 at a second AoA from the location of the target object 908 to the location of an antenna of the wireless device 906. The first AoA may be different than the second AoA. In another example, 1428 may be performed by the wireless device 1002 in FIG. 10, which may receive the set of sensing signals 1026 at a second AoA from the location of the target object 1008 to the location of an antenna of the wireless device 1002. The first AoA may be different than the second AoA. In another example, 1428 may be performed by the wireless device 1102 in FIG. 11, which may receive the set of sensing signals 1126 at a second AoA from the location of the target object 1108 to the location of an antenna of the wireless device 1102. The first AoA may be different than the second AoA. The first AoA may be the same as the second AoA. In another example, 1428 may be performed by the wireless device 1209 in FIG. 12, which may receive the set of sensing signals 1226 at a second AoA from the location of the target object 1208 to the location of an antenna of the wireless device 1209. The first AoA may be different than the second AoA. The first AoA may be the same as the second AoA. Moreover, 1428 may be performed by the component 199 in FIG. 1, 3, 6, 18, 19, or 20.

At 1430, the wireless device may calculate the first Doppler frequency based on the measured first set of sensing signals. For example, 1430 may be performed by the wireless device 906 in FIG. 9, which may, at 928, calculate the first Doppler frequency based on the measurements of the set of sensing signals 920. In another example, 1430 may be performed by the wireless device 1002 in FIG. 10, which may, at 1028, calculate the first Doppler frequency based on the measurements of the set of sensing signals 1020. In another example, 1430 may be performed by the wireless device 1102 in FIG. 11, which may, at 1128, calculate the first Doppler frequency based on the measurements of the set of sensing signals 1120. In another example, 1430 may be performed by the wireless device 1209 in FIG. 12, which may, at 1228, calculate the first Doppler frequency based on the measurements of the set of sensing signals 1220. Moreover, 1430 may be performed by the component 199 in FIG. 1, 3, 6, 18, 19, or 20.

At 1432, the wireless device may calculate the second Doppler frequency based on the measured second set of sensing signals. For example, 1432 may be performed by the wireless device 906 in FIG. 9, which may, at 928, calculate the second Doppler frequency based on the measurements of the set of sensing signals 926. In another example, 1432 may be performed by the wireless device 1002 in FIG. 10, which may, at 1028, calculate the second Doppler frequency based on the measurements of the set of sensing signals 1026. In another example, 1432 may be performed by the wireless device 1102 in FIG. 11, which may, at 1128, calculate the second Doppler frequency based on the measurements of the set of sensing signals 1126. In another example, 1432 may be performed by the wireless device 1209 in FIG. 12, which may, at 1228, calculate the second Doppler frequency based on the measurements of the set of sensing signals 1226. Moreover, 1432 may be performed by the component 199 in FIG. 1, 3, 6, 18, 19, or 20.

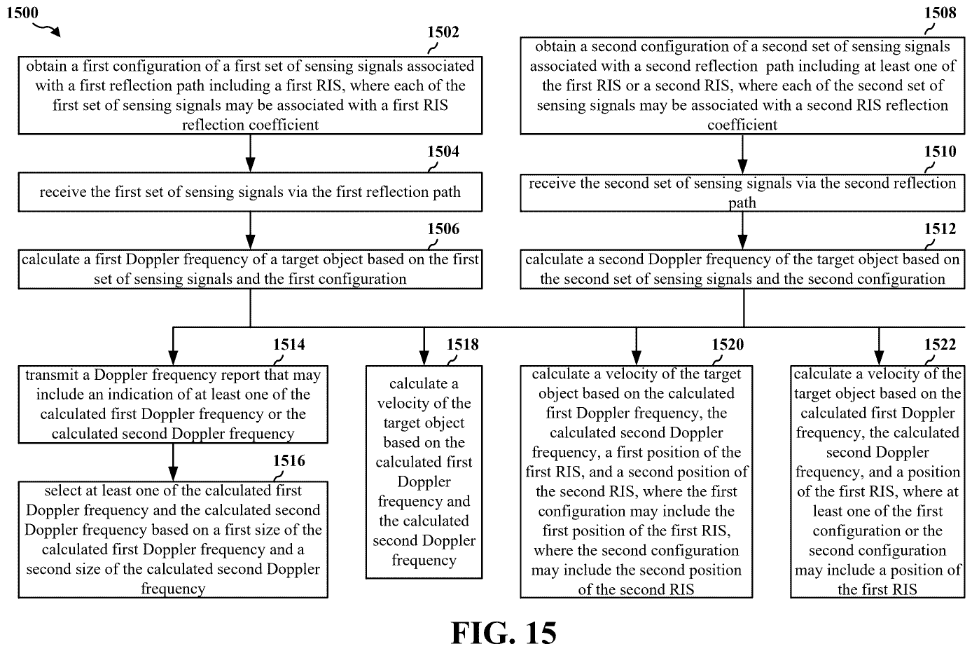

FIG. 15 is a flowchart 1500 of a method of wireless communication. The method may be performed by a wireless device (e.g., the UE 104, the UE 350, the UE 404; the base station 102, the base station 310; the wireless device 502, the wireless device 504, the wireless device 506, the wireless device 508, the wireless device 602, the wireless device 606, the wireless device 702, the wireless device 802, the wireless device 808, the wireless device 902, the wireless device 906, the wireless device 1002, the wireless device 1102, the wireless device 1202, the wireless device 1209; the apparatus 1804; the network entity 1802, the network entity 1902, the network entity 2060). At 1502, the wireless device may obtain a first configuration of a first set of sensing signals associated with a first reflection path including a first RIS. Each of the first set of sensing signals may be associated with a first RIS reflection coefficient. For example, 1502 may be performed by the wireless device 906 in FIG. 9, which may receive the set of reflection coefficients 914 from the wireless device 902, or may receive the reflection coefficients from a sensing processing entity. The set of reflection coefficients may be for a first configuration of the set of sensing signals 916 associated with a first reflection path including the set of sensing signals 916, the set of sensing signals 918, and the set of sensing signals 920, which includes reflecting off of the RIS 904. Each of the set of sensing signals may be associated with a first RIS reflection coefficient for the first reflection path. In another example, 1502 may be performed by the wireless device 1002 in FIG. 10, which may obtain a set of reflection coefficients from a module of the wireless device 1102 that calculates reflection coefficients, or may receive the reflection coefficients from a sensing processing entity. The set of reflection coefficients may be for a first configuration of the set of sensing signals 1016 associated with a first reflection path including the set of sensing signals 1016, the set of sensing signals 1017, the set of sensing signals 1018, and the set of sensing signals 1020, which includes reflecting off of the RIS 1004 and the target object 1008. Each of the set of sensing signals may be associated with a first RIS reflection coefficient for the first reflection path. In another example, 1502 may be performed by the wireless device 1102 in FIG. 11, which may obtain a set of reflection coefficients from a module of the wireless device 1102 that calculates reflection coefficients, or may receive the reflection coefficients from a sensing processing entity. The set of reflection coefficients may be for a first configuration of the set of sensing signals 1116 associated with a first reflection path including the set of sensing signals 1116, the set of sensing signals 1118, and the set of sensing signals 1120, which includes reflecting off of the RIS 1104. Each of the set of sensing signals may be associated with a first RIS reflection coefficient for the first reflection path. In another example, 1302 may be performed by the wireless device 1209 in FIG. 12, which may receive the set of reflection coefficients 1215 from the wireless device 1202 that calculates reflection coefficients at 1210. The set of reflection coefficients 1215 may be for a first configuration of the set of sensing signals 1216 associated with a first reflection path including the set of sensing signals 1216, the set of sensing signals 1218, and the set of sensing signals 1220, which includes reflecting off of the RIS 1204. Each of the set of sensing signals may be associated with a first RIS reflection coefficient for the first reflection path. Moreover, 1502 may be performed by the component 199 in FIG. 1, 3, 6, 18, 19, or 20.

At 1504, the wireless device may receive the first set of sensing signals via the first reflection path. For example, 1504 may be performed by the wireless device 906 in FIG. 9, which may receive the set of sensing signals 920, which originated with the set of sensing signals 916, via the first reflection path. In another example, 1504 may be performed by the wireless device 1002 in FIG. 10, which may receive the set of sensing signals 1020, which originated with the set of sensing signals 1016, via the first reflection path. In another example, 1304 may be performed by the wireless device 1102 in FIG. 11, which may receive the set of sensing signals 1120, which originated with the set of sensing signals 1116 via the first reflection path. In another example, 1304 may be performed by the wireless device 1209 in FIG. 12, which may receive the set of sensing signals 1220, which originated with the set of sensing signals 1216 via the first reflection path. Moreover, 1504 may be performed by the component 199 in FIG. 1, 3, 6, 18, 19, or 20.

At 1506, the wireless device may calculate a first Doppler frequency of a target object based on the first set of sensing signals and the first configuration. For example, 1506 may be performed by the wireless device 906 in FIG. 9, which may, at 928, calculate a first Doppler frequency of the target object 908 based on the set of sensing signals 920 and the first configuration. In another example, 1506 may be performed by the wireless device 1002 in FIG. 10, which may, at 1028, calculate a first Doppler frequency of the target object 1008 based on the set of sensing signals 1020 and the first configuration. In another example, 1306 may be performed by the wireless device 1102 in FIG. 11, which may, at 1128, calculate a first Doppler frequency of the target object 1108 based on the set of sensing signals 1120 and the first configuration. In another example, 1306 may be performed by the wireless device 1209 in FIG. 12, which may, at 1228, calculate a first Doppler frequency of the target object 1208 based on the set of sensing signals 1220 and the first configuration. Moreover, 1506 may be performed by the component 199 in FIG. 1, 3, 6, 18, 19, or 20.

At 1508, the wireless device may obtain a second configuration of a second set of sensing signals associated with a second reflection path including at least one of the first RIS or a second RIS. Each of the second set of sensing signals is associated with a second RIS reflection coefficient. For example, 1508 may be performed by the wireless device 906 in FIG. 9, which may receive the set of reflection coefficients 914 from the wireless device 902, or may receive the reflection coefficients from a sensing processing entity. The set of reflection coefficients may be for a second configuration of the set of sensing signals 922 associated with a second reflection path including the set of sensing signals 922, the set of sensing signals 924, and the set of sensing signals 926, which includes reflecting off of the RIS 904. Each of the set of sensing signals is associated with a second RIS reflection coefficient. In another example, 1508 may be performed by the wireless device 1002 in FIG. 10, which may obtain a set of reflection coefficients from a module of the wireless device 1102 that calculates reflection coefficients, or may receive the reflection coefficients from a sensing processing entity. The set of reflection coefficients may be for a second configuration of the set of sensing signals 1022 associated with a second reflection path including the set of sensing signals 1022, the set of sensing signals 1024, and the set of sensing signals 1026, which includes reflecting off of the RIS 1004. Each of the set of sensing signals is associated with a second RIS reflection coefficient. In another example, 1508 may be performed by the wireless device 1102 in FIG. 11, which may obtain a set of reflection coefficients from a module of the wireless device 1102 that calculates reflection coefficients, or may receive the reflection coefficients from a sensing processing entity. The set of reflection coefficients may be for a second configuration of the set of sensing signals 1122 associated with a second reflection path including the set of sensing signals 1122, the set of sensing signals 1124, and the set of sensing signals 1126, which includes reflecting off of the RIS 1106. Each of the set of sensing signals is associated with a second RIS reflection coefficient. In another example, 1308 may be performed by the wireless device 1209 in FIG. 12, which may obtain a set of reflection coefficients from a module of the wireless device 1202 that calculates reflection coefficients at 1210. The set of reflection coefficients may be for a second configuration of the set of sensing signals 1222 associated with a second reflection path including the set of sensing signals 1222, the set of sensing signals 1224, and the set of sensing signals 1226, which includes reflecting off of the RIS 1206. Each of the set of sensing signals is associated with a second RIS reflection coefficient. Moreover, 1508 may be performed by the component 199 in FIG. 1, 3, 6, 18, 19, or 20.

At 1510, the wireless device may receive the second set of sensing signals via the second reflection path. For example, 1510 may be performed by the wireless device 906 in FIG. 9, which may receive the set of sensing signals 926, which originate from the set of sensing signals 922, via the second reflection path. In another example, 1510 may be performed by the wireless device 1002 in FIG. 10, which may receive the set of sensing signals 1026, which originate from the set of sensing signals 1022, via the second reflection path. In another example, 1310 may be performed by the wireless device 1102 in FIG. 11, which may receive the set of sensing signals 1126, which originate from the set of sensing signals 1122, via the second reflection path. In another example, 1310 may be performed by the wireless device 1209 in FIG. 12, which may receive the set of sensing signals 1226, which originate from the set of sensing signals 1122, via the second reflection path. Moreover, 1510 may be performed by the component 199 in FIG. 1, 3, 6, 18, 19, or 20.

At 1512, the wireless device may calculate a second Doppler frequency of the target object based on the second set of sensing signals and the second configuration. For example, 1512 may be performed by the wireless device 906 in FIG. 9, which may, at 928, calculate a second Doppler frequency of the target object 908 based on the set of sensing signals 920 and the second configuration. In another example, 1512 may be performed by the wireless device 1002 in FIG. 10, which may, at 1028, calculate a second Doppler frequency of the target object 1008 based on the set of sensing signals 1020 and the second configuration. In another example, 1312 may be performed by the wireless device 1102 in FIG. 11, which may, at 1128, calculate a second Doppler frequency of the target object 1108 based on the set of sensing signals 1120 and the second configuration. In another example, 1312 may be performed by the wireless device 1209 in FIG. 12, which may, at 1228, calculate a second Doppler frequency of the target object 1208 based on the set of sensing signals 1126 and the second configuration. Moreover, 1512 may be performed by the component 199 in FIG. 1, 3, 6, 18, 19, or 20.

At 1514, the wireless device may transmit a Doppler frequency report that may include an indication of at least one of the calculated first Doppler frequency or the calculated second Doppler frequency. For example, 1514 may be performed by the wireless device 906 in FIG. 9, which may transmit the velocity report 932 including a Doppler frequency report to the wireless device 902, or a sensing entity, that may include an indication of at least one of the first Doppler frequency or the second Doppler frequency calculated at 928. In another example, 1514 may be performed by the wireless device 1002 in FIG. 10, which may transmit a velocity report including a Doppler frequency report to another wireless device, such as a sensing entity, that may include an indication of at least one of the first Doppler frequency or the second Doppler frequency calculated at 1028. In another example, 1514 may be performed by the wireless device 1102 in FIG. 11, which may transmit a velocity report including a Doppler frequency report to another wireless device, such as a sensing entity, that may include an indication of at least one of the first Doppler frequency or the second Doppler frequency calculated at 1128. In another example, 1514 may be performed by the wireless device 1209 in FIG. 12, which may transmit the velocity report 1232 including a Doppler frequency report to the wireless device 1202, or another wireless device, such as a sensing entity, that may include an indication of at least one of the first Doppler frequency or the second Doppler frequency calculated at 1228. Moreover, 1514 may be performed by the component 199 in FIG. 1, 3, 6, 18, 19, or 20.

At 1516, the wireless device may select at least one of the calculated first Doppler frequency and the calculated second Doppler frequency based on a first size of the calculated first Doppler frequency and a second size of the calculated second Doppler frequency. For example, 1516 may be performed by the wireless device 906 in FIG. 9, which may select at least one of the calculated first Doppler frequency and the calculated second Doppler frequency to transmit based on a first size of the calculated first Doppler frequency (e.g., the largest Doppler frequency, or frequencies, calculated from the set of sensing signals 920) and a second size of the calculated second Doppler frequency (e.g., the largest Doppler frequency, or frequencies, calculated from the asset of sensing signals 926). In another example, 1516 may be performed by the wireless device 1002 in FIG. 10, which may select at least one of the calculated first Doppler frequency and the calculated second Doppler frequency to transmit based on a first size of the calculated first Doppler frequency and a second size of the calculated second Doppler frequency. In another example, 1516 may be performed by the wireless device 1102 in FIG. 11, which may select at least one of the calculated first Doppler frequency and the calculated second Doppler frequency to transmit based on a first size of the calculated first Doppler frequency and a second size of the calculated second Doppler frequency. In another example, 1516 may be performed by the wireless device 1209 in FIG. 12, which may select at least one of the calculated first Doppler frequency and the calculated second Doppler frequency to transmit based on a first size of the calculated first Doppler frequency and a second size of the calculated second Doppler frequency. Moreover, 1516 may be performed by the component 199 in FIG. 1, 3, 6, 18, 19, or 20.

At 1518, the wireless device may calculate a velocity of the target object based on the calculated first Doppler frequency and the calculated second Doppler frequency. For example, 1518 may be performed by the wireless device 906 in FIG. 9, which may, at 930, calculate a velocity of the target object 908 based on the calculated first Doppler frequency and the calculated second Doppler frequency. In another example, 1518 may be performed by the wireless device 1002 in FIG. 10, which may, at 1030, calculate a velocity of the target object 1008 based on the calculated first Doppler frequency and the calculated second Doppler frequency. In another example, 1518 may be performed by the wireless device 1102 in FIG. 11, which may, at 1130, calculate a velocity of the target object 1108 based on the calculated first Doppler frequency and the calculated second Doppler frequency. In another example, 1518 may be performed by the wireless device 1209 in FIG. 12, which may, at 1230, calculate a velocity of the target object 1208 based on the calculated first Doppler frequency and the calculated second Doppler frequency. Moreover, 1518 may be performed by the component 199 in FIG. 1, 3, 6, 18, 19, or 20.

At 1520, the wireless device may calculate a velocity of the target object based on the calculated first Doppler frequency, the calculated second Doppler frequency, a first position of the first RIS, and a second position of the second RIS. The first configuration may include the first position of the first RIS. The second configuration may include the second position of the second RIS. For example, 1520 may be performed by the wireless device 1102 in FIG. 11, which may, at 1130, calculate a velocity of the target object 1108 based on the calculated first Doppler frequency, the calculated second Doppler frequency, a first position of the RIS 1104, and a second position of the RIS 1106. The first configuration may include the first position of the RIS 1104. The second configuration may include the second position of the RIS 1106. In another example, 1520 may be performed by the wireless device 1209 in FIG. 12, which may, at 1230, calculate a velocity of the target object 1208 based on the calculated first Doppler frequency, the calculated second Doppler frequency, a first position of the RIS 1204, and a second position of the RIS 1206. The first configuration may include the first position of the RIS 1204. The second configuration may include the second position of the RIS 1206. Moreover, 1520 may be performed by the component 199 in FIG. 1, 3, 6, 18, 19, or 20.

At 1522, the wireless device may calculate a velocity of the target object based on the calculated first Doppler frequency, the calculated second Doppler frequency, and a position of the first RIS. At least one of the first configuration or the second configuration may include a position of the first RIS. For example, 1522 may be performed by the wireless device 906 in FIG. 9, which may, at 930, calculate a velocity of the target object 908 based on the calculated first Doppler frequency, the calculated second Doppler frequency, and a position of the RIS 904. At least one of the first configuration or the second configuration may include a position of the RIS 904. In another example, 1522 may be performed by the wireless device 1002 in FIG. 10, which may, at 1030, calculate a velocity of the target object 1008 based on the calculated first Doppler frequency, the calculated second Doppler frequency, and a position of the RIS 1004. At least one of the first configuration or the second configuration may include a position of the RIS 1004. In another example, 1522 may be performed by the wireless device 1102 in FIG. 11, which may, at 1130, calculate a velocity of the target object 1108 based on the calculated first Doppler frequency, the calculated second Doppler frequency, and a position of the RIS 1104. At least one of the first configuration or the second configuration may include a position of the RIS 1104. In another example, 1522 may be performed by the wireless device 1209 in FIG. 12, which may, at 1230, calculate a velocity of the target object 1208 based on the calculated first Doppler frequency, the calculated second Doppler frequency, and a position of the RIS 1204. At least one of the first configuration or the second configuration may include a position of the RIS 1204. Moreover, 1522 may be performed by the component 199 in FIG. 1, 3, 6, 18, 19, or 20.

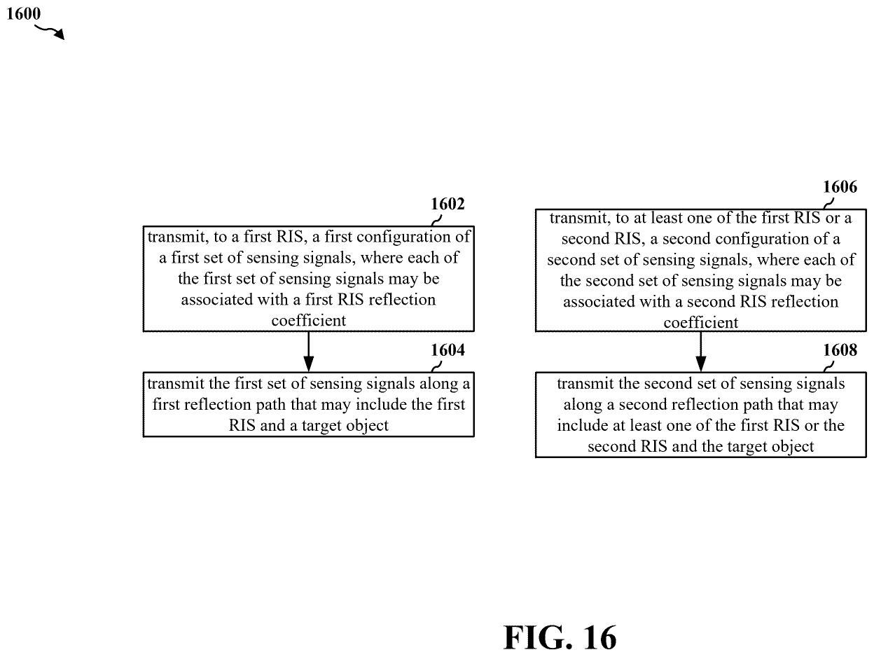

FIG. 16 is a flowchart 1600 of a method of wireless communication. The method may be performed by a wireless device (e.g., the UE 104, the UE 350, the UE 404; the base station 102, the base station 310; the wireless device 502, the wireless device 504, the wireless device 506, the wireless device 508, the wireless device 602, the wireless device 606, the wireless device 702, the wireless device 802, the wireless device 808, the wireless device 902, the wireless device 906, the wireless device 1002, the wireless device 1102, the wireless device 1202, the wireless device 1209; the apparatus 1804; the network entity 1802, the network entity 1902, the network entity 2060). At 1602, the wireless device may transmit, to a first RIS, a first configuration of a first set of sensing signals. Each of the first set of sensing signals may be associated with a first RIS reflection coefficient. For example, 1602 may be performed by the wireless device 902 in FIG. 9, which may transmit, to the RIS 904, the set of reflection coefficients 912, which may be for a first configuration of the set of sensing signals 918, which originate with the set of sensing signals 916. Each of the set of sensing signals 918 may be associated with a first RIS reflection coefficient. In another example, 1602 may be performed by the wireless device 1002 in FIG. 10, which may transmit, to the RIS 1004, the set of reflection coefficients 1012 for a first configuration of the set of sensing signals 1016. Each of the set of sensing signals 1016 may be associated with a first RIS reflection coefficient. In another example, 1602 may be performed by the wireless device 1102 in FIG. 11, which may transmit, to the RIS 1104, the set of reflection coefficients 1112 for a first configuration of the set of sensing signals 1116. Each of the set of sensing signals 1116 may be associated with a first RIS reflection coefficient. In another example, 1602 may be performed by the wireless device 1202 in FIG. 12, which may transmit, to the RIS 1204, the set of reflection coefficients 1112 for a first configuration of the set of sensing signals 1216. Each of the set of sensing signals 1116 may be associated with a first RIS reflection coefficient. Moreover, 1602 may be performed by the component 198 in FIG. 1, 3, 6, 18, 19, or 20.

At 1604, the wireless device may transmit the first set of sensing signals along a first reflection path including the first RIS and a target object. For example, 1604 may be performed by the wireless device 902 in FIG. 9, which may transmit the set of sensing signals 916 along a first reflection path, including the set of sensing signals 916, the set of sensing signals 918, and the set of sensing signals 920, which includes reflecting off of the RIS 904 and the target object 908. In another example, 1604 may be performed by the wireless device 1002 in FIG. 10, which may transmit the set of sensing signals 1016 along a first reflection path including the set of sensing signals 1016, the set of sensing signals 1017, the set of sensing signals 1018, and the set of sensing signals 1020, which includes reflecting off of the RIS 1004 and the target object 1008. In another example, 1604 may be performed by the wireless device 1102 in FIG. 11, which may transmit the set of sensing signals 1116 along a first reflection path including the set of sensing signals 1116, the set of sensing signals 1118, and the set of sensing signals 1120, which includes reflecting off of the RIS 1104 and the target object 1108. In another example, 1604 may be performed by the wireless device 1202 in FIG. 12, which may transmit the set of sensing signals 1216 along a first reflection path including the set of sensing signals 1218, and the set of sensing signals 1220, which includes reflecting off of the RIS 1204 and the target object 1208. Moreover, 1604 may be performed by the component 198 in FIG. 1, 3, 6, 18, 19, or 20.

At 1606, the wireless device may transmit, to at least one of the first RIS or a second RIS, a second configuration of a second set of sensing signals. Each of the second set of sensing signals is associated with a second RIS reflection coefficient. For example, 1606 may be performed by the wireless device 902 in FIG. 9, which may transmit, to the RIS 904, the set of reflection coefficients 912, which may be for a second configuration of the set of sensing signals 922. Each of the set of sensing signals 922 is associated with a second RIS reflection coefficient. In another example, 1606 may be performed by the wireless device 1002 in FIG. 10, which may transmit, to the RIS 1004, the set of reflection coefficients 1012 for a second configuration of the set of sensing signals 1022. Each of the set of sensing signals 1022 is associated with a second RIS reflection coefficient. In another example, 1606 may be performed by the wireless device 1102 in FIG. 11, which may transmit, to the RIS 1106, the set of reflection coefficients 1114 for a second configuration of the set of sensing signals 1122. Each of the set of sensing signals 1122 is associated with a second RIS reflection coefficient. In another example, 1606 may be performed by the wireless device 1202 in FIG. 12, which may transmit, to the RIS 1206, the set of reflection coefficients 1214 for a second configuration of the set of sensing signals 1222. Each of the set of sensing signals 1222 is associated with a second RIS reflection coefficient. Moreover, 1606 may be performed by the component 198 in FIG. 1, 3, 6, 18, 19, or 20.

At 1608, the wireless device may transmit the second set of sensing signals along a second reflection path including at least one of the first RIS or the second RIS and the target object. For example, 1608 may be performed by the wireless device 902 in FIG. 9, which may transmit the set of sensing signals 922 along a second reflection path including the set of sensing signals 922, the set of sensing signals 924, and the set of sensing signals 926, which includes reflecting off of the RIS 904 and the target object 908. In another example, 1608 may be performed by the wireless device 1002 in FIG. 10, which may transmit the set of sensing signals 1022 along a second reflection path including the set of sensing signals 1022, the set of sensing signals 1024, and the set of sensing signals 1026, which includes reflecting off of the RIS 1004 and the target object 1008. In another example, 1608 may be performed by the wireless device 1102 in FIG. 11, which may transmit the set of sensing signals 1122 along a second reflection path including the set of sensing signals 1122, the set of sensing signals 1124, and the set of sensing signals 1126, which includes reflecting off of the RIS 1106 and the target object 1108. In another example, 1608 may be performed by the wireless device 1202 in FIG. 12, which may transmit the set of sensing signals 1222 along a second reflection path including the set of sensing signals 1222, the set of sensing signals 1224, and the set of sensing signals 1226, which includes reflecting off of the RIS 1206 and the target object 1208. Moreover, 1608 may be performed by the component 198 in FIG. 1, 3, 6, 18, 19, or 20.

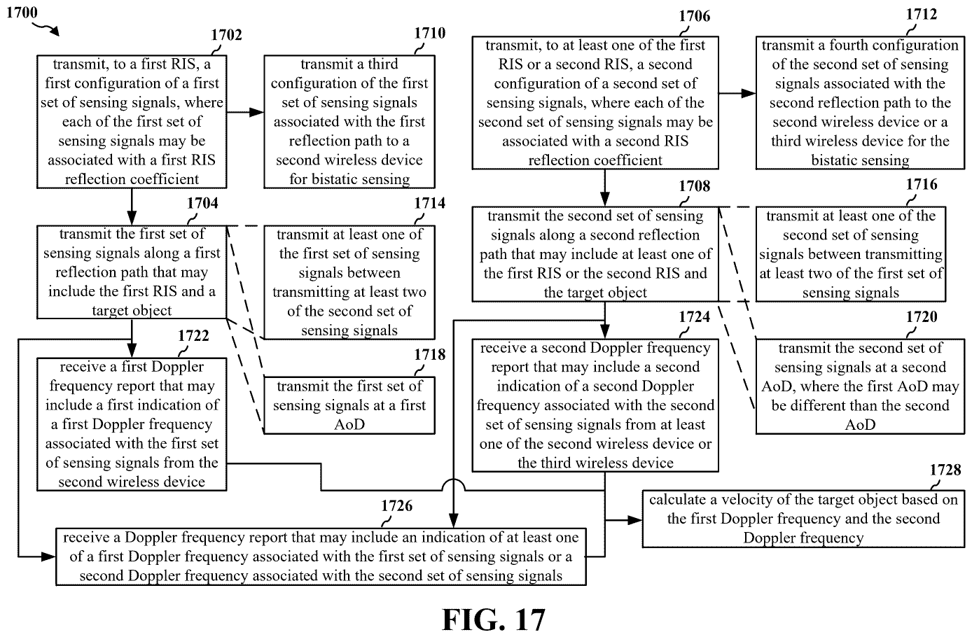

FIG. 17 is a flowchart 1700 of a method of wireless communication. The method may be performed by a wireless device (e.g., the UE 104, the UE 350, the UE 404; the base station 102, the base station 310; the wireless device 502, the wireless device 504, the wireless device 506, the wireless device 508, the wireless device 602, the wireless device 606, the wireless device 702, the wireless device 802, the wireless device 808, the wireless device 902, the wireless device 906, the wireless device 1002, the wireless device 1102, the wireless device 1202, the wireless device 1209; the apparatus 1804; the network entity 1802, the network entity 1902, the network entity 2060). At 1702, the wireless device may transmit, to a first RIS, a first configuration of a first set of sensing signals. Each of the first set of sensing signals may be associated with a first RIS reflection coefficient. For example, 1702 may be performed by the wireless device 902 in FIG. 9, which may transmit, to the RIS 904, the set of reflection coefficients 912, which may be for a first configuration of the set of sensing signals 918, which originate with the set of sensing signals 916. Each of the set of sensing signals 918 may be associated with a first RIS reflection coefficient. In another example, 1702 may be performed by the wireless device 1002 in FIG. 10, which may transmit, to the RIS 1004, the set of reflection coefficients 1012 for a first configuration of the set of sensing signals 1016. Each of the set of sensing signals 1016 may be associated with a first RIS reflection coefficient. In another example, 1702 may be performed by the wireless device 1102 in FIG. 11, which may transmit, to the RIS 1104, the set of reflection coefficients 1112 for a first configuration of the set of sensing signals 1116. Each of the set of sensing signals 1116 may be associated with a first RIS reflection coefficient. In another example, 1702 may be performed by the wireless device 1202 in FIG. 12, which may transmit, to the RIS 1204, the set of reflection coefficients 1112 for a first configuration of the set of sensing signals 1216. Each of the set of sensing signals 1116 may be associated with a first RIS reflection coefficient. Moreover, 1702 may be performed by the component 198 in FIG. 1, 3, 6, 18, 19, or 20.

At 1704, the wireless device may transmit the first set of sensing signals along a first reflection path including the first RIS and a target object. For example, 1704 may be performed by the wireless device 902 in FIG. 9, which may transmit the set of sensing signals 916 along a first reflection path, including the set of sensing signals 916, the set of sensing signals 918, and the set of sensing signals 920, which includes reflecting off of the RIS 904 and the target object 908. In another example, 1704 may be performed by the wireless device 1002 in FIG. 10, which may transmit the set of sensing signals 1016 along a first reflection path including the set of sensing signals 1016, the set of sensing signals 1017, the set of sensing signals 1018, and the set of sensing signals 1020, which includes reflecting off of the RIS 1004 and the target object 1008. In another example, 1704 may be performed by the wireless device 1102 in FIG. 11, which may transmit the set of sensing signals 1116 along a first reflection path including the set of sensing signals 1116, the set of sensing signals 1118, and the set of sensing signals 1120, which includes reflecting off of the RIS 1104 and the target object 1108. In another example, 1704 may be performed by the wireless device 1202 in FIG. 12, which may transmit the set of sensing signals 1216 along a first reflection path including the set of sensing signals 1218, and the set of sensing signals 1220, which includes reflecting off of the RIS 1204 and the target object 1208. Moreover, 1704 may be performed by the component 198 in FIG. 1, 3, 6, 18, 19, or 20.

At 1706, the wireless device may transmit, to at least one of the first RIS or a second RIS, a second configuration of a second set of sensing signals. Each of the second set of sensing signals is associated with a second RIS reflection coefficient. For example, 1706 may be performed by the wireless device 902 in FIG. 9, which may transmit, to the RIS 904, the set of reflection coefficients 912, which may be for a second configuration of the set of sensing signals 922. Each of the set of sensing signals 922 is associated with a second RIS reflection coefficient. In another example, 1706 may be performed by the wireless device 1002 in FIG. 10, which may transmit, to the RIS 1004, the set of reflection coefficients 1012 for a second configuration of the set of sensing signals 1022. Each of the set of sensing signals 1022 is associated with a second RIS reflection coefficient. In another example, 1706 may be performed by the wireless device 1102 in FIG. 11, which may transmit, to the RIS 1106, the set of reflection coefficients 1114 for a second configuration of the set of sensing signals 1122. Each of the set of sensing signals 1122 is associated with a second RIS reflection coefficient. In another example, 1706 may be performed by the wireless device 1202 in FIG. 12, which may transmit, to the RIS 1206, the set of reflection coefficients 1214 for a second configuration of the set of sensing signals 1222. Each of the set of sensing signals 1222 is associated with a second RIS reflection coefficient. Moreover, 1706 may be performed by the component 198 in FIG. 1, 3, 6, 18, 19, or 20.

At 1708, the wireless device may transmit the second set of sensing signals along a second reflection path including at least one of the first RIS or the second RIS and the target object. For example, 1708 may be performed by the wireless device 902 in FIG. 9, which may transmit the set of sensing signals 922 along a second reflection path including the set of sensing signals 922, the set of sensing signals 924, and the set of sensing signals 926, which includes reflecting off of the RIS 904 and the target object 908. In another example, 1708 may be performed by the wireless device 1002 in FIG. 10, which may transmit the set of sensing signals 1022 along a second reflection path including the set of sensing signals 1022, the set of sensing signals 1024, and the set of sensing signals 1026, which includes reflecting off of the RIS 1004 and the target object 1008. In another example, 1708 may be performed by the wireless device 1102 in FIG. 11, which may transmit the set of sensing signals 1122 along a second reflection path including the set of sensing signals 1122, the set of sensing signals 1124, and the set of sensing signals 1126, which includes reflecting off of the RIS 1106 and the target object 1108. In another example, 1708 may be performed by the wireless device 1202 in FIG. 12, which may transmit the set of sensing signals 1222 along a second reflection path including the set of sensing signals 1222, the set of sensing signals 1224, and the set of sensing signals 1226, which includes reflecting off of the RIS 1206 and the target object 1208. Moreover, 1708 may be performed by the component 198 in FIG. 1, 3, 6, 18, 19, or 20.

At 1710, the wireless device may transmit a third configuration of the first set of sensing signals associated with the first reflection path to a second wireless device for bistatic sensing. For example, 1710 may be performed by the wireless device 1202 in FIG. 12, which may transmit a third configuration of the set of sensing signals 1216 associated with the first reflection path to the wireless device 1209 for bistatic sensing. The third configuration may be transmitted as the set of reflection coefficients 1215.

In another example, 1710 may be performed by the wireless device 902 in FIG. 9, which may transmit a third configuration of the set of sensing signals 916 associated with the first reflection path to the wireless device 906 for bistatic sensing. The third configuration may be transmitted as the set of reflection coefficients 1215 Moreover, 1710 may be performed by the component 198 in FIG. 1, 3, 6, 18, 19, or 20.

At 1712, the wireless device may transmit a fourth configuration of the second set of sensing signals associated with the second reflection path to the second wireless device or a third wireless device for the bistatic sensing. For example, 1712 may be performed by the wireless device 1202 in FIG. 12, which may transmit a fourth configuration of the set of sensing signals 1222 associated with the second reflection path to the wireless device 1209 or a third wireless device (e.g., where the set of sensing signals 1220 are received by the wireless device 1209 and the set of sensing signals 1226 are received by a different wireless device) for the bistatic sensing. Moreover, 1712 may be performed by the component 198 in FIG. 1, 3, 6, 18, 19, or 20.

At 1714, the wireless device may transmit at least one of the first set of sensing signals between transmitting at least two of the second set of sensing signals. For example, 1714 may be performed by the wireless device 902 in FIG. 9, which may transmit at least one of the set of sensing signals 916 between transmitting at least two of the set of sensing signals 922. Moreover, 1714 may be performed by the component 198 in FIG. 1, 3, 6, 18, 19, or 20.

At 1716, the wireless device may transmit at least one of the second set of sensing signals between transmitting at least two of the first set of sensing signals. For example, 1716 may be performed by the wireless device 902 in FIG. 9, which may transmit at least one of the set of sensing signals 922 between transmitting at least two of the set of sensing signals 916. In other words, the wireless device 902 may be configured to alternate between transmitting some of the set of sensing signals 916 and some of the set of sensing signals 922. Moreover, 1716 may be performed by the component 198 in FIG. 1, 3, 6, 18, 19, or 20.

At 1718, the wireless device may transmit the first set of sensing signals at a first AoD. For example, 1718 may be performed by the wireless device 902 in FIG. 9, which may transmit the set of sensing signals 916 at a first AoD from an antenna of the wireless device 902 to the target object 908. Moreover, 1718 may be performed by the component 198 in FIG. 1, 3, 6, 18, 19, or 20.

At 1720, the wireless device may transmit the second set of sensing signals at a second AoD. The first AoD may be different than the second AoD. For example, 1720 may be performed by the wireless device 902 in FIG. 9, which may transmit the set of sensing signals 922 at a second AoD from the wireless device 902 to the RIS 904. The first AoD may be different than the second AoD. Moreover, 1720 may be performed by the component 198 in FIG. 1, 3, 6, 18, 19, or 20.

At 1722, the wireless device may receive a first Doppler frequency report that may include a first indication of a first Doppler frequency associated with the first set of sensing signals from the second wireless device. For example, 1722 may be performed by the wireless device 902 in FIG. 9, which may receive a first Doppler frequency report in the velocity report 932 that may include a first indication of a first Doppler frequency associated with the set of sensing signals 916 from the wireless device 906. Moreover, 1722 may be performed by the component 198 in FIG. 1, 3, 6, 18, 19, or 20.

At 1724, the wireless device may receive a second Doppler frequency report that may include a second indication of a second Doppler frequency associated with the second set of sensing signals from at least one of the second wireless device or the third wireless device. For example, 1724 may be performed by the wireless device 902 in FIG. 9, which may receive a second Doppler frequency report in the velocity report 932 that may include a second indication of a second Doppler frequency associated with the set of sensing signals 926 from at least one of the wireless device 906 or another wireless device (e.g., where the set of sensing signals 920 are received by the wireless device 906 and the set of sensing signals 926 are received by a different wireless device for bistatic sensing). Moreover, 1724 may be performed by the component 198 in FIG. 1, 3, 6, 18, 19, or 20.

At 1726, the wireless device may receive a Doppler frequency report that may include an indication of at least one of a first Doppler frequency associated with the first set of sensing signals or a second Doppler frequency associated with the second set of sensing signals. For example, 1726 may be performed by the wireless device 902 in FIG. 9, which may receive a Doppler frequency report in the velocity report 932 that may include an indication of at least one of a first Doppler frequency associated with the set of sensing signals 920 or a second Doppler frequency associated with the set of sensing signals 926. Moreover, 1726 may be performed by the component 198 in FIG. 1, 3, 6, 18, 19, or 20.

At 1728, the wireless device may calculate a velocity of the target object based on the first Doppler frequency and the second Doppler frequency. For example, 1728 may be performed by the wireless device 902 in FIG. 9, which may, at 930, calculate a velocity of the target object 908 based on the first Doppler frequency and the second Doppler frequency. Moreover, 1728 may be performed by the component 198 in FIG. 1, 3, 6, 18, 19, or 20.

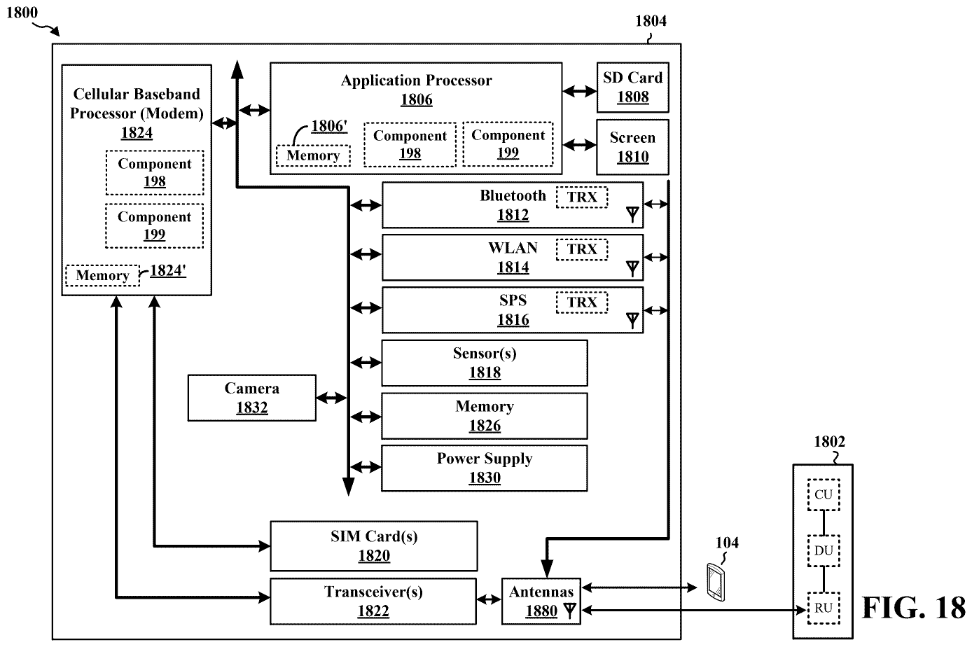

FIG. 18 is a diagram 1800 illustrating an example of a hardware implementation for an apparatus 1804. The apparatus 1804 may be a UE, a component of a UE, or may implement UE functionality. In some aspects, the apparatus 1104 may include a cellular baseband processor 1824 (also referred to as a modem) coupled to one or more transceivers 1822 (e.g., cellular RF transceiver). The cellular baseband processor 1824 may include on-chip memory 1824′. In some aspects, the apparatus 1804 may further include one or more subscriber identity modules (SIM) cards 1820 and an application processor 1806 coupled to a secure digital (SD) card 1808 and a screen 1810. The application processor 1806 may include on-chip memory 1806′. In some aspects, the apparatus 1804 may further include a Bluetooth module 1812, a WLAN module 1814, an SPS module 1816 (e.g., GNSS module), one or more sensor modules 1818 (e.g., barometric pressure sensor/altimeter; motion sensor such as inertial measurement unit (IMU), gyroscope, and/or accelerometer(s); magnetometer, audio and/or other technologies used for positioning), additional memory modules 1826, a power supply 1830, and/or a camera 1832. The Bluetooth module 1812, the WLAN module 1814, and the SPS module 1816 may include an on-chip transceiver (TRX) (or in some cases, just a receiver (RX)). The Bluetooth module 1812, the WLAN module 1814, and the SPS module 1816 may include their own dedicated antennas and/or utilize the antennas 1880 for communication. The cellular baseband processor 1824 communicates through the transceiver(s) 1822 via one or more antennas 1880 with the UE 104 and/or with an RU associated with a network entity 1802. The cellular baseband processor 1824 and the application processor 1806 may each include a computer-readable medium/memory 1824′, 1806′, respectively. The additional memory modules 1826 may also be considered a computer-readable medium/memory. Each computer-readable medium/memory 1824′, 1806′, 1826 may be non-transitory. The cellular baseband processor 1824 and the application processor 1806 are each responsible for general processing, including the execution of software stored on the computer-readable medium/memory. The software, when executed by the cellular baseband processor 1824/application processor 1806, causes the cellular baseband processor 1824/application processor 1806 to perform the various functions described supra. The computer-readable medium/memory may also be used for storing data that is manipulated by the cellular baseband processor 1824/application processor 1806 when executing software. The cellular baseband processor 1824/application processor 1806 may be a component of the UE 350 and may include the memory 360 and/or at least one of the TX processor 368, the RX processor 356, and the controller/processor 359. In one configuration, the apparatus 1804 may be a processor chip (modem and/or application) and include just the cellular baseband processor 1824 and/or the application processor 1806, and in another configuration, the apparatus 1804 may be the entire UE (e.g., see UE 350 of FIG. 3) and include the additional modules of the apparatus 1804.

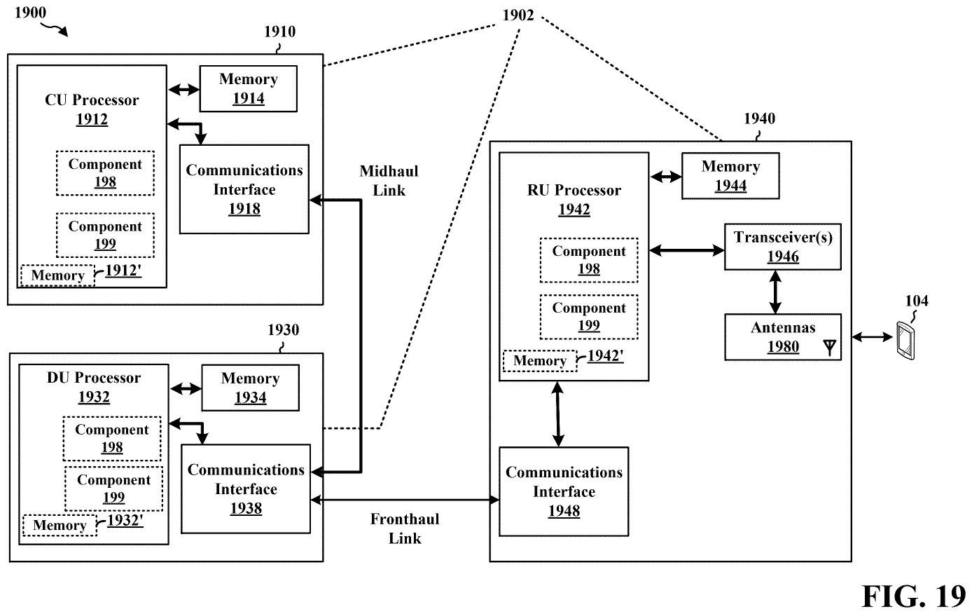

As discussed supra, the component 198 may be configured to transmit, to a first RIS, a first configuration of a first set of sensing signals. Each of the first set of sensing signals may be associated with a first RIS reflection coefficient. The component 198 may transmit the first set of sensing signals along a first reflection path including the first RIS and a target object. The component 198 may transmit, to at least one of the first RIS or a second RIS, a second configuration of a second set of sensing signals. Each of the second set of sensing signals is associated with a second RIS reflection coefficient. The component 198 may transmit the second set of sensing signals along a second reflection path including at least one of the first RIS or the second RIS and the target object. The RIS may reflect the first set of sensing signals based on the first RIS reflection coefficient and may reflect the second set of sensing signals based on the second RIS reflection coefficient. The component 198 may be within the cellular baseband processor 1824, the application processor 1806, or both the cellular baseband processor 1824 and the application processor 1806. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1804 may include a variety of components configured for various functions. In one configuration, the apparatus 1804, and in particular the cellular baseband processor 1824 and/or the application processor 1806, may include means for transmitting, to a first RIS, a first configuration of a first set of sensing signals. Each of the first set of sensing signals is associated with a first RIS reflection coefficient. The apparatus 1804 may include means for transmitting, to at least one of the first RIS or a second RIS, a second configuration of a second set of sensing signals. Each of the second set of sensing signals is associated with a second RIS reflection coefficient. The apparatus 1804 may include means for transmitting the first set of sensing signals along a first reflection path including the first RIS and a target object. The apparatus 1804 may include means for transmitting the second set of sensing signals along a second reflection path including at least one of the first RIS or the second RIS and the target object. The first RIS reflection coefficient may be different from the second RIS reflection coefficient. The apparatus 1804 may include means for transmitting the first set of sensing signals by transmitting at least one of the first set of sensing signals between transmitting at least two of the second set of sensing signals. The apparatus 1804 may include means for transmitting the second set of sensing signals by transmitting at least one of the second set of sensing signals between transmitting at least two of the first set of sensing signals. The apparatus 1804 may include means for transmitting the first set of sensing signals by transmitting the first set of sensing signals at a first AoD. The apparatus 1804 may include means for transmitting the second set of sensing signals by transmitting the second set of sensing signals at a second AoD. The first AoD may be different than the second AoD. The apparatus 1804 may include means for transmitting a third configuration of the first set of sensing signals associated with the first reflection path to a second wireless device for bistatic sensing. The apparatus 1804 may include means for transmitting a fourth configuration of the second set of sensing signals associated with the second reflection path to the second wireless device for the bistatic sensing. The first reflection path may include a first reflection of the first set of sensing signals from the target object to the second wireless device. The second reflection path may include a second reflection of the second set of sensing signals from the target object to the first RIS. The apparatus 1804 may include means for receiving a Doppler frequency report including an indication of at least one of a first Doppler frequency associated with the first set of sensing signals and a second Doppler frequency associated with the second set of sensing signals. The indication of at least one of the first Doppler frequency or the second Doppler frequency may include (a) a quantization value of a set of Doppler frequencies associated with the first set of sensing signals and the second set of sensing signals, (b) a first absolute value for the first Doppler frequency and a second absolute value for the second Doppler frequency, (c) a differential value between the first Doppler frequency and the second Doppler frequency, or (d) a first direction associated with the first Doppler frequency and a second direction associated with the second Doppler frequency. The set of Doppler frequencies may include a set of highest Doppler frequencies out of a set of calculated Doppler frequencies. The set of calculated Doppler frequencies may include at least the first Doppler frequency and the second Doppler frequency. The apparatus 1804 may include means for calculating a velocity of the target object based on the first Doppler frequency and the second Doppler frequency. The third configuration may include a first position of the first RIS. The fourth configuration may include at least one of the first position of the first RIS or a second position of the second RIS. The apparatus 1804 may include means for transmitting a third configuration of the first set of sensing signals associated with the first reflection path to a second wireless device for bistatic sensing. The apparatus 1804 may include means for transmitting a fourth configuration of the second set of sensing signals associated with the second reflection path to a third wireless device for the bistatic sensing. The apparatus 1804 may include means for receiving a first Doppler frequency report including a first indication of a first Doppler frequency associated with the first set of sensing signals from the second wireless device. The apparatus 1804 may include means for receiving a second Doppler frequency report including a second indication of a second Doppler frequency associated with the second set of sensing signals from the second wireless device. The first indication of the first Doppler frequency may include a quantization value of a set of Doppler frequencies associated with the first set of sensing signals, a first absolute value for the first Doppler frequency, or a first direction associated with the first Doppler frequency. The set of Doppler frequencies may include a first number of highest Doppler frequencies associated with the first set of sensing signals. The apparatus 1804 may include means for calculating a velocity of the target object based on the first Doppler frequency report and the second Doppler frequency report. The third configuration may include a first position of the first RIS. The fourth configuration may include at least one of the first position of the first RIS or a second position of the second RIS. The apparatus 1804 may include means for receiving the first set of sensing signals via the first reflection path. The apparatus 1804 may include means for receiving the second set of sensing signals via the second reflection path. The apparatus 1804 may include means for calculating a first Doppler frequency of the target object based on the first set of sensing signals and the first configuration. The apparatus 1804 may include means for calculating a second Doppler frequency of the target object based on the second set of sensing signals and the second configuration. The apparatus 1804 may include means for measuring the first set of sensing signals. The apparatus 1804 may include means for calculating the first Doppler frequency of the target object by calculating the first Doppler frequency based on the measured first set of sensing signals. The apparatus 1804 may include means for measuring the second set of sensing signals. The apparatus 1804 may include means for calculating the second Doppler frequency of the target object by calculating the second Doppler frequency based on the measured second set of sensing signals. The apparatus 1804 may include means for transmitting, to the first RIS, a request for a position of the first RIS. The apparatus 1804 may include means for receiving, from the first RIS, the position of the first RIS. The first configuration may be based on the position of the first RIS. The apparatus 1804 may include means for transmitting the calculated velocity to a second wireless device. The apparatus 1804 may include means for transmitting the calculated first Doppler frequency and the calculated second Doppler frequency to a second wireless device. The apparatus 1804 may include means for receiving the first set of sensing signals via the first reflection path. The apparatus 1804 may include means for receiving the second set of sensing signals via the second reflection path. The apparatus 1804 may include means for calculating a position of the target object based on the first set of sensing signals, the first configuration, the second set of sensing signals, and the second configuration. The apparatus 1804 may include means for transmitting the calculated position of the target object to a second wireless device. The apparatus 1804 may include means for receiving the first set of sensing signals via the first reflection path. The apparatus 1804 may include means for receiving the second set of sensing signals via the second reflection path. The apparatus 1804 may include means for calculating a position of the first RIS based on the first set of sensing signals and the first configuration. The apparatus 1804 may include means for calculating the position of the first RIS further based on the second set of sensing signals and the second configuration. The apparatus 1804 may include means for calculating a position of the second RIS based on the second set of sensing signals and the second configuration. The apparatus 1804 may include means for transmitting at least one of the calculated position of the first RIS or the calculated position of the second RIS to a second wireless device. The second wireless device may include a sensing processing entity. The apparatus 1804 may include means for receiving a report of a calculated velocity of the target object. The means may be the component 198 of the apparatus 1804 configured to perform the functions recited by the means. As described supra, the apparatus 1804 may include the TX processor 368, the RX processor 356, and the controller/processor 359. As such, in one configuration, the means may be the TX processor 368, the RX processor 356, and/or the controller/processor 359 configured to perform the functions recited by the means. As discussed supra, the component 199 may be configured to obtain a first configuration of a first set of sensing signals associated with a first reflection path including a first RIS. Each of the first set of sensing signals may be associated with a first RIS reflection coefficient. The component 199 may receive the first set of sensing signals via the first reflection path. The component 199 may calculate a first Doppler frequency of a target object based on the first set of sensing signals and the first configuration. The component 199 may obtain a second configuration of a second set of sensing signals associated with a second reflection path including at least one of the first RIS or a second RIS. Each of the second set of sensing signals may be associated with a second RIS reflection coefficient. The component 199 may receive the second set of sensing signals via the second reflection path. The component 199 may calculate a second Doppler frequency of the target object based on the second set of sensing signals and the second configuration. A velocity of the target object may be calculated based on the first Doppler frequency and the second Doppler frequency. The component 199 may be within the cellular baseband processor 1824, the application processor 1806, or both the cellular baseband processor 1824 and the application processor 1806. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1804 may include a variety of components configured for various functions. In one configuration, the apparatus 1804, and in particular the cellular baseband processor 1824 and/or the application processor 1806, may include means for obtaining a first configuration of a first set of sensing signals associated with a first reflection path including a first RIS. Each of the first set of sensing signals is associated with a first RIS reflection coefficient. The apparatus 1804 may include means for obtaining a second configuration of a second set of sensing signals associated with a second reflection path including at least one of the first RIS or a second RIS. Each of the second set of sensing signals may be associated with a second RIS reflection coefficient. The apparatus 1804 may include means for receiving the first set of sensing signals via the first reflection path. The apparatus 1804 may include means for receiving the second set of sensing signals via the second reflection path. The apparatus 1804 may include means for calculating a first Doppler frequency of a target object based on the first set of sensing signals and the first configuration. The apparatus 1804 may include means for calculating a second Doppler frequency of the target object based on the second set of sensing signals and the second configuration. The apparatus 1804 may include means for obtaining the first configuration by receiving the first configuration from a first network node. The apparatus 1804 may include means for obtaining the second configuration by receiving the second configuration from at least one of the first network node or a second network node. The apparatus 1804 may include means for obtaining the first configuration by configuring the first set of sensing signals for the first RIS associated with the first reflection path. The apparatus 1804 may include means for obtaining the second configuration by configuring the second set of sensing signals for at least one of the first RIS or the second RIS associated with the second reflection path. The first RIS reflection coefficient may be different from the second RIS reflection coefficient. The first reflection path may include a first reflection of the first set of sensing signals from the target object to the wireless device. The second reflection path may include a second reflection of the second set of sensing signals from the target object to the first RIS. The first reflection path may include a first reflection of the first set of sensing signals off of the first RIS. The second reflection path may include a second reflection of the second set of sensing signals off of the second RIS. The first reflection path may include a network node that transmits the first set of sensing signals. The second reflection path may include the network node that transmits the second set of sensing signals. The wireless device may include the network node. The first reflection path may include a first network node that transmits the first set of sensing signals. The second reflection path may include a second network node that transmits the second set of sensing signals. The wireless device may include at least one of the first network node or the second network node. The apparatus 1804 may include means for receiving the first set of sensing signals by receiving at least one of the first set of sensing signals between receiving at least two of the second set of sensing signals. The apparatus 1804 may include means for receiving the second set of sensing signals by receiving at least one of the second set of sensing signals between receiving at least two of the first set of sensing signals. The apparatus 1804 may include means for receiving the first set of sensing signals by receiving the first set of sensing signals at a first AoA. The apparatus 1804 may include means for receiving the second set of sensing signals by receiving the second set of sensing signals at a second AoA. The first AoA may be different than the second AoA. The apparatus 1804 may include means for measuring the first set of sensing signals. The apparatus 1804 may include means for calculating the first Doppler frequency of the target object by calculating the first Doppler frequency based on the measured first set of sensing signals. The apparatus 1804 may include means for measuring the second set of sensing signals. The apparatus 1804 may include means for calculating the second Doppler frequency of the target object by calculating the second Doppler frequency based on the measured second set of sensing signals. The apparatus 1804 may include means for transmitting a Doppler frequency report including an indication of at least one of the calculated first Doppler frequency or the calculated second Doppler frequency. The indication of at least one of the calculated first Doppler frequency or the calculated second Doppler frequency may include (a) a quantization value of a set of Doppler frequencies associated with the first set of sensing signals and the second set of sensing signals, (b) a first absolute value for the calculated first Doppler frequency and a second absolute value for the calculated second Doppler frequency, (c) a differential value between the calculated first Doppler frequency and the calculated second Doppler frequency, or (d) a first direction associated with the calculated first Doppler frequency and a second direction associated with the calculated second Doppler frequency. The apparatus 1804 may include means for selecting at least one of the calculated first Doppler frequency or the calculated second Doppler frequency based on a first size of the calculated first Doppler frequency and a second size of the calculated second Doppler frequency. For example, the method may include selecting a Doppler frequency by selecting the largest absolute Doppler frequencies first, followed smaller absolute Doppler frequencies until K maximum Doppler frequency values are selected. The apparatus 1804 may include means for calculating a velocity of the target object based on the calculated first Doppler frequency and the calculated second Doppler frequency. The first configuration may include a first position of the first RIS. The second configuration may include a second position of the second RIS. The apparatus 1804 may include means for calculating a velocity of the target object based on the calculated first Doppler frequency, the calculated second Doppler frequency, the first position of the first RIS, and the second position of the second RIS. At least one of the first configuration or the second configuration may include a position of the first RIS. The apparatus 1804 may include means for calculating a velocity of the target object based on the calculated first Doppler frequency, the calculated second Doppler frequency, and the position of the first RIS. The wireless device may include at least one of a network node or a UE. The apparatus 1804 may include means for transmitting the calculated velocity of the target object to a network node. The network node may include a base station or a TRP. The means may be the component 199 of the apparatus 1804 configured to perform the functions recited by the means. As described supra, the apparatus 1804 may include the TX processor 368, the RX processor 356, and the controller/processor 359. As such, in one configuration, the means may be the TX processor 368, the RX processor 356, and/or the controller/processor 359 configured to perform the functions recited by the means. FIG. 19 is a diagram 1900 illustrating an example of a hardware implementation for a network entity 1902. The network entity 1902 may be a BS, a component of a BS, or may implement BS functionality. The network entity 1902 may include at least one of a CU 1910, a DU 1930, or an RU 1940. For example, depending on the layer functionality handled by the component 199, the network entity 1902 may include the CU 1910; both the CU 1910 and the DU 1930; each of the CU 1910, the DU 1930, and the RU 1940; the DU 1930; both the DU 1930 and the RU 1940; or the RU 1940. The CU 1910 may include a CU processor 1912. The CU processor 1912 may include on-chip memory 1912′. In some aspects, the CU 1910 may further include additional memory modules 1914 and a communications interface 1918. The CU 1910 communicates with the DU 1930 through a midhaul link, such as an F1 interface. The DU 1930 may include a DU processor 1932. The DU processor 1932 may include on-chip memory 1932′. In some aspects, the DU 1930 may further include additional memory modules 1934 and a communications interface 1938. The DU 1930 communicates with the RU 1940 through a fronthaul link. The RU 1940 may include an RU processor 1942. The RU processor 1942 may include on-chip memory 1942′. In some aspects, the RU 1940 may further include additional memory modules 1944, one or more transceivers 1946, antennas 1980, and a communications interface 1948. The RU 1940 communicates with the UE 104. The on-chip memory 1912′, 1932′, 1942′ and the additional memory modules 1914, 1934, 1944 may each be considered a computer-readable medium/memory. Each computer-readable medium/memory may be non-transitory. Each of the processors 1912, 1932, 1942 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 198 may be configured to transmit, to a first RIS, a first configuration of a first set of sensing signals. Each of the first set of sensing signals may be associated with a first RIS reflection coefficient. The component 198 may transmit the first set of sensing signals along a first reflection path including the first RIS and a target object. The component 198 may transmit, to at least one of the first RIS or a second RIS, a second configuration of a second set of sensing signals. Each of the second set of sensing signals is associated with a second RIS reflection coefficient. The component 198 may transmit the second set of sensing signals along a second reflection path including at least one of the first RIS or the second RIS and the target object. The RIS may reflect the first set of sensing signals based on the first RIS reflection coefficient and may reflect the second set of sensing signals based on the second RIS reflection coefficient. The component 198 may be within one or more processors of one or more of the CU 1910, DU 1930, and the RU 1940. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1902 may include a variety of components configured for various functions. In one configuration, the network entity 1902 may include means for transmitting, to a first RIS, a first configuration of a first set of sensing signals. Each of the first set of sensing signals is associated with a first RIS reflection coefficient. The network entity 1902 may include means for transmitting, to at least one of the first RIS or a second RIS, a second configuration of a second set of sensing signals. Each of the second set of sensing signals is associated with a second RIS reflection coefficient. The network entity 1902 may include means for transmitting the first set of sensing signals along a first reflection path including the first RIS and a target object. The network entity 1902 may include means for transmitting the second set of sensing signals along a second reflection path including at least one of the first RIS or the second RIS and the target object. The first RIS reflection coefficient may be different from the second RIS reflection coefficient. The network entity 1902 may include means for transmitting the first set of sensing signals by transmitting at least one of the first set of sensing signals between transmitting at least two of the second set of sensing signals. The network entity 1902 may include means for transmitting the second set of sensing signals by transmitting at least one of the second set of sensing signals between transmitting at least two of the first set of sensing signals. The network entity 1902 may include means for transmitting the first set of sensing signals by transmitting the first set of sensing signals at a first AoD. The network entity 1902 may include means for transmitting the second set of sensing signals by transmitting the second set of sensing signals at a second AoD. The first AoD may be different than the second AoD. The network entity 1902 may include means for transmitting a third configuration of the first set of sensing signals associated with the first reflection path to a second wireless device for bistatic sensing. The network entity 1902 may include means for transmitting a fourth configuration of the second set of sensing signals associated with the second reflection path to the second wireless device for the bistatic sensing. The first reflection path may include a first reflection of the first set of sensing signals from the target object to the second wireless device. The second reflection path may include a second reflection of the second set of sensing signals from the target object to the first RIS. The network entity 1902 may include means for receiving a Doppler frequency report including an indication of at least one of a first Doppler frequency associated with the first set of sensing signals and a second Doppler frequency associated with the second set of sensing signals. The indication of at least one of the first Doppler frequency or the second Doppler frequency may include (a) a quantization value of a set of Doppler frequencies associated with the first set of sensing signals and the second set of sensing signals, (b) a first absolute value for the first Doppler frequency and a second absolute value for the second Doppler frequency, (c) a differential value between the first Doppler frequency and the second Doppler frequency, or (d) a first direction associated with the first Doppler frequency and a second direction associated with the second Doppler frequency. The set of Doppler frequencies may include a set of highest Doppler frequencies out of a set of calculated Doppler frequencies. The set of calculated Doppler frequencies may include at least the first Doppler frequency and the second Doppler frequency. The network entity 1902 may include means for calculating a velocity of the target object based on the first Doppler frequency and the second Doppler frequency. The third configuration may include a first position of the first RIS. The fourth configuration may include at least one of the first position of the first RIS or a second position of the second RIS. The network entity 1902 may include means for transmitting a third configuration of the first set of sensing signals associated with the first reflection path to a second wireless device for bistatic sensing. The network entity 1902 may include means for transmitting a fourth configuration of the second set of sensing signals associated with the second reflection path to a third wireless device for the bistatic sensing. The network entity 1902 may include means for receiving a first Doppler frequency report including a first indication of a first Doppler frequency associated with the first set of sensing signals from the second wireless device. The network entity 1902 may include means for receiving a second Doppler frequency report including a second indication of a second Doppler frequency associated with the second set of sensing signals from the second wireless device. The first indication of the first Doppler frequency may include a quantization value of a set of Doppler frequencies associated with the first set of sensing signals, a first absolute value for the first Doppler frequency, or a first direction associated with the first Doppler frequency. The set of Doppler frequencies may include a first number of highest Doppler frequencies associated with the first set of sensing signals. The network entity 1902 may include means for calculating a velocity of the target object based on the first Doppler frequency report and the second Doppler frequency report. The third configuration may include a first position of the first RIS. The fourth configuration may include at least one of the first position of the first RIS or a second position of the second RIS. The network entity 1902 may include means for receiving the first set of sensing signals via the first reflection path. The network entity 1902 may include means for receiving the second set of sensing signals via the second reflection path. The network entity 1902 may include means for calculating a first Doppler frequency of the target object based on the first set of sensing signals and the first configuration. The network entity 1902 may include means for calculating a second Doppler frequency of the target object based on the second set of sensing signals and the second configuration. The network entity 1902 may include means for measuring the first set of sensing signals. The network entity 1902 may include means for calculating the first Doppler frequency of the target object by calculating the first Doppler frequency based on the measured first set of sensing signals. The network entity 1902 may include means for measuring the second set of sensing signals. The network entity 1902 may include means for calculating the second Doppler frequency of the target object by calculating the second Doppler frequency based on the measured second set of sensing signals. The network entity 1902 may include means for transmitting, to the first RIS, a request for a position of the first RIS. The network entity 1902 may include means for receiving, from the first RIS, the position of the first RIS. The first configuration may be based on the position of the first RIS. The network entity 1902 may include means for transmitting the calculated velocity to a second wireless device. The network entity 1902 may include means for transmitting the calculated first Doppler frequency and the calculated second Doppler frequency to a second wireless device. The network entity 1902 may include means for receiving the first set of sensing signals via the first reflection path. The network entity 1902 may include means for receiving the second set of sensing signals via the second reflection path. The network entity 1902 may include means for calculating a position of the target object based on the first set of sensing signals, the first configuration, the second set of sensing signals, and the second configuration. The network entity 1902 may include means for transmitting the calculated position of the target object to a second wireless device. The network entity 1902 may include means for receiving the first set of sensing signals via the first reflection path. The network entity 1902 may include means for receiving the second set of sensing signals via the second reflection path. The network entity 1902 may include means for calculating a position of the first RIS based on the first set of sensing signals and the first configuration. The network entity 1902 may include means for calculating the position of the first RIS further based on the second set of sensing signals and the second configuration. The network entity 1902 may include means for calculating a position of the second RIS based on the second set of sensing signals and the second configuration. The network entity 1902 may include means for transmitting at least one of the calculated position of the first RIS or the calculated position of the second RIS to a second wireless device. The second wireless device may include a sensing processing entity. The network entity 1902 may include means for receiving a report of a calculated velocity of the target object. The means may be the component 198 of the network entity 1902 configured to perform the functions recited by the means. As described supra, the network entity 1902 may include the TX processor 316, the RX processor 370, and the controller/processor 375. As such, in one configuration, the means may be the TX processor 316, the RX processor 370, and/or the controller/processor 375 configured to perform the functions recited by the means.

As discussed supra, the component 199 may be configured to obtain a first configuration of a first set of sensing signals associated with a first reflection path including a first RIS. Each of the first set of sensing signals may be associated with a first RIS reflection coefficient. The component 199 may receive the first set of sensing signals via the first reflection path. The component 199 may calculate a first Doppler frequency of a target object based on the first set of sensing signals and the first configuration. The component 199 may obtain a second configuration of a second set of sensing signals associated with a second reflection path including at least one of the first RIS or a second RIS. Each of the second set of sensing signals may be associated with a second RIS reflection coefficient. The component 199 may receive the second set of sensing signals via the second reflection path. The component 199 may calculate a second Doppler frequency of the target object based on the second set of sensing signals and the second configuration. A velocity of the target object may be calculated based on the first Doppler frequency and the second Doppler frequency. The component 199 may be within one or more processors of one or more of the CU 1910, DU 1930, and the RU 1940. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1902 may include a variety of components configured for various functions. In one configuration, the network entity 1902 may include means for obtaining a first configuration of a first set of sensing signals associated with a first reflection path including a first RIS. Each of the first set of sensing signals is associated with a first RIS reflection coefficient. The network entity 1902 may include means for obtaining a second configuration of a second set of sensing signals associated with a second reflection path including at least one of the first RIS or a second RIS. Each of the second set of sensing signals may be associated with a second RIS reflection coefficient. The network entity 1902 may include means for receiving the first set of sensing signals via the first reflection path. The network entity 1902 may include means for receiving the second set of sensing signals via the second reflection path. The network entity 1902 may include means for calculating a first Doppler frequency of a target object based on the first set of sensing signals and the first configuration. The network entity 1902 may include means for calculating a second Doppler frequency of the target object based on the second set of sensing signals and the second configuration. The network entity 1902 may include means for obtaining the first configuration by receiving the first configuration from a first network node. The network entity 1902 may include means for obtaining the second configuration by receiving the second configuration from at least one of the first network node or a second network node. The network entity 1902 may include means for obtaining the first configuration by configuring the first set of sensing signals for the first RIS associated with the first reflection path. The network entity 1902 may include means for obtaining the second configuration by configuring the second set of sensing signals for at least one of the first RIS or the second RIS associated with the second reflection path. The first RIS reflection coefficient may be different from the second RIS reflection coefficient. The first reflection path may include a first reflection of the first set of sensing signals from the target object to the wireless device. The second reflection path may include a second reflection of the second set of sensing signals from the target object to the first RIS. The first reflection path may include a first reflection of the first set of sensing signals off of the first RIS. The second reflection path may include a second reflection of the second set of sensing signals off of the second RIS. The first reflection path may include a network node that transmits the first set of sensing signals. The second reflection path may include the network node that transmits the second set of sensing signals. The wireless device may include the network node. The first reflection path may include a first network node that transmits the first set of sensing signals. The second reflection path may include a second network node that transmits the second set of sensing signals. The wireless device may include at least one of the first network node or the second network node. The network entity 1902 may include means for receiving the first set of sensing signals by receiving at least one of the first set of sensing signals between receiving at least two of the second set of sensing signals. The network entity 1902 may include means for receiving the second set of sensing signals by receiving at least one of the second set of sensing signals between receiving at least two of the first set of sensing signals. The network entity 1902 may include means for receiving the first set of sensing signals by receiving the first set of sensing signals at a first AoA. The network entity 1902 may include means for receiving the second set of sensing signals by receiving the second set of sensing signals at a second AoA. The first AoA may be different than the second AoA. The network entity 1902 may include means for measuring the first set of sensing signals. The network entity 1902 may include means for calculating the first Doppler frequency of the target object by calculating the first Doppler frequency based on the measured first set of sensing signals. The network entity 1902 may include means for measuring the second set of sensing signals. The network entity 1902 may include means for calculating the second Doppler frequency of the target object by calculating the second Doppler frequency based on the measured second set of sensing signals. The network entity 1902 may include means for transmitting a Doppler frequency report including an indication of at least one of the calculated first Doppler frequency or the calculated second Doppler frequency. The indication of at least one of the calculated first Doppler frequency or the calculated second Doppler frequency may include (a) a quantization value of a set of Doppler frequencies associated with the first set of sensing signals and the second set of sensing signals, (b) a first absolute value for the calculated first Doppler frequency and a second absolute value for the calculated second Doppler frequency, (c) a differential value between the calculated first Doppler frequency and the calculated second Doppler frequency, or (d) a first direction associated with the calculated first Doppler frequency and a second direction associated with the calculated second Doppler frequency. The network entity 1902 may include means for selecting at least one of the calculated first Doppler frequency or the calculated second Doppler frequency based on a first size of the calculated first Doppler frequency and a second size of the calculated second Doppler frequency. For example, the method may include selecting a Doppler frequency by selecting the largest absolute Doppler frequencies first, followed smaller absolute Doppler frequencies until K maximum Doppler frequency values are selected. The network entity 1902 may include means for calculating a velocity of the target object based on the calculated first Doppler frequency and the calculated second Doppler frequency. The first configuration may include a first position of the first RIS. The second configuration may include a second position of the second RIS. The network entity 1902 may include means for calculating a velocity of the target object based on the calculated first Doppler frequency, the calculated second Doppler frequency, the first position of the first RIS, and the second position of the second RIS. At least one of the first configuration or the second configuration may include a position of the first RIS. The network entity 1902 may include means for calculating a velocity of the target object based on the calculated first Doppler frequency, the calculated second Doppler frequency, and the position of the first RIS. The wireless device may include at least one of a network node or a UE. The network entity 1902 may include means for transmitting the calculated velocity of the target object to a network node. The network node may include a base station or a TRP. The means may be the component 199 of the network entity 1902 configured to perform the functions recited by the means. As described supra, the network entity 1902 may include the TX processor 316, the RX processor 370, and the controller/processor 375. As such, in one configuration, the means may be the TX processor 316, the RX processor 370, and/or the controller/processor 375 configured to perform the functions recited by the means.

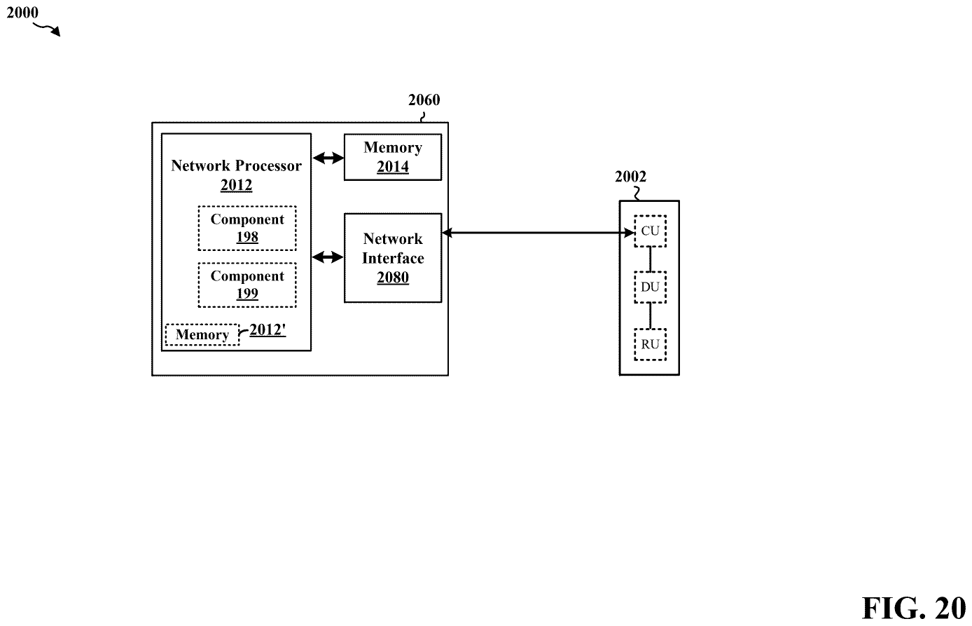

FIG. 20 is a diagram 2000 illustrating an example of a hardware implementation for a network entity 2060. In one example, the network entity 2060 may be within the core network 120. The network entity 2060 may include a network processor 2012. The network processor 2012 may include on-chip memory 2012′. In some aspects, the network entity 2060 may further include additional memory modules 2014. The network entity 2060 communicates via the network interface 2080 directly (e.g., backhaul link) or indirectly (e.g., through a RIC) with the CU 2002. The on-chip memory 2012′ and the additional memory modules 2014 may each be considered a computer-readable medium/memory. Each computer-readable medium/memory may be non-transitory. The processor 2012 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 198 may be configured to transmit, to a first RIS, a first configuration of a first set of sensing signals. Each of the first set of sensing signals may be associated with a first RIS reflection coefficient. The component 198 may transmit the first set of sensing signals along a first reflection path including the first RIS and a target object. The component 198 may transmit, to at least one of the first RIS or a second RIS, a second configuration of a second set of sensing signals. Each of the second set of sensing signals is associated with a second RIS reflection coefficient. The component 198 may transmit the second set of sensing signals along a second reflection path including at least one of the first RIS or the second RIS and the target object. The RIS may reflect the first set of sensing signals based on the first RIS reflection coefficient and may reflect the second set of sensing signals based on the second RIS reflection coefficient. The component 198 may be within the processor 2012. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 2060 may include a variety of components configured for various functions. In one configuration, the network entity 2060 may include means for transmitting, to a first RIS, a first configuration of a first set of sensing signals. Each of the first set of sensing signals is associated with a first RIS reflection coefficient. The network entity 2060 may include means for transmitting, to at least one of the first RIS or a second RIS, a second configuration of a second set of sensing signals. Each of the second set of sensing signals is associated with a second RIS reflection coefficient. The network entity 2060 may include means for transmitting the first set of sensing signals along a first reflection path including the first RIS and a target object. The network entity 2060 may include means for transmitting the second set of sensing signals along a second reflection path including at least one of the first RIS or the second RIS and the target object. The first RIS reflection coefficient may be different from the second RIS reflection coefficient. The network entity 2060 may include means for transmitting the first set of sensing signals by transmitting at least one of the first set of sensing signals between transmitting at least two of the second set of sensing signals. The network entity 2060 may include means for transmitting the second set of sensing signals by transmitting at least one of the second set of sensing signals between transmitting at least two of the first set of sensing signals. The network entity 2060 may include means for transmitting the first set of sensing signals by transmitting the first set of sensing signals at a first AoD. The network entity 2060 may include means for transmitting the second set of sensing signals by transmitting the second set of sensing signals at a second AoD. The first AoD may be different than the second AoD. The network entity 2060 may include means for transmitting a third configuration of the first set of sensing signals associated with the first reflection path to a second wireless device for bistatic sensing. The network entity 2060 may include means for transmitting a fourth configuration of the second set of sensing signals associated with the second reflection path to the second wireless device for the bistatic sensing. The first reflection path may include a first reflection of the first set of sensing signals from the target object to the second wireless device. The second reflection path may include a second reflection of the second set of sensing signals from the target object to the first RIS. The network entity 2060 may include means for receiving a Doppler frequency report including an indication of at least one of a first Doppler frequency associated with the first set of sensing signals and a second Doppler frequency associated with the second set of sensing signals. The indication of at least one of the first Doppler frequency or the second Doppler frequency may include (a) a quantization value of a set of Doppler frequencies associated with the first set of sensing signals and the second set of sensing signals, (b) a first absolute value for the first Doppler frequency and a second absolute value for the second Doppler frequency, (c) a differential value between the first Doppler frequency and the second Doppler frequency, or (d) a first direction associated with the first Doppler frequency and a second direction associated with the second Doppler frequency. The set of Doppler frequencies may include a set of highest Doppler frequencies out of a set of calculated Doppler frequencies. The set of calculated Doppler frequencies may include at least the first Doppler frequency and the second Doppler frequency. The network entity 2060 may include means for calculating a velocity of the target object based on the first Doppler frequency and the second Doppler frequency. The third configuration may include a first position of the first RIS. The fourth configuration may include at least one of the first position of the first RIS or a second position of the second RIS. The network entity 2060 may include means for transmitting a third configuration of the first set of sensing signals associated with the first reflection path to a second wireless device for bistatic sensing. The network entity 2060 may include means for transmitting a fourth configuration of the second set of sensing signals associated with the second reflection path to a third wireless device for the bistatic sensing. The network entity 2060 may include means for receiving a first Doppler frequency report including a first indication of a first Doppler frequency associated with the first set of sensing signals from the second wireless device. The network entity 2060 may include means for receiving a second Doppler frequency report including a second indication of a second Doppler frequency associated with the second set of sensing signals from the second wireless device. The first indication of the first Doppler frequency may include a quantization value of a set of Doppler frequencies associated with the first set of sensing signals, a first absolute value for the first Doppler frequency, or a first direction associated with the first Doppler frequency. The set of Doppler frequencies may include a first number of highest Doppler frequencies associated with the first set of sensing signals. The network entity 2060 may include means for calculating a velocity of the target object based on the first Doppler frequency report and the second Doppler frequency report. The third configuration may include a first position of the first RIS. The fourth configuration may include at least one of the first position of the first RIS or a second position of the second RIS. The network entity 2060 may include means for receiving the first set of sensing signals via the first reflection path. The network entity 2060 may include means for receiving the second set of sensing signals via the second reflection path. The network entity 2060 may include means for calculating a first Doppler frequency of the target object based on the first set of sensing signals and the first configuration. The network entity 2060 may include means for calculating a second Doppler frequency of the target object based on the second set of sensing signals and the second configuration. The network entity 2060 may include means for measuring the first set of sensing signals. The network entity 2060 may include means for calculating the first Doppler frequency of the target object by calculating the first Doppler frequency based on the measured first set of sensing signals. The network entity 2060 may include means for measuring the second set of sensing signals. The network entity 2060 may include means for calculating the second Doppler frequency of the target object by calculating the second Doppler frequency based on the measured second set of sensing signals. The network entity 2060 may include means for transmitting, to the first RIS, a request for a position of the first RIS. The network entity 2060 may include means for receiving, from the first RIS, the position of the first RIS. The first configuration may be based on the position of the first RIS. The network entity 2060 may include means for transmitting the calculated velocity to a second wireless device. The network entity 2060 may include means for transmitting the calculated first Doppler frequency and the calculated second Doppler frequency to a second wireless device. The network entity 2060 may include means for receiving the first set of sensing signals via the first reflection path. The network entity 2060 may include means for receiving the second set of sensing signals via the second reflection path. The network entity 2060 may include means for calculating a position of the target object based on the first set of sensing signals, the first configuration, the second set of sensing signals, and the second configuration. The network entity 2060 may include means for transmitting the calculated position of the target object to a second wireless device. The network entity 2060 may include means for receiving the first set of sensing signals via the first reflection path. The network entity 2060 may include means for receiving the second set of sensing signals via the second reflection path. The network entity 2060 may include means for calculating a position of the first RIS based on the first set of sensing signals and the first configuration. The network entity 2060 may include means for calculating the position of the first RIS further based on the second set of sensing signals and the second configuration. The network entity 2060 may include means for calculating a position of the second RIS based on the second set of sensing signals and the second configuration. The network entity 2060 may include means for transmitting at least one of the calculated position of the first RIS or the calculated position of the second RIS to a second wireless device. The second wireless device may include a sensing processing entity. The network entity 2060 may include means for receiving a report of a calculated velocity of the target object. The means may be the component 198 of the network entity 2060 configured to perform the functions recited by the means.

As discussed supra, the component 199 may be configured to obtain a first configuration of a first set of sensing signals associated with a first reflection path including a first RIS. Each of the first set of sensing signals may be associated with a first RIS reflection coefficient. The component 199 may receive the first set of sensing signals via the first reflection path. The component 199 may calculate a first Doppler frequency of a target object based on the first set of sensing signals and the first configuration. The component 199 may obtain a second configuration of a second set of sensing signals associated with a second reflection path including at least one of the first RIS or a second RIS. Each of the second set of sensing signals may be associated with a second RIS reflection coefficient. The component 199 may receive the second set of sensing signals via the second reflection path. The component 199 may calculate a second Doppler frequency of the target object based on the second set of sensing signals and the second configuration. A velocity of the target object may be calculated based on the first Doppler frequency and the second Doppler frequency. The component 199 may be within the processor 2012. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 2060 may include a variety of components configured for various functions. In one configuration, the network entity 2060 may include means for obtaining a first configuration of a first set of sensing signals associated with a first reflection path including a first RIS. Each of the first set of sensing signals is associated with a first RIS reflection coefficient. The network entity 2060 may include means for obtaining a second configuration of a second set of sensing signals associated with a second reflection path including at least one of the first RIS or a second RIS. Each of the second set of sensing signals may be associated with a second RIS reflection coefficient. The network entity 2060 may include means for receiving the first set of sensing signals via the first reflection path. The network entity 2060 may include means for receiving the second set of sensing signals via the second reflection path. The network entity 2060 may include means for calculating a first Doppler frequency of a target object based on the first set of sensing signals and the first configuration. The network entity 2060 may include means for calculating a second Doppler frequency of the target object based on the second set of sensing signals and the second configuration. The network entity 2060 may include means for obtaining the first configuration by receiving the first configuration from a first network node. The network entity 2060 may include means for obtaining the second configuration by receiving the second configuration from at least one of the first network node or a second network node. The network entity 2060 may include means for obtaining the first configuration by configuring the first set of sensing signals for the first RIS associated with the first reflection path. The network entity 2060 may include means for obtaining the second configuration by configuring the second set of sensing signals for at least one of the first RIS or the second RIS associated with the second reflection path. The first RIS reflection coefficient may be different from the second RIS reflection coefficient. The first reflection path may include a first reflection of the first set of sensing signals from the target object to the wireless device. The second reflection path may include a second reflection of the second set of sensing signals from the target object to the first RIS. The first reflection path may include a first reflection of the first set of sensing signals off of the first RIS. The second reflection path may include a second reflection of the second set of sensing signals off of the second RIS. The first reflection path may include a network node that transmits the first set of sensing signals. The second reflection path may include the network node that transmits the second set of sensing signals. The wireless device may include the network node. The first reflection path may include a first network node that transmits the first set of sensing signals. The second reflection path may include a second network node that transmits the second set of sensing signals. The wireless device may include at least one of the first network node or the second network node. The network entity 2060 may include means for receiving the first set of sensing signals by receiving at least one of the first set of sensing signals between receiving at least two of the second set of sensing signals. The network entity 2060 may include means for receiving the second set of sensing signals by receiving at least one of the second set of sensing signals between receiving at least two of the first set of sensing signals. The network entity 2060 may include means for receiving the first set of sensing signals by receiving the first set of sensing signals at a first AoA. The network entity 2060 may include means for receiving the second set of sensing signals by receiving the second set of sensing signals at a second AoA. The first AoA may be different than the second AoA. The network entity 2060 may include means for measuring the first set of sensing signals. The network entity 2060 may include means for calculating the first Doppler frequency of the target object by calculating the first Doppler frequency based on the measured first set of sensing signals. The network entity 2060 may include means for measuring the second set of sensing signals. The network entity 2060 may include means for calculating the second Doppler frequency of the target object by calculating the second Doppler frequency based on the measured second set of sensing signals. The network entity 2060 may include means for transmitting a Doppler frequency report including an indication of at least one of the calculated first Doppler frequency or the calculated second Doppler frequency. The indication of at least one of the calculated first Doppler frequency or the calculated second Doppler frequency may include (a) a quantization value of a set of Doppler frequencies associated with the first set of sensing signals and the second set of sensing signals, (b) a first absolute value for the calculated first Doppler frequency and a second absolute value for the calculated second Doppler frequency, (c) a differential value between the calculated first Doppler frequency and the calculated second Doppler frequency, or (d) a first direction associated with the calculated first Doppler frequency and a second direction associated with the calculated second Doppler frequency. The network entity 2060 may include means for selecting at least one of the calculated first Doppler frequency or the calculated second Doppler frequency based on a first size of the calculated first Doppler frequency and a second size of the calculated second Doppler frequency. For example, the method may include selecting a Doppler frequency by selecting the largest absolute Doppler frequencies first, followed smaller absolute Doppler frequencies until K maximum Doppler frequency values are selected. The network entity 2060 may include means for calculating a velocity of the target object based on the calculated first Doppler frequency and the calculated second Doppler frequency. The first configuration may include a first position of the first RIS. The second configuration may include a second position of the second RIS. The network entity 2060 may include means for calculating a velocity of the target object based on the calculated first Doppler frequency, the calculated second Doppler frequency, the first position of the first RIS, and the second position of the second RIS. At least one of the first configuration or the second configuration may include a position of the first RIS. The network entity 2060 may include means for calculating a velocity of the target object based on the calculated first Doppler frequency, the calculated second Doppler frequency, and the position of the first RIS. The wireless device may include at least one of a network node or a UE. The network entity 2060 may include means for transmitting the calculated velocity of the target object to a network node. The network node may include a base station or a TRP. The means may be the component 199 of the network entity 2060 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive the data, for example with a transceiver, or may obtain the data from a device that receives the data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.
Aspect 1 is a method of wireless communication at a wireless device, where the method may include obtaining a first configuration of a first set of sensing signals associated with a first reflection path including a first RIS. Each of the first set of sensing signals is associated with a first RIS reflection coefficient. The method may include obtaining a second configuration of a second set of sensing signals associated with a second reflection path including at least one of the first RIS or a second RIS. Each of the second set of sensing signals may be associated with a second RIS reflection coefficient. The method may include receiving the first set of sensing signals via the first reflection path. The method may include receiving the second set of sensing signals via the second reflection path. The method may include calculating a first Doppler frequency of a target object based on the first set of sensing signals and the first configuration. The method may include calculating a second Doppler frequency of the target object based on the second set of sensing signals and the second configuration.
Aspect 2 is the method of aspect 1, where obtaining the first configuration may include receiving the first configuration from a first network node. Obtaining the second configuration may include receiving the second configuration from at least one of the first network node or a second network node.
Aspect 3 is the method of either of aspects 1 or 2, where obtaining the first configuration may include configuring the first set of sensing signals for the first RIS associated with the first reflection path. Obtaining the second configuration may include configuring the second set of sensing signals for at least one of the first RIS or the second RIS associated with the second reflection path.
Aspect 4 is the method of any of aspects 1 to 3, where the first RIS reflection coefficient may be different from the second RIS reflection coefficient.
Aspect 5 is the method of any of aspects 1 to 4, where the first reflection path may include a first reflection of the first set of sensing signals from the target object to the wireless device. The second reflection path may include a second reflection of the second set of sensing signals from the target object to the first RIS.
Aspect 6 is the method of any of aspects 1 to 5, where the first reflection path may include a first reflection of the first set of sensing signals off of the first RIS. The second reflection path may include a second reflection of the second set of sensing signals off of the second RIS.
Aspect 7 is the method of any of aspects 1 to 6, where the first reflection path may include a network node that transmits the first set of sensing signals. The second reflection path may include the network node that transmits the second set of sensing signals.
Aspect 8 is the method of aspect 7, where the wireless device may include the network node.
Aspect 9 is the method of any of aspects 1 to 8, where the first reflection path may include a first network node that transmits the first set of sensing signals. The second reflection path may include a second network node that transmits the second set of sensing signals.
Aspect 10 is the method of aspect 9, where the wireless device may include at least one of the first network node or the second network node.
Aspect 11 is the method of any of aspects 1 to 10, where receiving the first set of sensing signals may include receiving at least one of the first set of sensing signals between receiving at least two of the second set of sensing signals. Receiving the second set of sensing signals may include receiving at least one of the second set of sensing signals between receiving at least two of the first set of sensing signals.
Aspect 12 is the method of any of aspects 1 to 11, where receiving the first set of sensing signals may include receiving the first set of sensing signals at a first AoA. Receiving the second set of sensing signals may include receiving the second set of sensing signals at a second AoA. The first AoA may be different than the second AoA.
Aspect 13 is the method of any of aspects 1 to 12, where the method may include measuring the first set of sensing signals. Calculating the first Doppler frequency of the target object may include calculating the first Doppler frequency based on the measured first set of sensing signals. The method may include measuring the second set of sensing signals. Calculating the second Doppler frequency of the target object may include calculating the second Doppler frequency based on the measured second set of sensing signals.
Aspect 14 is the method of any of aspects 1 to 13, where the method may include transmitting a Doppler frequency report including an indication of at least one of the calculated first Doppler frequency or the calculated second Doppler frequency.
Aspect 15 is the method of aspect 14, where the indication of at least one of the calculated first Doppler frequency or the calculated second Doppler frequency may include (a) a quantization value of a set of Doppler frequencies associated with the first set of sensing signals and the second set of sensing signals, (b) a first absolute value for the calculated first Doppler frequency and a second absolute value for the calculated second Doppler frequency, (c) a differential value between the calculated first Doppler frequency and the calculated second Doppler frequency, or (d) a first direction associated with the calculated first Doppler frequency and a second direction associated with the calculated second Doppler frequency.
Aspect 16 is the method of aspect 15, where the method may include selecting at least one of the calculated first Doppler frequency or the calculated second Doppler frequency based on a first size of the calculated first Doppler frequency and a second size of the calculated second Doppler frequency. For example, the method may include selecting a Doppler frequency by selecting the largest absolute Doppler frequencies first, followed smaller absolute Doppler frequencies until K maximum Doppler frequency values are selected.
Aspect 17 is the method of any of aspects 1 to 16, where the method may include calculating a velocity of the target object based on the calculated first Doppler frequency and the calculated second Doppler frequency.
Aspect 18 is the method of any of aspects 1 to 17, where the first configuration may include a first position of the first RIS. The second configuration may include a second position of the second RIS. The method may include calculating a velocity of the target object based on the calculated first Doppler frequency, the calculated second Doppler frequency, the first position of the first RIS, and the second position of the second RIS.
Aspect 19 is the method of any of aspects 1 to 18, where at least one of the first configuration or the second configuration may include a position of the first RIS. The method may include calculating a velocity of the target object based on the calculated first Doppler frequency, the calculated second Doppler frequency, and the position of the first RIS.
Aspect 20 is the method of any of aspects 1 to 19, where the wireless device may include at least one of a network node or a UE.
Aspect 21 is a method of wireless communication at a first wireless device, where the method may include transmitting, to a first RIS, a first configuration of a first set of sensing signals. Each of the first set of sensing signals is associated with a first RIS reflection coefficient. The method may include transmitting, to at least one of the first RIS or a second RIS, a second configuration of a second set of sensing signals. Each of the second set of sensing signals is associated with a second RIS reflection coefficient. The method may include transmitting the first set of sensing signals along a first reflection path including the first RIS and a target object. The method may include transmitting the second set of sensing signals along a second reflection path including at least one of the first RIS or the second RIS and the target object.
Aspect 22 is the method of aspect 21, where the first RIS reflection coefficient may be different from the second RIS reflection coefficient.
Aspect 23 is the method of either of aspects 21 or 22, where transmitting the first set of sensing signals may include transmitting at least one of the first set of sensing signals between transmitting at least two of the second set of sensing signals. Transmitting the second set of sensing signals may include transmitting at least one of the second set of sensing signals between transmitting at least two of the first set of sensing signals.
Aspect 24 is the method of any of aspects 21 to 23, where transmitting the first set of sensing signals may include transmitting the first set of sensing signals at a first AoD. Transmitting the second set of sensing signals may include transmitting the second set of sensing signals at a second AoD. The first AoD may be different than the second AoD.
Aspect 25 is the method of any of aspects 21 to 24, where the method may include transmitting a third configuration of the first set of sensing signals associated with the first reflection path to a second wireless device for bistatic sensing. The method may include transmitting a fourth configuration of the second set of sensing signals associated with the second reflection path to the second wireless device for the bistatic sensing.
Aspect 26 is the method of aspect 25, where the first reflection path may include a first reflection of the first set of sensing signals from the target object to the second wireless device. The second reflection path may include a second reflection of the second set of sensing signals from the target object to the first RIS.
Aspect 27 is the method of either of aspects 25 or 26, where the method may include receiving a Doppler frequency report including an indication of at least one of a first Doppler frequency associated with the first set of sensing signals and a second Doppler frequency associated with the second set of sensing signals.
Aspect 28 is the method of aspect 27, where the indication of at least one of the first Doppler frequency or the second Doppler frequency may include (a) a quantization value of a set of Doppler frequencies associated with the first set of sensing signals and the second set of sensing signals, (b) a first absolute value for the first Doppler frequency and a second absolute value for the second Doppler frequency, (c) a differential value between the first Doppler frequency and the second Doppler frequency, or (d) a first direction associated with the first Doppler frequency and a second direction associated with the second Doppler frequency.
Aspect 29 is the method of aspect 28, where the set of Doppler frequencies may include a set of highest Doppler frequencies out of a set of calculated Doppler frequencies. The set of calculated Doppler frequencies may include at least the first Doppler frequency and the second Doppler frequency.
Aspect 30 is the method of any of aspects 27 to 29, where the method may include calculating a velocity of the target object based on the first Doppler frequency and the second Doppler frequency.
Aspect 31 is the method of any of aspects 25 to 30, where the third configuration may include a first position of the first RIS. The fourth configuration may include at least one of the first position of the first RIS or a second position of the second RIS.
Aspect 32 is the method of any of aspects 21 to 31, where the method may include transmitting a third configuration of the first set of sensing signals associated with the first reflection path to a second wireless device for bistatic sensing. The method may include transmitting a fourth configuration of the second set of sensing signals associated with the second reflection path to a third wireless device for the bistatic sensing.
Aspect 33 is the method of aspect 32, where the method may include receiving a first Doppler frequency report including a first indication of a first Doppler frequency associated with the first set of sensing signals from the second wireless device. The method may include receiving a second Doppler frequency report including a second indication of a second Doppler frequency associated with the second set of sensing signals from the third wireless device.
Aspect 34 is the method of aspect 33, where the first indication of the first Doppler frequency may include a quantization value of a set of Doppler frequencies associated with the first set of sensing signals, a first absolute value for the first Doppler frequency, or a first direction associated with the first Doppler frequency.
Aspect 35 is the method of aspect 34, where the set of Doppler frequencies may include a first number of highest Doppler frequencies associated with the first set of sensing signals.
Aspect 36 is the method of any of aspects 33 to 35, where the method may include calculating a velocity of the target object based on the first Doppler frequency report and the second Doppler frequency report.
Aspect 37 is the method of any of aspects 32 to 36, where the third configuration may include a first position of the first RIS. The fourth configuration may include at least one of the first position of the first RIS or a second position of the second RIS.
Aspect 38 is the method of any of aspects 21 to 37, where the method may include receiving the first set of sensing signals via the first reflection path. The method may include receiving the second set of sensing signals via the second reflection path. The method may include calculating a first Doppler frequency of the target object based on the first set of sensing signals and the first configuration. The method may include calculating a second Doppler frequency of the target object based on the second set of sensing signals and the second configuration.
Aspect 39 is the method of aspect 38, where the method may include measuring the first set of sensing signals. Calculating the first Doppler frequency of the target object may include calculating the first Doppler frequency based on the measured first set of sensing signals. The method may include measuring the second set of sensing signals. Calculating the second Doppler frequency of the target object may include calculating the second Doppler frequency based on the measured second set of sensing signals.
Aspect 40 is the method of any of aspects 21 to 39. The method may include transmitting, to the first RIS, a request for a position of the first RIS. The method may include receiving, from the first RIS, the position of the first RIS. The first configuration may be based on the position of the first RIS.
Aspect 41 is the method of any of aspects 21 to 40, where the method may include receiving a report of a calculated velocity of the target object.
Aspect 42 is the method of either of aspects 30 or 36, where the method may include transmitting the calculated velocity to a second wireless device.
Aspect 43 is the method of aspect 38, where the method may include transmitting the calculated first Doppler frequency and the calculated second Doppler frequency to a second wireless device.
Aspect 44 is the method of any of aspects 21 to 37, where the method may include receiving the first set of sensing signals via the first reflection path. The method may include receiving the second set of sensing signals via the second reflection path. The method may include calculating a position of the target object based on the first set of sensing signals, the first configuration, the second set of sensing signals, and the second configuration. The method may include transmitting the calculated position of the target object to a second wireless device.
Aspect 44 is the method of any of aspects 21 to 37, where the method may include receiving the first set of sensing signals via the first reflection path. The method may include receiving the second set of sensing signals via the second reflection path. The method may include calculating a position of the first RIS based on the first set of sensing signals and the first configuration. Calculating the position of the first RIS may be further based on the second set of sensing signals and the second configuration. The method may include calculating a position of the second RIS based on the second set of sensing signals and the second configuration. The method may include transmitting at least one of the calculated position of the first RIS or the calculated position of the second RIS to a second wireless device.
Aspect 45 is the method of any of aspects 42 to 44, where the second wireless device may include a sensing processing entity.
Aspect 46 is the method of aspect 19, where the method may include transmitting the calculated velocity of the target object to a network node. The network node may include a base station or a TRP.
Aspect 47 is an apparatus for wireless communication, including: a memory; and at least one processor coupled to the memory and, based at least in part on information stored in the memory, the at least one processor is configured to implement any of aspects 1 to 46.
Aspect 48 is the apparatus of aspect 41, further including at least one of an antenna or a transceiver coupled to the at least one processor.
Aspect 49 is an apparatus for wireless communication including means for implementing any of aspects 1 to 46.
Aspect 50 is a computer-readable medium (e.g., a non-transitory computer-readable medium) storing computer executable code, where the code when executed by a processor causes the processor to implement any of aspects 1 to 46.

1. An apparatus for wireless communication at a wireless device, comprising:
a memory; and
at least one processor coupled to the memory and, based at least in part on information stored in the memory, the at least one processor is configured to:
obtain a first configuration of a first set of sensing signals associated with a first reflection path comprising a first reconfigurable intelligent surface (RIS), wherein each of the first set of sensing signals is associated with a first RIS reflection coefficient;
obtain a second configuration of a second set of sensing signals associated with a second reflection path comprising at least one of the first RIS or a second RIS, wherein each of the second set of sensing signals is associated with a second RIS reflection coefficient;
receive the first set of sensing signals via the first reflection path;
receive the second set of sensing signals via the second reflection path;
calculate a first Doppler frequency of a target object based on the first set of sensing signals and the first configuration; and
calculate a second Doppler frequency of the target object based on the second set of sensing signals and the second configuration.

2. (canceled)

3. The apparatus of claim 1, wherein, to obtain the first configuration, the at least one processor is configured to;
configure the first set of sensing signals for the first RIS associated with the first reflection path, wherein, to obtain the second configuration, the at least one processor is configured to:
configure the second set of sensing signals for at least one of the first RIS or the second RIS associated with the second reflection path.

4. The apparatus of claim 1, wherein the first RIS reflection coefficient is different from the second RIS reflection coefficient.

5. The apparatus of claim 1, wherein the first reflection path comprises a first reflection of the first set of sensing signals from the target object to the wireless device, wherein the second reflection path comprises a second reflection of the second set of sensing signals from the target object to the first RIS.

6. The apparatus of claim 1, wherein the first reflection path comprises a first reflection of the first set of sensing signals off of the first RIS, wherein the second reflection path comprises a second reflection of the second set of sensing signals off of the second RIS.

7. The apparatus of claim 1, wherein the first reflection path comprises a network node that transmits the first set of sensing signals, wherein the second reflection path comprises the network node that transmits the second set of sensing signals.

8. (canceled)

9. The apparatus of claim 1, wherein the first reflection path comprises a first network node that transmits the first set of sensing signals, wherein the second reflection path comprises a second network node that transmits the second set of sensing signals.

10. (canceled)

11. The apparatus of claim 1, wherein, to receive the first set of sensing signals, the at least one processor is configured to;
receive at least one of the first set of sensing signals between receiving at least two of the second set of sensing signals, wherein, to receive the second set of sensing signals, the at least one processor is configured to:
receive at least one of the second set of sensing signals between receiving at least two of the first set of sensing signals.

12. (canceled)

13. The apparatus of claim 1, wherein the at least one processor is further configured to:
measure the first set of sensing signals, wherein, to calculate the first Doppler frequency of the target object, the at least one processor is configured to calculate the first Doppler frequency based on the measured first set of sensing signals; and
measure the second set of sensing signals, wherein, to calculate the second Doppler frequency of the target object, the at least one processor is configured to calculate the second Doppler frequency based on the measured second set of sensing signals.

14. (canceled)

15. The apparatus of claim 1, wherein the at least one processor is further configured to:
transmit a Doppler frequency report comprising an indication of at least one of the calculated first Doppler frequency or the calculated second Doppler frequency, wherein the indication of at least one of the calculated first Doppler frequency or the calculated second Doppler frequency comprises:
a quantization value of a set of Doppler frequencies associated with the first set of sensing signals and the second set of sensing signals;
a first absolute value for the calculated first Doppler frequency and a second absolute value for the calculated second Doppler frequency;
a differential value between the calculated first Doppler frequency and the calculated second Doppler frequency; or
a first direction associated with the calculated first Doppler frequency and a second direction associated with the calculated second Doppler frequency.

16. (canceled)

17. (canceled)

18. The apparatus of claim 1, wherein the first configuration comprises a first position of the first RIS, wherein the second configuration comprises a second position of the second RIS, wherein the at least one processor is further configured to:
calculate a velocity of the target object based on the calculated first Doppler frequency, the calculated second Doppler frequency, the first position of the first RIS, and the second position of the second RIS.

19. The apparatus of claim 1, wherein at least one of the first configuration or the second configuration comprises a position of the first RIS, wherein the at least one processor is further configured to:
calculate a velocity of the target object based on the calculated first Doppler frequency, the calculated second Doppler frequency, and the position of the first RIS.

20. (canceled)

21. An apparatus for wireless communication at a first wireless device, comprising:
a memory; and
at least one processor coupled to the memory and, based at least in part on information stored in the memory, the at least one processor is configured to:
transmit, to a first reconfigurable intelligent surface (RIS), a first configuration of a first set of sensing signals, wherein each of the first set of sensing signals is associated with a first RIS reflection coefficient;
transmit, to at least one of the first RIS or a second RIS, a second configuration of a second set of sensing signals, wherein each of the second set of sensing signals is associated with a second RIS reflection coefficient;
transmit the first set of sensing signals along a first reflection path comprising the first RIS and a target object; and
transmit the second set of sensing signals along a second reflection path comprising at least one of the first RIS or the second RIS and the target object.

22. The apparatus of claim 21, wherein the first RIS reflection coefficient is different from the second RIS reflection coefficient.

23. The apparatus of claim 21, wherein the at least one processor is further configured to:
transmit a third configuration of the first set of sensing signals associated with the first reflection path to a second wireless device for bistatic sensing; and
transmit a fourth configuration of the second set of sensing signals associated with the second reflection path to the second wireless device or a third wireless device for the bistatic sensing.

24. (canceled)

25. The apparatus of claim 23, wherein the third configuration comprises a first position of the first RIS, wherein the fourth configuration comprises at least one of the first position of the first RIS or a second position of the second RIS.

26. The apparatus of claim 23, wherein the at least one processor is further configured to:
receive a first Doppler frequency report comprising a first indication of a first Doppler frequency associated with the first set of sensing signals from the second wireless device; and
receive a second Doppler frequency report comprising a second indication of a second Doppler frequency associated with the second set of sensing signals from at least one of the second wireless device or the third wireless device.

27. The apparatus of claim 21, wherein the at least one processor is further configured to:
receive the first set of sensing signals via the first reflection path;
receive the second set of sensing signals via the second reflection path;
measure the first set of sensing signals;
measure the second set of sensing signals;
calculate a first Doppler frequency of the target object based on the first set of sensing signals, the first configuration, and the measured first set of sensing signals; and
calculate a second Doppler frequency of the target object based on the second set of sensing signals, the second configuration, and the measured second set of sensing signals.

28. The apparatus of claim 21, wherein, to transmit the first set of sensing signals, the at least one processor is configured to:
transmit at least one of the first set of sensing signals between transmitting at least two of the second set of sensing signals, wherein, to transmit the second set of sensing signals, the at least one processor is configured to:
transmit at least one of the second set of sensing signals between transmitting at least two of the first set of sensing signals.

29. A method for wireless communication at a wireless device, comprising:
obtaining a first configuration of a first set of sensing signals associated with a first reflection path comprising a first reconfigurable intelligent surface (RIS), wherein each of the first set of sensing signals is associated with a first RIS reflection coefficient;
obtaining a second configuration of a second set of sensing signals associated with a second reflection path comprising at least one of the first RIS or a second RIS, wherein each of the second set of sensing signals is associated with a second RIS reflection coefficient;
receiving the first set of sensing signals via the first reflection path;
receiving the second set of sensing signals via the second reflection path;
calculating a first Doppler frequency of a target object based on the first set of sensing signals and the first configuration; and
calculating a second Doppler frequency of the target object based on the second set of sensing signals and the second configuration.

30. (canceled)
